(19) United States
(12) Patent Application Publication
(10) Pub. No.: US 2017/0045441 A1
(43) Pub. Date: Feb. 16, 2017

(54) SAMPLE ANALYSIS METHODS

(71) Applicant: ARCHIMEJ TECHNOLOGY, Evry (FR)

(72) Inventor: Mejdi Nciri, Paris (FR)

(21) Appl. No.: 15/340,615

(22) Filed: Nov. 1, 2016

Related U.S. Application Data
(63) Continuation-in-part of application No. 15/337,693, filed on Oct. 28, 2016.
Application No. 15/337,693 is a continuation-in-part of application No. 14/910,310, filed on Feb. 5, 2016.
Application No. 15/337,693 is a continuation-in-part of application No. 14/399,786, filed on Nov. 7, 2014.

(30) Foreign Application Priority Data
May 9, 2012 (FR) FR1201353
Nov. 20, 2012 (FR) FR1261015
Jan. 18, 2013 (FR) FR1350446
Aug. 8, 2013 (FR) FR1357872

(51) Int. Cl. G01N 21/31

(52) U.S. Cl. CPC G01N 21/31; G01N 2021/3129; G01N 2021/3196

(57) ABSTRACT

The invention generally relates to methods for determining a concentration of at least one target analyte in a heterogeneous sample and methods for detecting a condition. In certain aspects, the inventions provides methods that involve illuminating a heterogeneous sample, such as a biological sample, including at least one target analyte with polychromatic light, receiving luminous data of the heterogeneous sample and the at least one target analyte with a detector without splitting the polychromatic light into individual wavelengths and generating spectral data therefrom. The spectral data is then converted into a concentration of the at least one target analyte in the biological sample by comparing the spectral data to a database comprising known spectra already associated with concentration levels.

### RELATED APPLICATIONS

This application is a continuation-in-part of U.S. patent application Ser. No. 15/337,693, filed on Oct. 28, 2016, which is a continuation-in-part of U.S. patent application Ser. No. 14/399,786, filed on Nov. 7, 2014, which is a National Phase Entry of PCT/FR2013/050957 filed on Apr. 30, 2013, which claims priority to FR1350446 filed on Jan. 18, 2013, FR1261015 filed on Nov. 20, 2012, and FR1201353 filed on May 9, 2012, the content of each of which is incorporated herein by reference. The '693 application is also a continuation-in-part of U.S. patent application Ser. No. 14/910,310 filed on Feb. 5, 2016, which is a National Stage Entry of PCT/EP2014/066854, filed on Aug. 5, 2014, which claims priority to FR 1357872 filed on Aug. 8, 2013, the content of each of which is incorporated herein by reference.

### FIELD OF THE INVENTION

The invention generally relates to methods for determining a concentration one or more target analytes in a sample.

### BACKGROUND

The presence of target analytes in a sample, along with the levels of target analytes that are present in the sample can provide valuable information in a number of industries. For example, analysis of a blood sample for various components, such as iron or uric acid, and their respective concentrations can be indicative of a disease or disorder in an individual. Similarly, analysis of processed wastewater for various components and their respective concentrations can be indicative of the quality of the water and the presence of potentially dangerous levels of a certain component.

Absorption spectroscopy has been used for a number of decades to analyze various sample types to determine the presence of certain target analytes and/or their concentration in the sample. Classic absorption spectroscopy methods involve the use of a single light source that emits a polychromatic light beam onto the sample. The beam then passes through the sample and some of the light is absorbed as the beam travels through the sample. The light beam then typically passes through a wavelength separator such as a prism and the light beam is separated into its monochromatic component light beams. Each monochromatic beam is then sent to a separate detector. These methods typically require, for example, the use of bulky equipment and are costly due, in part, to the need to provide a plurality of detectors capable of detecting the separate light beams.

### SUMMARY

The invention provides methods for sample analysis using polychromatic light. Using very low sample quantities (e.g., one drop of a sample, such as one drop of blood) and with minimal sample preparation, one or multiple target analytes in a sample can be measured. Aspects of the invention are accomplished by analyzing a polychromatic light beam that has passed through a sample. Unlike prior spectroscopy approaches for analyzing a sample, the methods of the invention do not require splitting a polychromatic light bean into its different wavelength components, each of which must be sent to a different detector. Rather, a single detector receives the polychromatic light beam after it has passed through the sample. The received polychromatic light beam is then analyzed and a target analyte in a sample is detected based on the analysis of the received polychromatic light. In that manner, the methods of the invention eliminate the need for systems that have a plurality of detectors, dramatically simplifying spectrometer devices for sample analysis.

Further, the methods of the invention can be performed without the need for additional chemical reagents. In that manner, costs for sample analysis are reduced and the methods of the invention avoid the problem of having to determine which reagent or reagents to use in order to detect a specific target analyte.

In certain aspects, the invention provides methods for determining a concentration of at least one target analyte in a heterogeneous sample that involve illuminating the heterogeneous sample including a target analyte with polychromatic light. A luminous signal of the heterogeneous sample containing the target analyte is received by a detector without splitting the polychromatic light into individual wavelengths, and spectral data is generated therefrom. The spectral data is then converted into a concentration by comparing the spectral data of the at least one target analyte to a database having known spectra already associated with concentration levels of the target analyte.

Other aspects of the invention provide methods for detecting a condition that involve illuminating a biological sample comprising at least one target analyte with polychromatic light. A luminous signal of the biological sample containing the target analyte is received by a detector without splitting the polychromatic light into individual wavelengths, and spectral data is generated therefrom. The spectral data is then converted into a concentration by comparing the spectral data of the at least one target analyte to a database having known spectra already associated with concentration levels of the target analyte, with the concentration provided indicative of a condition.

The methods of the invention can analyze any type of sample. Exemplary sample types include biological samples, environmental samples (including, e.g., industrial samples and agricultural samples), and food/beverage product samples, etc. In certain embodiments, the sample is a biological sample, such as a human tissue or body fluid sample (e.g., blood or urine or saliva).

In certain embodiments, the generation of spectral data includes accounting for current data from each of a plurality of monochromatic light beams as well as temperature. The methods may further involve generating a report that includes the concentration of the target analyte, in which the concentration is indicative of a disease state of a subject. The methods may further involve transmitting the report to a physician. That report may then aide the physician in the diagnosis of a disease state of a subject.

In one aspect, methods of the invention involve the analysis of one or more analytes without the use of chemical reagents. In another aspect, methods of the invention involve the detection of multiple analytes within a heterogeneous sample that involve mixing within a single chamber a plurality of chemical reagents and a heterogeneous sample comprising a plurality of target analytes to form a plurality of reaction products. Each chemical reagent is specific for a different target analyte. The sample is illuminated in a single chamber with a polychromatic light beam. Spectral data of the sample, including reaction products, is then received by a detector. Each reaction product will have a unique spectral signature. The spectral signature for each of the plurality of target analytes is then output to, for example, a display.

Further aspects of the invention involve assessing an element from a blood sample. Such methods may involve illuminating a plasma sample containing the element with polychromatic light. Spectral data of the sample, including the element, is received by a detector without splitting the polychromatic light into individual wavelengths, spectral data being generated therefrom. The spectral data is then analyzed. The methods are conducted without reacting the element with another chemical reagent. Any number of different elements may be assessed, and exemplary elements that can be assessed using these methods include bilirubin, uric acid, iron, total proteins, and triglycerides.

Other aspects of the invention provide methods that account for the presence of lipids in a sample. Such methods may involve analyzing a sample containing one or more lipids in order to obtain spectral data. The methods may then involve correcting for diffusion of light in the spectral data to generate corrected spectral data and analyzing the corrected spectral data.

### BRIEF DESCRIPTION OF THE DRAWINGS

FIG. 1 shows a prior art method for conducting absorption spectroscopy.

FIGS. 2A-B show a general overview of methods of the invention conducted using systems described herein.

FIG. 3 shows the emission spectra of two light sources utilized in a device for emitting a polychromatic multiplexed light beam according to the present disclosure.

FIG. 4 shows a first embodiment of an emission device according to the present disclosure.

FIG. 5 shows a second embodiment of an emission device according to the present disclosure.

FIG. 6 shows a third embodiment of an emission device according to the present disclosure.

FIG. 7 shows a fourth embodiment of an emission device according to the present disclosure.

FIG. 8 shows an embodiment of an emission installation according to the present disclosure.

FIG. 9 shows an embodiment of an absorption spectrometer according to the present disclosure.

FIG. 10 shows an embodiment of a fluorescence spectrometer according to the present disclosure.

FIG. 11 shows an embodiment of a fluorescence microscopy apparatus according to the present disclosure.

FIG. 12 shows an embodiment of a multispectral imaging apparatus according to the present disclosure.

FIG. 13 shows an embodiment of a light emission unit according to the present disclosure.

FIG. 14 shows an assembly for a first embodiment of a fabricating method according to the present disclosure for fabricating a first embodiment of a light emission device, as shown in FIG. 4.

FIG. 15 shows a diagrammatic view of the first embodiment of a light emission device, as shown in FIG. 4, according to the assembly of FIG. 14.

FIG. 16 shows diagrammatically a second embodiment of a light emission device according to the present disclosure.

FIGS. 17 to 21 show elements taken into account for a second embodiment of a fabricating method according to the present disclosure for fabricating the second embodiment of a light emission device according to the present disclosure.

FIG. 22 is a more general view of a light emission device according to the present disclosure.

FIG. 23 shows a support of a light emission device according to the present disclosure, and the sources fixed to this support.

FIG. 24 shows a variant for a support of a light emission device according to the present disclosure, and the sources fixed to this support.

FIG. 25 shows another variant for a support of a light emission device according to the present disclosure, and the sources fixed to this support.

FIG. 26 is a perspective view of a variant of a support of a light emission device according to the present disclosure provided with reliefs.

FIGS. 27 and 28 are profile views of a variant for which the support of a light emission device according to the present disclosure is inclined.

FIG. 29 is a bottom view of a support of a light emission device according to the present disclosure, and of the sources fixed to this support in the case of chromatic dispersion properties comprising chromatic folding in the plane of the support at the image of an apochromatic objective lens.

FIG. 30 depicts elements in blood plasma according to their concentration and molar mass.

FIG. 31 depicts certain interactions between certain elements shown in FIG. 30.

FIG. 32 shows an example report that can be generated using methods of the present disclosure

FIG. 33 shows a method for analyzing spectral data in accordance with the present disclosure.

FIG. 34 shows a report containing the concentration levels of various analytes for a number of plasma samples.

FIG. 35 shows absorption data obtained using methods of the invention.

FIG. 36 shows spectral data obtained using methods of the invention.

FIG. 37 shows a flow chart depicting the steps of applying a machine learning algorithm in accordance with methods of the invention.

FIG. 38 shows a flow chart depicting the steps of a process used to predict the concentration of bilirubin.

FIGS. 39-41 depict the data analysis and results of the methods according to the present invention as applied to uric acid.

FIGS. 42 and 43 depict the results of the methods according to the present invention as applied to bilirubin.

FIG. 44A-C show various aspects of prototype apparatus including a laser at 405 nm used to produce photodegradation data for bilirubin

FIG. 45 depicts the signal transmission as a function of time using photodegradation methods.

FIG. 46 shows the prediction of bilirubin concentration from the difference of signal measurements in blue before and after laser exposure.

FIGS. 47A-D further illustrate the change in absorbance over time as a bilirubin sample is exposed to a blue laser.

FIGS. 48A and B illustrate the underlying chemical basis for the change in absorbance as bilirubin is degraded.

FIGS. 49 and 50 depict the results of the methods according to the present invention as applied to iron.

FIGS. 51 and 52 depict the results of the methods according to the present invention as applied to triglycerides.

FIG. 53 depicts concentration for various analytes including fats and corresponding instrumentation.

FIGS. 54A and B show the absorption of water and milk versus milk concentration.

FIG. 55 shows the absorption of milk versus wavelength.

FIG. 56 depicts the optical index versus concentration of total protein.

FIG. 57 shows refraction index measurements plotted against protein concentration.

FIG. 58 shows the coupling of total proteins and triglycerides.

FIG. 59 shows a system in accordance with the present disclosure.

### DETAILED DESCRIPTION

The present disclosure provides methods for determining the concentration of one or more target analytes in a sample using the systems described herein. The systems and methods of the invention find use in numerous different industries and are applicable for analysis of numerous different types of heterogeneous samples. A particularly important use for the systems and methods of the invention is in the life sciences for the analysis of biological samples (e.g., human tissue and/or body fluid samples, such as blood or urine samples). Such analysis may aide a physician in diagnosing or accessing a disease state of a subject or patient. Generally, the methods of the invention are carried out, in part, on a device that transmits a polychromatic multiplexed light beam through a sample containing the target analyte. Spectral data is received from the sample at a detector without having to split the polychromatic beam into its different wavelength components. The spectral data is analyzed to determine presence, and optionally concentration, of one or more target analytes in the sample. In certain embodiments, the methods of the invention are conducted without reacting the target analyte with additional chemical reagents.

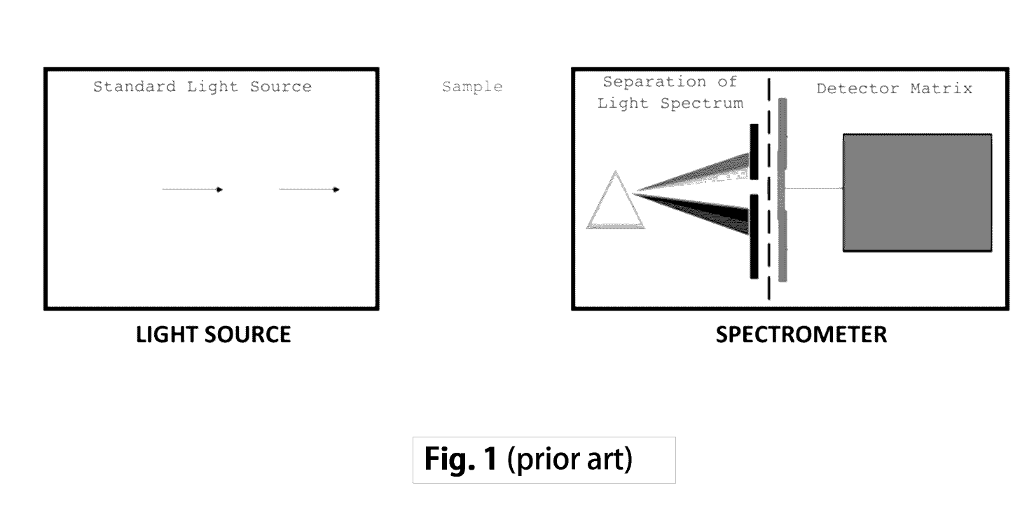

Prior spectroscopy approaches for analyzing a sample, as shown in FIG. 1 and as discussed above in the Background section, involve the use of a single light source that emits a polychromatic light beam. The beam then passes through the sample and some of the light is absorbed as the beam travels through the sample. The light beam then typically passes through a wavelength separator such as a prism and the light beam is separated into monochromatic beams. Each monochromatic beam is sent to and separately detected by a detector.

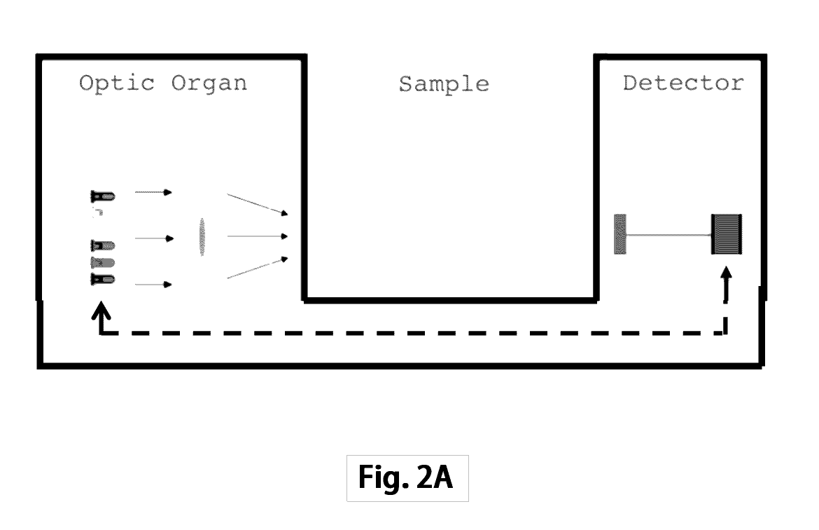

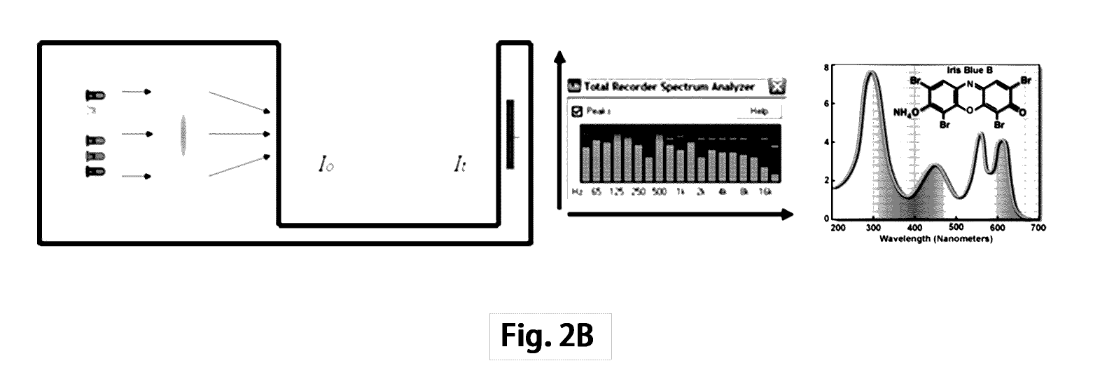

In contrast, the methods of the present invention are conducted as shown in FIGS. 2A-B using systems such as those shown in FIGS. 2A-B. As shown in FIG. 2A-B, a plurality of light sources (six light sources shown in FIGS. 2A-B, which is only exemplary) each emit a light beam at a different wavelength. The different light beams pass through an optical assembly. The optical assembly is configured to combine the light beams into one multiplexed polychromatic light beam. The resultant polychromatic light beam exits the optical assembly and then passes through the sample. After passing through the sample, the received polychromatic light beam is sent to a detector to thereby obtain a total absorption spectrum of the sample (FIG. 2B). The total absorption spectrum of the sample is then analyzed and a target analyte in a sample is detected based on the analysis of the received polychromatic light (FIG. 2B). A more detailed description of the devices in accordance with the present invention is provided below.

### A. Light Emission Devices

Aspects of the invention are accomplished using the devices described herein and in U.S. Patent Application Publication No. 2015/0304027, the content of which is incorporated by reference herein in its entirety. An exemplary light emission device includes at least two separate light sources, each emitting a light beam of at least one wavelength λ₁ or λ₂ respectively, as well as spectral multiplexing module. By “spectral multiplexing” is meant the spatial combination of several light beams, each contributing to the final spectral composition of a light beam having parallel rays, called a “collimated” light beam.

The spectral multiplexing module includes an optical assembly that may be formed of at least one lens and/or an optical prism. The optical assembly has chromatic dispersion properties, such that the light beams from the separate light sources pass through the optical assembly without spectrally selective reflection (i.e. reflection of a portion of the light beam at certain wavelengths only, the portion of the light beam at the other wavelengths being either transmitted or deflected in another favored direction) and are spatially superimposed after exiting the optical assembly, preferably without the use of a dichroic reflector or diffraction grating.

Preferably, the emission device is arranged so that each light beam propagates in free space from its corresponding light source to the optical assembly. By “free space” is meant any spatial medium for routing the signal: air, interstellar medium, vacuum, etc. as opposed to a material transport medium, such as optical fiber or wired or coaxial transmission lines. Thus there is no coupling between the light beam emitted by a light source, and a waveguide. There is no coupling known as “fiber-to-fiber” or “fiber-to-LED.” Thus, the device according to the invention has little energy loss.

In accordance with the present disclosure, a respective wavelength is associated with each light source. Throughout the following, when a wavelength of a source, or a wavelength of an emission from a source, or a wavelength λ₁ or λ₂ respectively of a source is mentioned, this associated wavelength will be designated. Each source can emit at other wavelengths apart from this associated wavelength. Each light beam of at least one wavelength λ₁ or λ₂ respectively has in any case a certain spectral width.

The superimposed light beams form a beam that is superimposed, or multiplexed. The light beams can be superimposed at a point, or at infinity, then forming a single collimated multiplexed beam. The optical assembly, owing to its chromatic dispersion properties, can convert a multicolored light beam (i.e. comprising at least two wavelengths) into at least two light beams, each at a respective wavelength. Thus, by the principle of the inverse return of light, light beams each at at least one wavelength can be moved spatially closer together at the output of the optical assembly. The term “chromatic dispersion” according to the invention comprises chromatic aberrations.

The light emission devices of the present disclosure allow for the light beams to be efficiently mixed, and the intensity of the superimposed beam to be high. Moreover, light emission devices of the present disclosure offer greater freedom of positioning of the light sources which reduces the cost of production and enables series production.

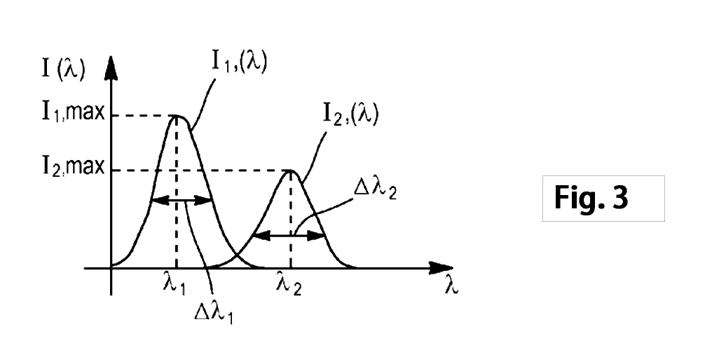

With reference to FIG. 3, the emission spectra of two light sources utilized in an emission device according to the present disclosure will be described.

The light intensity is marked I₁(λ) or I₂(λ) respectively, of two light sources that are quasi monochromatic at wavelengths λ₁ or λ₂ respectively. Each spectrum I₁(λ) or I2(λ) respectively, is “bell-shaped” (for example a Gaussian distribution) having a peak at the wavelength known as the operating wavelength λ₁ or λ₂ respectively. This peak has a full width at half maximum that is relatively small with respect to the operating wavelength.

Thus, a first light source S1 has a bell-shaped emission spectrum with:

a peak of height I_{1,max} (maximum value of the light intensity I₁(λ), i.e. I_{1,max}(λ₁)) for the operating wavelength λ₁=340 nm, and a full width at half maximum λλ₁ around the peak at λ₁, here equal to 10 nm.

In the same way, a second light source S2 has a bell-shaped emission spectrum with:

a peak of height I_{2,max} (maximum value of the light intensity I₂(λ), i.e. I_{2,max} (λ₂)) for the operating wavelength λ₂=405 nm, and a full width at half maximum Δλ₂ around the peak at λ₂, here equal to 10 nm.

The light sources S1 and S2 can then be regarded as quasi monochromatic, because the full width at half maximum Δλ₁ of the light source S1 is small with respect to the wavelength λ₁ because Δλ₁/λ₁<<1 the full width at half maximum Δλ₂ of the light source S2 is small with respect to the wavelength λ₂ because Δλ₂/λ₂<<1.

Provision can also be made to use polychromatic sources having other spectral shapes. According to the present disclosure, as a function of the position of the light source, only a portion of its spectrum centered on a wavelength known as an operating or emission wavelength will be used. It is therefore possible to use a polychromatic source, provided that its spectrum has a high intensity at this operating wavelength.

Each light source comprises (preferably consists of) a light-emitting diode (LED). The use of light-emitting diodes makes it possible to reduce the risk of failure, as LEDs are light sources that have a longer service life than the light sources usually used in devices such as a spectrometer, like incandescent or discharge sources. Moreover, LEDs have the advantage of being small and low cost.

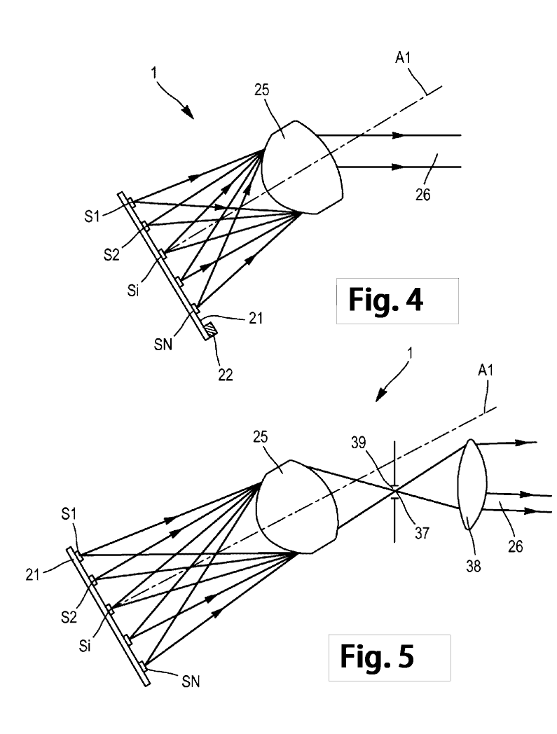

With reference to FIG. 4, a first embodiment of a light emission device 1 according to the present disclosure will be described.

In this embodiment, there are twelve light sources. For reasons of the legibility of the figure, only five light sources have been shown: S1, S2, Si, SN, where N=12. Provision can be made however for as many light sources as desired.

These light sources S1 to S12 are regarded as quasi monochromatic sources, each emitting a light beam at the wavelengths λ₁ to λ₁₂ respectively. By quasi monochromatic sources is meant a light source the emission spectrum of which is narrow in wavelength. This may be understood in the light of FIG. 3, in which the emission spectra of light-emitting diodes S1 and S2 are shown.

In addition to the light sources S1 and S2 described with reference to FIG. 3, the ten other light sources S3 to S12 emit light beams at the following wavelengths, which are ranked in increasing order of chromaticity:

### Source S3: λ₃=450 nm;

### Source S4: λ₄=480 nm;

### Source S5: λ₅=505 nm;

### Source S6: λ₆=546 nm;

### Source S7: λ₇=570 nm;

### Source S8: λ₈=605 nm;

### Source S9: λ₉=660 nm;

### Source S10: λ₁₀=700 nm

### Source S11: λ₁₁=750 nm

### Source S12: λ₁₂=800 nm

As a variant contemplated within the present disclosure, it is possible to use any other wavelength suitable for the application utilized. Preferably, the wavelengths of the light sources are comprised between 340 nanometers and 800 nanometers.

In this first embodiment, the light sources S1 to S12 are selected so that their respective emission spectra do not overlap. This means, still taking the example of light sources S1 and S2, the respective spectra of which are shown in FIG. 3, that the light intensity I₁(λ₂) of the light source S1 for the wavelength λ₂ is very low with respect to the peak value I_{2,max}, for example less than 5%, preferably less than 1% of this peak value, and that the light intensity I₂(λ₁) of the light source S2 for the wavelength λ₁ is very low with respect to the peak value I_{1,max}, for example less than 5%, preferably less than 1% of this peak value.

In one aspect, the light sources can each comprise an optical filter placed in front of them, making it possible to limit even further their respective full width at half maximum. This optical filter is a conventional spectral filter known to a person skilled in the art allowing a light beam to be transmitted only over a specific range of wavelengths known as its “pass band”. This filter can be for example an absorption filter, or an interference filter.

Each source comprises or is a light-emitting diode of encapsulated type. This means that each individual source comprises in this case at least one light-emitting diode or “LED chip” that emits light and is placed in a housing making it possible on the one hand, to dissipate the heat given off by each chip when it emits (thus ensuring a constant temperature for example using a Pelletier module as is conventionally done), and, on the other hand, to supply electrical power (in particular electric current) to each chip for its operation. The housing is thus generally constituted by a heat-resistant and electrically insulating material such as for example an epoxide polymer such as epoxy resin, or a ceramic. It includes two metal pins soldered onto the printed circuit board using two spots of solder, these solder spots making it possible on the one hand, to fix the light-emitting diode onto the printed circuit board, and on the other hand, to supply the LEDs with current.

As a variant, one and the same housing may contain several chips (“multichip LED”), the housing then generally comprising as many pairs of metal pins as there are chips incorporated in the package. This is then termed a multicore LED. The different chips of the housing are identical.

In each variant, provision may be made to replace the metal pins by simple conductive surfaces and use a technique known as SMD for “surface mounted device” (SMD). Another possibility for the production of the light sources according to the present disclosure will be described below.

In one embodiment, the printed circuit board 21 (PCB) 21 is made from a glass-fiber reinforced epoxy resin of the “FR4” type, well known in the art. In order to provide the necessary power, the printed circuit board 21 comprises a connector 22. The connector 22 is not shown in all the figures, for reasons of legibility of the figures. With reference to FIG. 9, it will be noted that this connector 22 is connected to a cable 23 linked to a power supply and control box 24 supplying a current adjusted for each of the light-emitting diodes.

The light-emitting diodes S1 to S12 each emit a light beam at their emission wavelength λ₁ to λ₁₂. Each light beam is generally a divergent beam, the LEDs being light sources emitting in a quasi-lambertian manner.

The emission device 1 comprises a spectral multiplexing module for mixing the light beams of the light sources S1 to S12 in order to form a multiplexed light beam 26.

In the embodiment of the present disclosure shown in FIG. 4, the spectral multiplexing module is formed by an optical assembly itself formed by a thick biconcave lens 25 having an optical axis A1. It is known that such a lens 25 has a lateral chromatic aberration when it is operated off its optical axis A1. A lateral chromatic aberration of an optical assembly is a variation of the lateral position (i.e. perpendicularly to the optical axis) of the focal point of an incident light beam collimated on this optical assembly then passing through this optical assembly, as a function of the wavelength of this light beam.

In fact, the lens 25 has foci F1 to F12 corresponding to the wavelengths λ₁ to λ₁₂. Because of the lateral chromatic aberration, these foci are distinct and separate, aligned in a straight line intersecting the optical axis A1 of the lens 25. The optical feature of these singular points of the lens 25 is that a light beam originating from these points is transmitted and converted by the lens 25 into the form of a light beam having parallel rays, known as a “collimated” light beam.

Thus, a light beam emitted at the wavelength λ₁ from the focus F1 in the direction of the lens 25 emerges from the lens 25 as a parallel light beam at the same wavelength λ₁. In the same way, a light beam emitted at the wavelength λ₂ from the focus F2 in the direction of the lens 25 emerges from the lens 25 as a parallel light beam at the same wavelength λ₂, being superimposed on the parallel light beam at the wavelength λ₁. The two light beams emitted from the foci F1 and F2 are therefore mixed, or “multiplexed” at the output of the lens 25.

Thus, it is to be understood that by placing the light sources S1 to S12 respectively in the positions of the foci F1 to F12 corresponding to the wavelengths λ₁ to λ₁₂ of the lens 25 having lateral chromatic aberration, the light beams emitted by the LEDs S1 to S12 are multiplexed at the output of the lens 25, in order to form a multiplexed light beam 26, here in the form of a collimated light beam. The multiplexed light beam 26 is therefore a polychromatic light beam, since it comprises several mixed wavelengths.

FIG. 5 shows a second embodiment of an emission device 1 according to the present disclosure and will be described only insofar as it differs from FIG. 4. While in the embodiment shown in FIG. 4, the light sources S1 to S12 are situated at the positions of the foci F1 to F12 corresponding to the wavelengths λ₁ to λ₁₂ of the lens 25, in this embodiment this is not the case. A “point-to-point” optical conjugation is therefore utilized, and not “focus-infinity”. Light sources S1 to S12 are situated at positions such that the lens 25 performs the optical conjugation between the light sources and a common image point 37. A spatial filter hole 39 placed at this image point 37 makes it possible to carry out a spatial filtering on the light beam emerging from the lens 25. An achromatic collimation lens 38 is placed such that the common image point 37 is placed at its object focus, which makes it possible to obtain a collimated multiplexed beam 26.

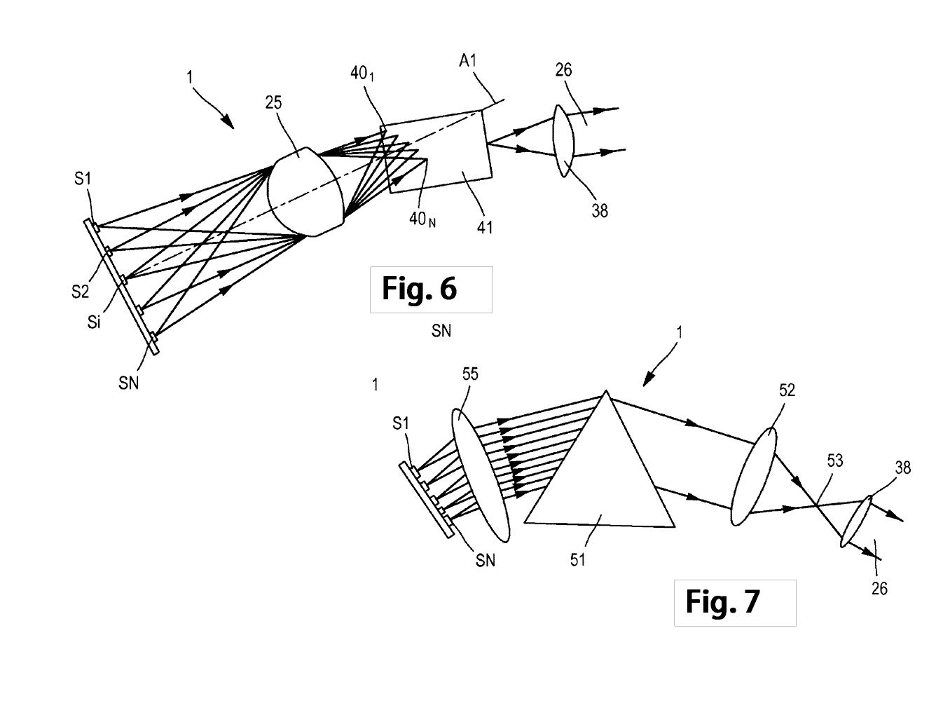

FIG. 6 shows a third embodiment of an emission device 1 according to the present disclosure and will be described only in respect of its differences with FIG. 5. In the example shown in FIG. 6, the geometric aberrations of the lens 25 are such that a common image point is not obtained for the light sources S1 to S12. Each light source is imaged by the lens 25 at a respective image point 40₁ to 40₁₂. Although the lens 25 does not image the sources S1 to S12 at a single point, it moves the light beams originating from each of the sources closer together. The points 40₁ to 40₁₂ are therefore combined in a focus volume having small dimensions, for example a thick disk that is a few millimeters in diameter and a few millimeters in height. A homogenization waveguide 41 is therefore placed in such a way that the light beams forming the image points 40₁ to 40₁₂, go inside the waveguide 41. The waveguide is for example a liquid-core optical fiber, having a diameter of 3 mm and a length of 75 mm. The light beams originating from each of the sources S1 to S12 are mixed inside the waveguide so that a homogenized light beam is obtained at the output of the waveguide. The beam is called homogenized because the contributions of each of the beams at respective wavelengths are spatially mixed. At the output of the waveguide, an achromatic collimator 38 makes it possible to obtain a collimated multiplexed beam 26. The diameter of the liquid-core optical fiber is considerably larger than the diameter of a conventional optical fiber (a few hundreds of micrometers). A liquid-core optical fiber is chosen, with a diameter of approximately 3 mm, typically between 2 mm and 6 mm, in order to ensure effective coupling in the fiber at the same time as good quality collimation at the output of the fiber.

FIG. 7 shows a fourth embodiment of an emission device 1 according to the present disclosure and will be described only insofar as it differs from FIG. 4. In this embodiment, the spectral multiplexing module comprises an optical assembly formed by an optical prism 51 surrounded by a collimation lens 55 and a focusing lens 52. The collimation lens makes it possible to collimate the light beams emerging from each of the light sources S1 to S12. Thus, several collimated beams are directed to the prism 51. At this stage, the several collimated beams can be spatially separate, or partially superimposed. The prism 51 moves these beams which emerge on the opposite face of the prism spatially closer together so that they are directed toward the focusing lens 52 which spatially combines the light beams emitted by the different light sources at an image point 53.

The prism and lenses assembly is generally used in the context of spectrometers, for spatially separating the different wavelengths. Here, in contrast they are used in order to move beams of different wavelengths spatially closer together, by exploiting the principle of the inverse return of light. The image point 53 is located at the object focus of an achromatic collimation lens 38, so that a multiplexed collimated beam 26 is obtained at the output of this lens 38.

It can be envisaged to combine the embodiment described with reference to FIG. 7 with the embodiment described with reference to FIG. 6. In particular, if a single image point 53 is not obtained but a group of image points 41_{1 to N} situated in a volume having small dimensions is obtained.

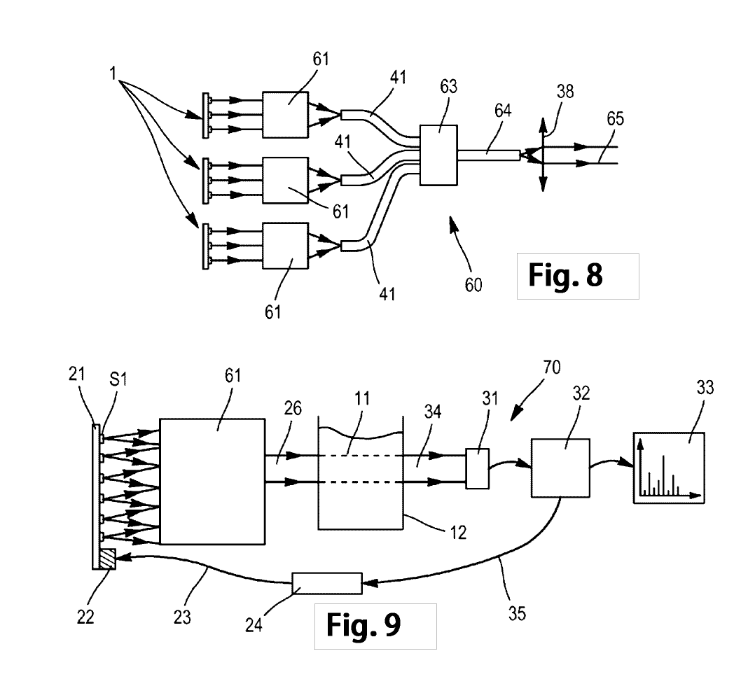

With reference to FIG. 8, an embodiment of an emission installation 60 according to the present disclosure will now be described. The emission installation 60 according to the present disclosure comprises three emission devices 1 according to the present disclosure. More precisely, in the embodiment as shown in FIG. 8, the emission installation 60 comprises three source units, a fiber splitter 63, and collimation optics 38 common to the three emission devices 1. The three source units each comprising light sources S1 to SN, where N is greater than five; for each source unit, an optical assembly 61 as described previously, in particular with reference to FIGS. 5, 6, 7; at the output of each optical assembly 61, the light beams corresponding to each source unit are focused on a single point or a plurality of points combined in a focusing area having a small volume (for example a thick disk five millimeters in diameter and 2 millimeters high). The light beams corresponding to each source unit each enter into a respective waveguide 41 which can be a homogenization waveguide. The fiber splitter 63 spatially combines the beams propagating in each waveguide 41, in a single waveguide 64 at the output of the fiber splitter 63. A polychromatic collimated multiplexed beam 65 is thus obtained at the output, combining the emission wavelengths of each of the light sources of each emission device 1.

Provision can also be made for a variant of this embodiment, in which dedicated collimation optics 38 correspond to each emission device 1, located in this case upstream of the fiber splitter 63. In this variant, it is possible to advantageously replace the fiber splitter by an arrangement of dichroic mirrors. All possible variants may be envisaged, utilizing several emission devices 1 as described with reference to FIGS. 4 to 7.

With reference to FIG. 9, an embodiment of an absorption spectrometer 70 according to the present disclosure will now be described. Such a spectrometer makes it possible to carry out an accurate chemical analysis of a sample. The absorption spectrometer 70 according to the present disclosure has lighting means formed by an emission device 1 according to the present disclosure. The multiplexed light beam 26 makes it possible to illuminate a sample 11 to be analyzed, constituted here by a human blood sample placed in a chamber 12, the characteristics of which will be detailed hereinafter.

Provision can be made for a single sample, with an operator replacing one sample with another between two measurements, or a set of samples placed in parallel so as to simply translate a single support between two measurements.

Provision can also be made for a polarizing filter for the light sources, placed in front of the sample on the path of the multiplexed light beam 26. Alternatively, the light sources can each comprise a polarizing filter placed in front of them. This polarizing filter makes it possible to increase the signal-to-noise ratio by dissociating, after transmission through the sample 11 to be analyzed, the light absorbed by the latter from the light eventually re-emitted by fluorescence. Moreover, such a polarizing filter would make it possible to also measure the rotatory power of the sample 11 to be analyzed, if exhibited thereby.

The multiplexed light beam 26 propagates in order to light illuminate sample 11 to be analyzed. The sample 11 is, for example, placed in a chamber 12, the walls of which are transparent and are not very absorbent for the wavelengths utilized in the emission device 1. The chamber 12 is here formed of a parallel epipedic tube produced from quartz. The multiplexed light beam 26 then passes through the sample 11, in which it is absorbed along its path. More precisely, each of the light beams at wavelengths λ₁ to λ₁₂ of the multiplexed light beam 26 is absorbed by the sample 11, the absorption being a priori different for each of the wavelengths λ₁ to λ₁₂.

In one aspect, one or more chemical reagents can be added to the sample 11 to be analyzed, making it possible to carry out titration of the sample 11 to be analyzed.

On output from the chamber 12, a light beam 34 is obtained transmitted by the sample 11 to be analyzed, the spectrum of this transmitted light beam 34 being characteristic of the sample 11, like a partial signature of its chemical composition. The transmitted light beam 34 is then detected and analyzed by a “detector unit”.

In particular, the detector unit comprises a detector 31, for example a “single-channel” detector, collecting the light beam 34 transmitted by the sample 11 to be analyzed. The detector 31 is here a semiconductor photodiode of the silicon type. As a variant, the detector could be an avalanche photodiode, a photomultiplier or a CCD or CMOS sensor. The detector 31 then delivers a signal relating to the light flux received for each of the wavelengths λ₁ to λ₁₂. The light flux received at a given a wavelength is linked to the level of absorption of this wavelength by the sample 11.

The signal relating to the light flux received by the detector 31 is transmitted to signal processor 32 which determines the absorption of each of the wavelengths λ₁ to λ₁₂ by the sample 11 to be analyzed. The results of the analysis of the sample 11 are then transmitted to a display 33 representing the results in the form of an absorption spectrum in which the wavelength is shown on the horizontal axis and the level of absorption of the sample 11 on the vertical axis, for example as a percentage, for the wavelength in question.

A power supply and control module 24 is arranged in order to control the light intensity of each of the light sources, for example to modulate the frequency thereof. Provision can thus be made to modulate the light intensity of each of the light sources S1 to S12 at a frequency different from each other. As explained above, the signals originating from each source can thus be distinguished during detection. Generally, the modulation frequencies are between 1 kilohertz and 1 gigahertz. The signal processor 32 then demodulates the signal delivered by the detector 31 synchronously with the light sources S1 to S12. This makes it possible in particular to use only a single detector to carry out the measurement.

Alternatively, provision can simply be made to turn each light source on or off, so that at each moment only one of the light sources emits light. Provision can also be made for combining these two embodiments. This may be referred to as spectral and time control of the spectrum of the multiplexed beam 26.

By separating the different light sources S1 to S12 in this way (by frequency modulation or turning on in succession), the measurement of the absorption on the sample 11 to be analyzed is carried out with greater accuracy. In particular, as aforementioned, the detection noise is considerably reduced.

The response time of the LEDs is very rapid, of the order of 100 ns, typically between 10 ns and 1000 ns. Spectral control that is as rapid as this can be termed time-resolved spectroscopy. Such power supply and control means 24 thus make it possible to observe very rapid phenomena. The response time of the LED is of the same order of magnitude as the response time of a suitably chosen photodiode. Owing to such response times both on the emission and reception side, very rapid phenomena can be observed, as these response times (for example of the order of a few hundred nanoseconds) are of the same order as the lifetime of the vibrational and rotational states of the molecules. It is possible for example to observe an absorption phenomenon over time. It is possible for example to observe at what speed the energy levels of a molecule are excited and de-excited.

The absorption spectrometer 70 also contains a feedback module which modifies the light intensity of each of the light sources S1 to S12 depending on the absorption of each of the wavelengths λ₁, λ₁₂ by the sample 11 to be analyzed. The feedback module comprises in particular the power supply and control module 24, the connection cable 35 between the signal processor 32 and the power supply and control module 24, and calculation means capable of implementing the feedback.

The signal processor 32 in fact transmit a signal via the connection cable 35 to the power supply and control module 24 relating to the measurement of the absorption of each of the wavelengths λ₁ to λ₁₂ by the sample 11 to be analyzed. The connection cable 35 thus establishes a feedback loop between the emission device and the detector unit. This feedback loop makes it possible to adapt the intensity of each wavelength in order to operate in the best area of sensitivity and linearity of the detector 31.

The procedure that an operator implements in order to carry out an absorption measurement by means of the absorption spectrometer shown in FIG. 9 will be described hereinafter.

### Calibration Step:

In this step, the operator starts the power supply and control module 24 allowing power to be supplied to the printed circuit board 21 comprising the twelve LEDs S1 to S12 which then each emit a divergent light beam at their respective wavelengths λ₁ to λ₁₂. A multiplexed light beam 26 is then formed, this multiplexed light beam propagating to the chamber 12 in order to illuminate it.

The operator then carries out an “empty” measurement, i.e. in this step, the chamber 12 of the absorption spectrometer is empty and does not yet contain the sample 11 to be analyzed. The multiplexed light beam 26 is therefore transmitted almost in its entirety by the chamber 12 as a transmitted light beam 34.

As a variant, the operator can carry out this calibration step with a chamber filled with water at pH=7 (hydrogen potential) the absorption spectrum of which is known.

The detector 31 then collects the transmitted light beam 34 and delivers a signal linked to the light intensity of each of the light beams emitted by the different LEDs S1 to S12, to the signal processor 32 which records this signal.

At the end of this calibration step, the signal processor has stored in memory a calibrated value of the light intensity of each of the light beams emitted by each of the light sources S1 to S12 and transmitted through the empty chamber 12 of the absorption spectrometer.

### Measurement Step:

In this step, the operator carries out a new measurement taking care to place the sample 11 to be analyzed in the chamber 12 of the absorption spectrometer.

Thus, at the end of this measurement step, the signal processor has therefore stored in memory a measured value of the light intensity of each of the light beams emitted by each of the light sources S1 to S12 and transmitted via the chamber 12 of the absorption spectrometer 10 filled by the sample 11 to be measured.

The signal processor 32 then determines, for each of the wavelengths λ₁ to λ₁₂, the ratio between the value calibrated in the calibration step and the value measured in the measurement step, this ratio being linked to the absorption of each of the monochromatic light beams forming the multiplexed light beam 26.

The results are then displayed on the display 33 in the form of a graph that the operator can view.

Depending on the relative levels of absorption from one wavelength to another, the operator can deduce therefrom the nature of the sample 11. Each chemical compound has a known absorption spectrum. The spectrum of the sample 11 is therefore a superimposition of known spectra weighted by a concentration. By deconvolution, the fraction of each chemical compound in the spectrum of the sample can be found. The high measurement sensitivity offered by the present disclosure (as explained above), improves the accuracy of this analysis of the chemical composition.

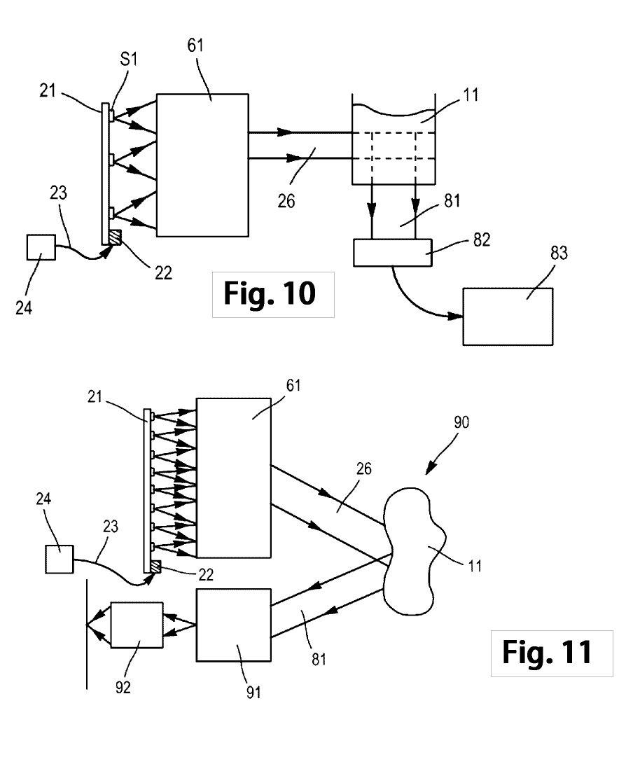

With reference to FIG. 10, a fluorescence spectrometer 80 according to the present disclosure will now be described and will be described only insofar as it differs from FIG. 9. In this embodiment, the multiplexed light beam 26 is directed toward the sample 11. In response to the absorption of the multiplexed light beam 26, the sample emits a fluorescence beam 81. A detector 82 receives this fluorescence beam 81. The detector 82 can for example consist of a photodiode or a spectrometer. Measurement of the fluorescence spectrum makes it possible to identify the constituents of the sample 11. The detector 82 is linked to signal processor 83. If the detector 82 is a spectrometer, the signal processor can form an integral part of the spectrometer.

Provision can be made for feedback module (not shown) comprising in particular the power supply and control module 24, a connection cable (not shown) between the signal processor 83 and the power supply and control means module 24, and calculation means capable of implementing the feedback. The signal processor 83 transmits a signal via the connection cable 35 to the power supply and control module 24 relating to the measurement of the fluorescence signal associated with each of the wavelengths λ₁ to λ₁₂. Such a feedback loop makes it possible to operate in the best area of sensitivity and linearity of the detector 82.

With reference to FIG. 11, a fluorescence microscopy apparatus 90 according to the present disclosure will now be described only insofar as it differs from FIG. 10.

The fluorescence beam 81 is directed toward collection module 91 such that an arrangement of at least one lens makes it possible to collect the fluorescence beam 81 in its entirety. The fluorescence beam 81 is then guided to optical magnification module 92 which focus an enlarged image of an observation area of the sample 11, for example on the retina of the eye of an observer. An image can thus be obtained of the fluorescence signal emitted by the sample 11 (which can consist of a biological tissue), for example in order to locate within the sample certain particular constituents having previously been labelled with fluorescent molecules.

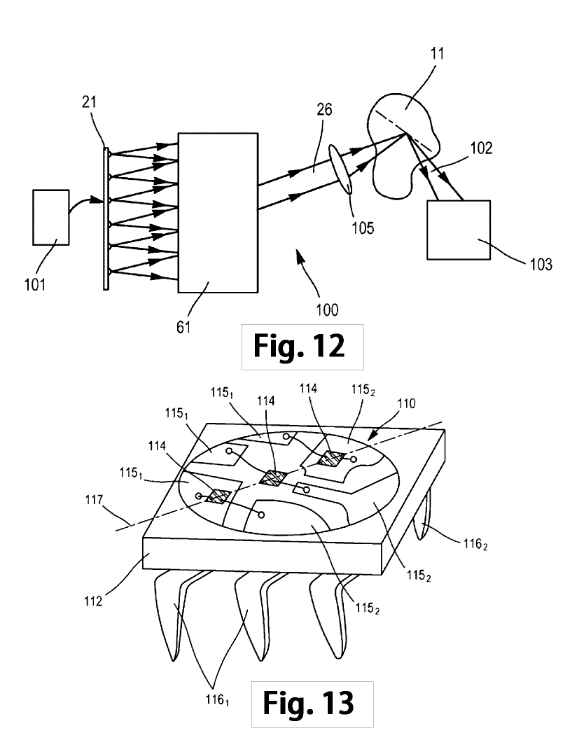

With reference to FIG. 12, a multispectral imaging apparatus 100 according to the present disclosure will now be described. The multispectral imaging apparatus 100 according to the present disclosure has lighting means formed by an emission device 1 according to the present disclosure. The multiplexed light beam 26 makes it possible to illuminate a sample 11 to be analyzed, constituted here by a sample of human tissue, within the context of an in vivo observation. A focusing lens 105 focuses the multiplexed light beam 26 onto a particular site on the sample 11 to be analyzed.

In multispectral imaging, several images are captured, each image corresponding to a very narrow band of the spectrum. Thus a much more precise definition is achieved of the light reflected by a surface and characteristics that are not visible to the naked eye can be acquired. The spectral bands can be chosen as a function of the wavelengths that are characteristic of the materials or products to be analyzed. This can be done by selecting the different light sources S1 to S12.

The multispectral imaging apparatus 100 therefore comprises control module 101, comprising a power supply and control module for the light sources as well as calculation means arranged in order to successively activate one of the several light sources. These successive activations can be controlled manually, or can be automated.

The focused light beam 26 is reflected on the sample 11 as a reflected beam 102, and propagates to imaging module 103 comprising for example sets of lenses and if appropriate a display screen. Very rapid events can thus be monitored, in particular in the context of an in vivo observation.

FIGS. 9 to 11 show different applications of the emission device according to the present disclosure. All possible combinations of these applications, and the different embodiments of the emission device described with reference to FIGS. 4 to 7, can be envisaged. It can also be envisaged, in each example described with reference to FIGS. 9 to 12, to replace the emission device according to the present disclosure by an emission installation according to the present disclosure (FIG. 8).

In one embodiment as shown in FIG. 13, a light emission unit 110 according to the present disclosure is described. The light emission unit 110 comprises three semiconductor chips 114, shown with a hatched design. The doping of each semiconductor chip makes it possible to determine the central emission wavelength of the chip, as well as the emission width. The chips are incorporated within a single component. This component can be made from plastic or ceramic. Each chip is bonded with electrically insulating adhesive onto a substrate (for example aluminum), and even sometimes directly onto an electrode. Each chip is micro-soldered to two dedicated electrodes 115₁ or 115₂ respectively by soldering with gold wire. Production of the light emission unit will not be described any further, as the present disclosure resides in the choice and arrangement of the chips of the emission unit.

The light emission unit 110 according to the present disclosure is an SMD component. FIG. 13 shows the light emission unit 110 linked to a support 112 comprising metal pins 116₁ or 116₂ respectively. Each metal pin 116₁ or 116₂ respectively is electrically linked to an electrode 115₁ or 115₂ respectively. These metal pins allow simplified wiring on a printed circuit board.

Each semiconductor chip 114 is for example in the form of a square having sides of 500 μm. The distance between two semiconductor chips 114 is of the order of 1.5 mm. This distance is measured along a straight line 117 along which the semiconductor chips are aligned.

Variants known as “multi-channel” can also be envisaged, i.e. comprising in addition means for spatial separation of the multiplexed beam into several beams of the same spectrum. Of course, the present disclosure is not limited to the examples which have just been described and numerous adjustments can be made to these examples without exceeding the scope of the corresponding disclosure. In particular all the features, forms, variants and embodiments described previously can be combined together in various combinations to the extent that they are not incompatible or mutually exclusive with one another.

In view of the foregoing description of various embodiments of light emission devices and the underlying principles, methods for analyzing target analytes can be envisaged. For example, in one embodiment, a method for analyzing a sample containing one or more target analytes includes the steps of generating two or more monochromatic light beams from two or more monochromatic light sources, combining the different monochromatic light beams into a single polychromatic light beam, illuminating the sample with the polychromatic light beam, and receiving spectral data of the target analyte in the sample to a detector without splitting the polychromatic light beam into individual wavelengths, thereby analyzing the sample. In some aspects, the different monochromatic light beams are combined into a single polychromatic light beam without use of a diffraction grating.

### B. Additional Fabrication Methods

Different methods can be provided for fabricating light emission devices for use in the various embodiments described above, in addition to other embodiments that can be envisioned from the present disclosure. Additional fabrication methods, that supplement or enhance the above fabrication methods, are described for example in U.S. Patent Application Publication No. 2016/0178143, the content of which is incorporated by reference herein in its entirety. For example, fabrication methods can be described with respect to a light emission device 1 that comprises N different light sources, N being a natural number greater than or equal to 2 (preferably greater than or equal to 3, preferably greater than or equal to 10).

As provided above, each source comprises or is a light-emitting diode of encapsulated type and is designed to operate at a given temperature and at a given electrical current. Determining each position according to the present disclosure is carried out within this hypothesis of given temperature and of given electrical current, which thus corresponds to the point of optimal operation. However, it will be noted that variations of 1 or 2 nanometers of wavelength are in any case not serious for an LED comprising a spectrum having a full width at half maximum of around ten nanometers, in particular when an optical assembly 6 is used comprising a prism 51 or an optical system 25 used off-axis and having a lateral chromatic aberration that does not select a reduced portion of this spectrum but transmits the entire spectrum of each light beam emitted by each source and passing through this optical assembly 6, as described in section B.

In one embodiment, as disclosed in Section A above, the LED housing comprises two metal pins that are connected to the support 2 respectively at an anode and at a cathode. It is possible to have a single light-emitting diode or “LED chip” per housing. In this case, each fixing of a source on the support 2 typically comprises fixing the source directly into its housing by soldering (typically SMD soldering) of the housing onto the support 2. This embodiment requires a space between two sources that is greater than the dimension of the chips, because it is at least equal to the dimension of the housings.

In another embodiment, several light-emitting diodes or “LED chips” per housing can be provided. Each fixing of a source on the support 2 typically comprises fixing the source to the support 2 using glue. Once several (preferably all) the sources have been fixed onto the support, they are encapsulated in a single housing. This arrangement makes it possible to bring the sources close together, i.e. to work with “narrower” chromatic dispersions in order to obtain a more compact light emission device, versus the embodiment described directly above.

Each source (“LED chip”) has a planar, light-emitting surface (preferably lambertian) extending parallel to a plane (and is arranged in order to emit its beam preferably in a mean direction perpendicular to this plane), so that the thickness of this source is defined perpendicularly to this plane and the diameter of this source is defined as the minimum diameter of a circle contained within this plane and able to surround this source. The diameter of each source is preferably less than 1 millimeter, more preferentially less than 300 micrometers.

By “position” Xᵢ of a source Sᵢ, is meant, quite naturally for a person skilled in the art, the position of a fixed reference point for all the sources. This is preferably the position of the center (or barycenter) of the part (or of the surface viewed from above) that generates light for each source or of the position of the upper left corner of each source, etc. This position is defined with respect to an origin X=0, arbitrarily defined. Sources will be discussed hereinafter that are in the shape of a rectangle, rhombus or square, and the position of each source will be considered to be the position of the center of the rectangle, rhombus or square formed by each source.

Similarly, when different sources are considered that are aligned, fixed, distributed, etc. on different axes (13, 14, 15, and/or 40), reference is made to the alignment, fixing, distribution, etc. of this fixed reference point (center, barycenter, corner, angle, etc.) of each source on these different axes (13, 14, 15, and/or 40).

A description will be given hereinafter of two embodiments of the method according to the present disclosure for fabricating a light emission device 1 according to the present disclosure, this light emission device 1 comprising the different, separate light sources Sᵢ (i an integer, i=1 to N) previously described and a planar support 2 common to all the sources. A first embodiment will be a fabricating method comprising measurements of the positions of the sources. A second embodiment will be a fabricating method comprising calculations of the positions of the sources.

In these two embodiments, the fabricating method according to the present disclosure comprises: for each source Sᵢ, a determination (by measurement or by calculation) of a position Xᵢ of this source Sᵢ along a fixing direction 3, as a function of optical properties of a spectral multiplexer 4 planned to be associated with this light emission device 1, of the working wavelength λ₁ of this source and of a placement 5 of the light emission device 1 with respect to the multiplexer 4, the spectral multiplexer 4 comprising an optical assembly 6 having chromatic dispersion properties; the positions X₁ to X_{N} of the sources S₁ to Sₙ are determined so that, for this placement 5 of the light emission device and for these positions X₁ to X_{N} of the sources S₁ to Sₙ, the optical assembly 6 is arranged in order to bring the light beams of the sources S₁ to Sₙ spatially closer together by means of its chromatic dispersion properties, so that the multiplexer 4 spatially superimposes (at least partially, preferably completely) said light beams into a multiplexed light beam 26, fixing, along the fixing direction 3, each source S₁ to Sₙ onto the support 2 at its previously determined position X₁ to X_{N}, so that the sources S₁ to Sₙ are distributed along the fixing direction 3 (preferably in order of increasing working wavelength λ₁ to λ_{N}, the sources S₁ to Sₙ are thus preferably ranked by increasing order of chromaticity) according to the law or the properties of chromatic dispersion of the spectral multiplexer 4. The determination step is implemented by technical means (measurement means, typically a detector and an optional filter, or calculation means).

The light emission device 1 thus obtained is arranged so that, once associated with the multiplexer 4, the multiplexer 4 implements spectral multiplexing of the beams emitted by the sources S₁ to Sₙ. The multiplexed light beam 26 is thus a polychromatic light beam, since it comprises several mixed wavelengths λ₁ to λ_{N}.

A chromatic aberration of an optical assembly 6 (comprising or consisting of for example an optical system 25 or a prism 51 such as described hereinafter) is a variation of the position of the focal point of an incident light beam collimated on this optical assembly 6 then passing through this optical assembly 6, as a function of the wavelength of this light beam.

The propagation of a light beam emitted by each light source S₁ to Sₙ takes place in free space from said source to the optical assembly 6.

The light beams are effectively mixed, and the intensity of the superimposed beam 26 is high. Moreover, this feature offers greater freedom of positioning of the light sources S₁ to Sₙ which reduces the cost of production according to the present disclosure and enables mass production. Indeed, a coupling action between an optical fiber and a source for each of the sources is not required.

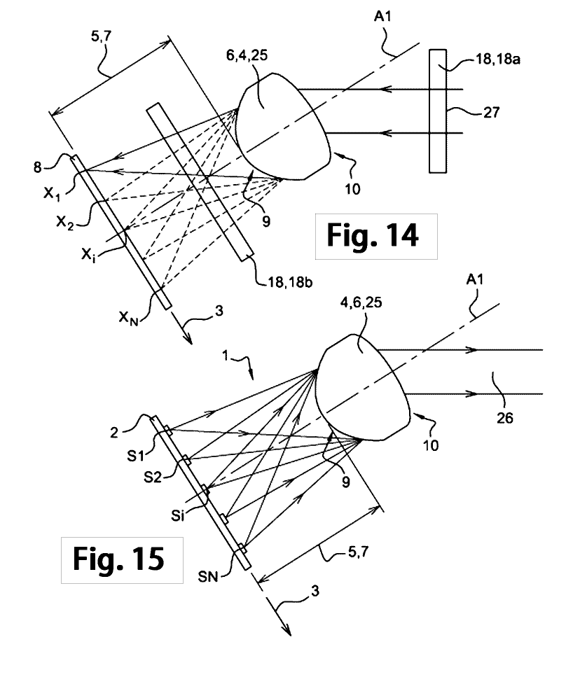

There will now be described, with reference to FIGS. 14 and 15, a first embodiment of a fabricating method according to the present disclosure for fabricating a first embodiment of light. In this first embodiment of a fabricating method according to the present disclosure, the step of determining the position of each source S₁ to Sₙ is carried out by a measurement. The multiplexer 4 consists of the optical assembly 6. optical assembly 6 comprises (and even consists of) the off-axis optical system 25, i.e. in this example a thick biconcave lens 25 having an optical axis A1 the chromatic aberrations of which are used. The lens 25 has foci F₁ to F_{N} corresponding to the wavelengths λ₁ to λ_{N}. Due to the lateral chromatic aberration, these foci are different and separated, aligned along a straight line secant with the optical axis A1 of the lens 25.

The optical assembly 6 thus comprises an optical system (the lens 25 in this particular case) having a lateral chromatic aberration, the determined positions of the sources S₁ to Sₙ corresponding to an off-axis use of the optical system.

A detector 8 is used which has the same shape (here, planar) as the support 2. The detector 8 is arranged in order to detect a light beam focused thereon, and to determine a position of the focal point of this beam on the detection surface of this detector 8.

The detector 8 is typically an array detector (CCD (“Charge-Coupled Device”) camera or PDA (“Photo Diode Array”) detector or PMT (“Photo Multiplier Tube”) array or not (for example a PSD (for “Position Sensitive Detector”) diode.

The placement 5 of the light emission device 1 with respect to the multiplexer 4, considered for determining the positions of the sources S₁ to Sₙ corresponds to a distance 7 between the apex of the concave surface 9 of the lens 25 oriented towards the support 2, and the support 2 this support 2 being planar and positioned perpendicularly to the axis A1 of the lens 25.

In order to measure the position Xᵢ, along the fixing direction 3, of each source Sᵢ, the detector 8 is positioned at this placement 5 with respect to the multiplexer 4, i.e. in this example at the distance 7 previously considered, but this time between the apex of the concave face 9 of the lens 25 oriented towards the detector 8 and the detector 8, since the detector 8 replaces the support 2, and perpendicularly to the axis A1 of the lens 25. Finally, the other face 10 of the lens 25 is then illuminated by a collimated beam 27 of white light, corresponding to a use off-axis A1 of the lens 25.

Furthermore, either at a position 18b between the detector 8 and the multiplexer 4, or at a position 18a before the lens 25, i.e. in the collimated beam 27 of white light, the following are also provided: a very selective filter 18 (pass-band filter, full width at half maximum of 10 nm) allowing the working wavelength λᵢ of this source to pass (typically allowing at least 90% of the intensity of this working wavelength λᵢ to pass) but blocking the working wavelengths of the other sources (typically blocking at least 90% of the intensity of these wavelengths, preferably blocking at least 99.9% of the intensity of these wavelengths). Thus the position Xᵢ of the source Sᵢ is determined as the position of the focal point detected by the detector 8. This procedure is carried out for each source, changing the filter 18 for each source.

The position 18a is very clearly preferred. In fact, the filter 18 is generally optimized and operates best at a given incidence (normal incidence in the case of FIG. 14), and at the position 18a there is no variation of incidence of the different wavelengths on the filter 18, while at the position 18b the different wavelengths have different incidences on the filter 18.

In a variant, the filter 18 can be dispensed with by replacing the while beam 27 with a monochromatic beam 27 at the working wavelength λ+ of the source Sᵢ for which it is sought to determine the position Xᵢ, and by thus changing the monochromatic wavelength of the beam 27 for each source S.

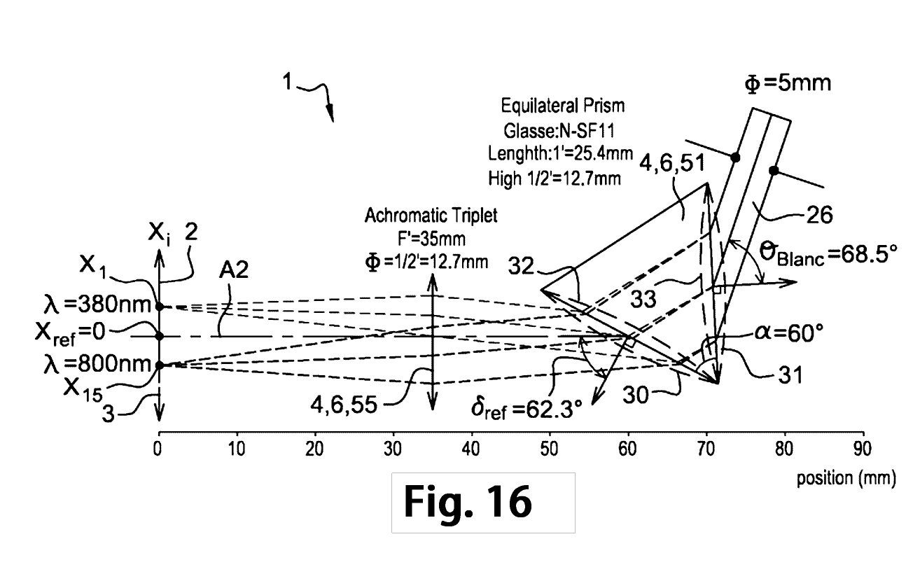

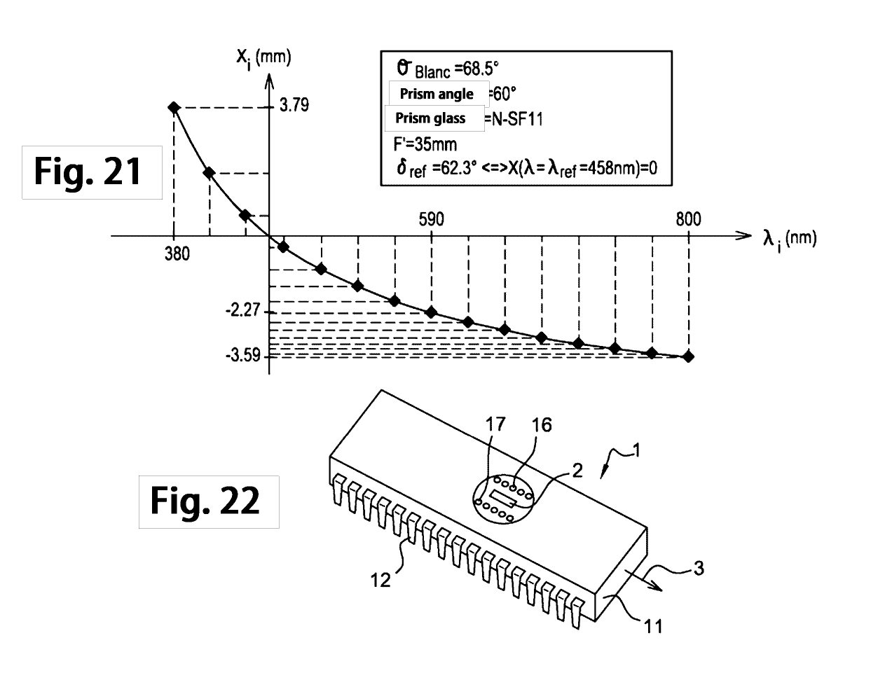

There will now be described, with reference to FIGS. 16 to 21, a second embodiment of the fabricating method according to the present disclosure for fabricating a second embodiment of the light emission device according to the present disclosure. In this second embodiment of the fabricating method according to the present disclosure, the step of determining the position of each source S₁ to Sₙ is carried out by a calculation.

In this second embodiment of light emission device 1 according to the present disclosure, the optical assembly 6 comprises an achromatic doublet 55 and a prism 51 the chromatic dispersion properties (more precisely the chromatic aberration properties) of which are used. This chromatic aberration forms the chromatic dispersion property according to the present disclosure in this embodiment.

In order to determine the position of each of the sources S₁ to Sₙ it is necessary to investigate the response of the multiplexer in the “reverse direction of use”, i.e. to investigate the chromatic dispersion of a white collimated beam.

In the optical assembly 6, the prism 51 converts a collimated white beam 27 into a multitude of collimated monochromatic beams 28 the directions of which depend on their wavelengths, and the doublet 55 focuses the collimated beams 28 in its focal plane as a function of their direction (but not of their wavelength).

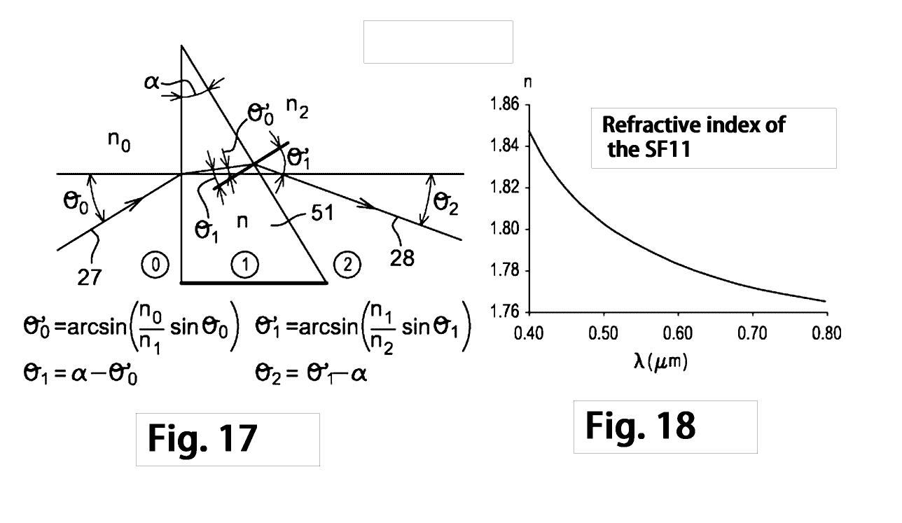

As shown in FIG. 17, for the prism 51, if n₀=n₂=1 (with n₀ and n₂ the outside optical indices of the prism 51 at each of its sides) thus the value of the deviation δ of a light ray is:

δ=θ₀+θ₂=θ₀ arcsin(n sin [α−arcsin((1/n)sin θ₀))−α

where:
θ₀ is the angle of incidence of the ray
n is the optical index of the prism 51 (function of the wavelength of the ray λ); for example, FIG. 16 shows the value of n as a function of the wavelength λi in the case of a SF11 glass prism 51; and α is the angle at the apex of the prism.

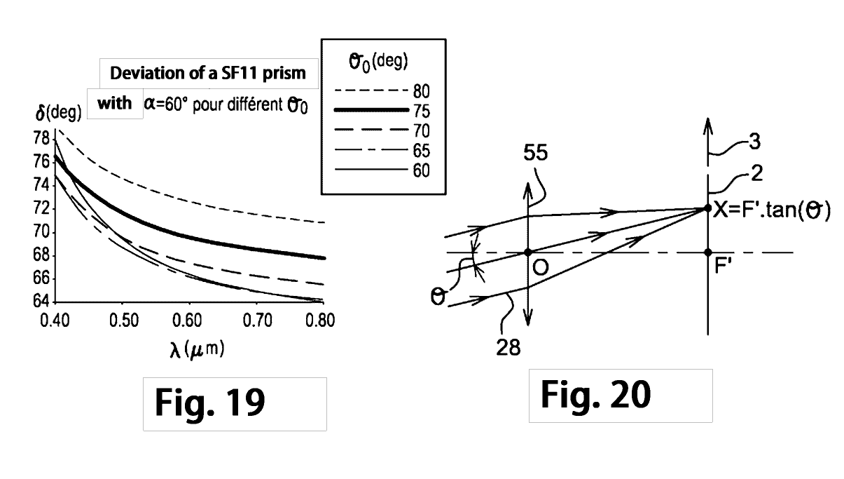

FIG. 19 gives different examples of deviation δ as a function of the wavelength λ and of θ0 for α=60° (the prism 51 typically has a profile in the shape of an equilateral triangle, as this is a standard component and therefore inexpensive).

With reference to FIG. 10, the achromatic doublet 55 conjugates a collimated beam 28 (point at infinity) to a point of its focal plane according to the relationship:

X=F′·tan(θ)
Where:
F′ is the focal length of the doublet 55;
X is the height in the focal plane; and
θ is the angle of the collimated beam

Unlike a simple lens, the focal length of the achromatic doublet 55 is quasi-independent of λ. In order to reduce the focal length and/or increase the aperture a triplet may be preferred. Thus, Xᵢ(λᵢ) of the source Si of working wavelength λᵢ (with i an integer i=1 to N) is determined by calculating it according to the formula:

Xᵢ(λᵢ)=F′ tan └δ(λᵢ)−δ(λ_{ref})┘

with

δ(λᵢ)=θ₀+arcsin(n(λ₁)sin [α−arcsin((sin θ₀)/(n(λi)))])−α

and λ_{ref} is the wavelength for which the origin of positions (X(λ_{ref})=0) is arbitrarily set.

This step of determination by calculation is implemented by technical means, more precisely by calculation means. The calculation means typically comprise a processor, typically an analogue and/or digital electronic circuit, and/or a microprocessor and/or a computer central processing unit.

FIG. 11 shows an example for an SF11 glass prism, for α=60°, for θ₀=0White=68.5°, for F′=35 mm and for δ_{ref}=δ(λ_{ref})=62.3°.

This step of determination by calculation could be completed by an optical design step: radiometric optimization. This calculation step consists of simulating the source+optical system assembly in the sense of actual operation so as to optimize the collimated white exit beam by slight modifications of the position of the sources as well as of the radii of curvature, thicknesses and/or positions of the optics of the multiplexer.

The table below shows an example for an SF11 glass prism, for α=60°, for θ₀=θWhite=68.5°, for F′=35 mm, for δ_{ref}=δ(λ_{ref})=62.3° and for N=15.

| | Number of the source i= | | | | | | | |
|---|---|---|---|---|---|---|---|---|
| | 1 | 2 | 3 | 4 | 5 | 6 | 7 | 8 |
| Working wavelength | 380 | 410 | 440 | 470 | 500 | 530 | 560 | 590 |
| λᵢ of this source (in | | | | | | | | |
| mn) | | | | | | | | |
| Position Xᵢ of this | 3.79 | 1.84 | 0.57 | −0.32 | −0.99 | −1.52 | −1.93 | −2.27 |
| source along the | | | | | | | | |
| direction 3 (in mm) | | | | | | | | |
| Position Yᵢ of this | 0 | 0 | 0 | 0 | 0 | 0 | 0 | 0 |
| source | | | | | | | | |
| perpendicularly to | | | | | | | | |
| the direction 3 (in | | | | | | | | |
| mm) | | | | | | | | |

| | Number of the source i= | | | | | | |
|---|---|---|---|---|---|---|---|
| | 9 | 10 | 11 | 12 | 13 | 14 | 15 |
| Working wavelength | 620 | 650 | 680 | 710 | 740 | 770 | 800 |
| λᵢ of this source (in | | | | | | | |
| nm) | | | | | | | |
| Position Xᵢ of this | −2.56 | −2.8 | −3 | −3.18 | −3.33 | −3.47 | −3.59 |
| source along the | | | | | | | |
| direction 3 (in mm) | | | | | | | |
| Position Yᵢ of this | 0 | 0.125 | −0.125 | 0.125 | −0.125 | 0.125 | −0.125 |
| source | | | | | | | |
| perpendicularly to | | | | | | | |
| the direction 3 (in | | | | | | | |
| mm) | | | | | | | |

There will now be described, with reference to FIGS. 15, 16, 22 and 23, the steps of the first or the second embodiment of a fabricating method according to the present disclosure following the step of determining the position X₁ of each source Sᵢ. As an example, the case will be considered of the fifteen positions X₁ to X₁₅, summarized in the above table, which correspond to the positions determined by calculation but which can also correspond to values determined by measurements according to the first embodiment of the fabricating method according to the present disclosure.

After having determined the positions of the sources S₁ to S_{N}, the fabricating method according to the present disclosure shown comprises fixing each source S₁ to Sₙ, along the fixing direction 3, onto the support 2 at its previously determined position X₁ to X_{N}, so that the sources S₁ to Sₙ are distributed along the fixing direction 3 in order of increasing working wavelength λ₁ to λ_{N} and according to the law or the properties of chromatic dispersion of the spectral multiplexer.

It is noted that according to the present disclosure it is not simply sought to put the sources S₁ to Sₙ closer to one another: the spacing between the sources S₁ to Sₙ must comply with the law of chromatic dispersion of the optical assembly 6 for which it is designed.

The support 2 is a planar surface firmly fixed to an electronic chip 11 equipped with connecting pins 12 arranged in order to fix the chip 11 onto an electronic circuit board and to make it possible to supply each source S₁ to Sₙ independently with electricity.

The support 2 is covered with glue before placing each source S₁ to Sₙ. According to the chosen method of electrical supply, either conductive glue or insulating glue is used.

In order to fix each source Sᵢ onto the support 2, this source is held by a suction tip, and the source Sᵢ is placed on the support 2 (more precisely in contact with the glue) by the suction tip, at its previously determined position Xᵢ. During placement, the projection of the tip over the plane of the support 2 remains fixed, and the support 2 is mounted on a piezoelectric displacement stage and is mobile so as to place the source Sᵢ at its correct, previously determined position Xᵢ. An additional baking step is implemented in order to set the glue permanently.

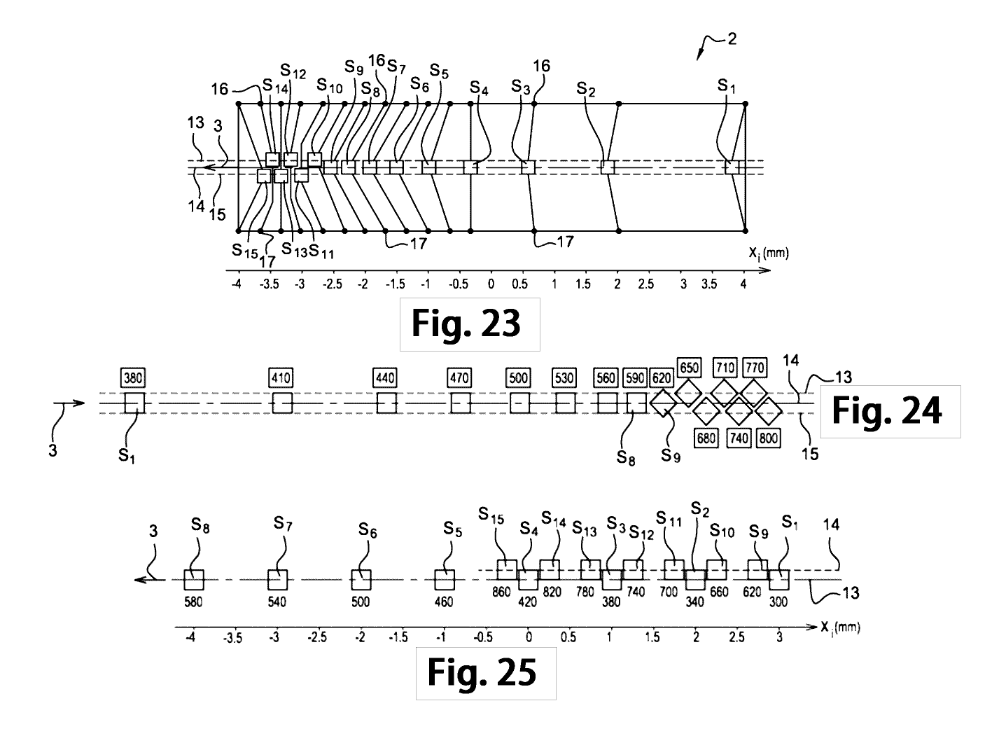

With reference to FIG. 23, it is advisable for the fixing to comprise fixing the sources S₁ to Sₙ on at least two (preferably at least three, preferably three) parallel fixing axes 13, 14, 15 extending along the fixing direction 3. Thus, the sources do not necessarily have the same coordinates Y₁ to Y_{N} perpendicular to the direction 3. Thus, the space requirement of the sources S₁ to Sₙ is reduced by “superimposing” them on the axis X by means of an offset in the Y direction.

It is noted that the light emission device 1 according to the present disclosure, obtained by a fabricating method according to the present disclosure, is particularly appropriate in that it comprises sources S₁ to Sₙ on at least two (preferably at least three, preferably three) parallel fixing axes 13, 14, 15 extending along the fixing direction 3.

Among the sources S₁ to Sₙ there are pairs of two sources (for example S₁₀ and S₁₁, or S₁₁ and S₁₂, or S₁₂ and S₁₃, or S₁₃ and S₁₄, or S₁₄ and S₁₅) having adjacent positions along the fixing direction 3 (i.e. without a third source having an intermediate position along the fixing direction 3 comprised between the positions of these two sources along the fixing direction 3) but which are not fixed on the same fixing axis 13, 14, 15.

It is noted that the sources S₁ to Sₙ comprise two sets:

a first set of sources S1 to S9, and a second set of sources S10 to S15 the working wavelengths λ₁₀ to λ₁₅ of which are greater than all the working wavelengths λ₁ to λ₉ of the sources of the first set.

All the sources of the second set belong to a pair of two sources (for example S₀ and S₁₁, or S₁₁ and S₁₂, or S₁₂ and S₁₃, or S₁₃ and S₁₄, or S₁₄ and Sᵢₛ) having adjacent positions along the fixing direction 3 but which are not fixed on the same fixing axis 13, 14, 15. Each source is linked to an anode 16 and to a cathode 17 (typically by gold wire bonding).

As has just been described, the light emission device 1 comprises the support 2 and the sources S₁ to Sₙ. The light emission device 1 can moreover comprise the chip 11 firmly fixed to the support 2. The light emission device can moreover comprise control electronics (not shown), arranged in order to control each source independently of the other sources. Typically, this control electronics is an electronic circuit board (printed circuit) on which the chip 11 is fixed.

Moreover, the fabricating method according to the present disclosure can comprise, as shown in FIGS. 15 and 16, after the fixing of each source S₁ to Sₙ, associating the light emission device 1 with the spectral multiplexer 4 considered in order to determine the position X₁ to X_{N} of each source S₁ to Sₙ. By this association, a method is thus proposed for fabricating an assembly comprising the light emission device 1 and the multiplexer. The multiplexer 4 is associated with the light emission device 1 by placing the light emission device 1 at its placement 5 considered during the determination of the positions X₁ to X_{N} of sources S₁ to Sₙ. The light emission device 1 plus multiplexer 4 assembly can form a part of an absorption spectrometer, the spectral multiplexer 4 being capable of mixing the light beams of the sources S₁ to Sₙ in order to form a multiplexed (or superimposed) light beam 26 intended to illuminate a specimen to be analyzed.

For example, in the case of the first embodiment of a light emission device according to the present disclosure shown in FIG. 15, the support 2 is placed:

at the distance 7, with respect to the lens 25, considered for determining the position X₁ to X_{N} of each source S₁ to Sₙ with the inclination of the support 2 (for example perpendicular), with respect to the axis A1, considered for determining the position X₁ to X_{N} of each source S₁ to Sₙ, assuming that the intersection of the support 2 and the axis A1 corresponds to a position reference value X_{ref} (for example X_{ref}=0) considered for determining the position X₁ to X_{N} of each source S₁ to Sₙ.

Similarly, in the case of the second embodiment of a light emission device according to the present disclosure shown in FIG. 16, the support 2 is placed:

at the focal length F′, with respect to the doublet 55, considered for determining the position X₁ to X_{N} of each source S₁ to Sₙ with the inclination of the support 2 (a priori perpendicular), with respect to the optical axis A2 of the doublet 55, considered for determining the position X₁ to X_{N} of each source S₁ to Sₙ, assuming that the intersection of the support 2 and the optical axis of the doublet 55 corresponds to a position reference value X_{ref} (for example X_{ref}=0 in the case of the fifteen values calculated in the preceding table) considered for determining the position X₁ to X_{N} of each source S₁ to Sₙ.

With reference to FIG. 24 which is a variant that will be described only with regard to its differences with respect to the case of FIG. 23 (with preferably the same optical assembly 6 as in the case of FIG. 13), each source S₁ to Sₙ has the shape of a quadrilateral, square or rhombus. For at least a part of the sources (S₉ to S₁₅) one after another along the fixing direction 3, each source has one of the diagonals of its quadrilateral shape aligned on one of the fixing axes 13, 14 or 15. This makes it possible to bring the axes closer together, i.e. to work with “narrower” chromatic dispersions, so as to obtain a more compact light emission device and thus more effective collection.

With reference to FIG. 25 which is a variant that will be described only with regard to its differences with respect to the case of FIG. 23, the sources S₁ to Sₙ (N=15) are distributed on different fixing axes 13, 14 so that:

the first fixing axis 13 corresponds to a first working wavelength range (300 to 580 nm) of the sources S₁ to S₈ distributed on this axis 13, and
the second fixing axis 14 corresponds to a second working wavelength range (620 to 860 nm) of the sources S₉ to S₁₅ distributed on this axis 14, so that there is no intersection between these two working wavelength ranges, but that the sources of the first working wavelength range (300 to 580 nm) and the sources of the second working wavelength range (620 to 860 nm) are situated one after another (perpendicularly to the direction 3). Thus, all the sources S₁ to S₁₅ considered as a whole are not distributed along the fixing direction 3 in order of increasing working wavelength λ₁ to λ₁₅.

It is therefore noted that: for the fixing axis 13 considered individually, each source S₁ to S₈ of this axis 13 is fixed along the fixing direction 3 on the support 2 at its position respectively X₁ to X₈ determined according to the previously described first or second embodiment of the method according to the present disclosure (measurement or calculation) so that the sources S₁ to S₈ of this axis 13 are distributed along the fixing direction 3 in order of increasing working wavelength λ₁ to λ₈, and for the fixing axis 14 considered individually, each source S₉ to S₁₅ of this axis 14 is fixed along the fixing direction 3 on the support 2 at its position respectively X₉ to X₁₅ determined according to the previously described first or second embodiment of the method according to the present disclosure (measurement or calculation) so that the sources S₉ to S₁₅ of this axis 14 are distributed along the fixing direction 3 in order of increasing working wavelength λ₁ to λ₁₅.

On the other hand, unlike the case in FIGS. 23 and 24, it is noted that all the sources S₁ to S₁₅ considered as a whole are not distributed along the fixing direction 3 in order of increasing working wavelength λ₁ to λ₁₅.

The case of FIG. 25 corresponds preferably to the case of FIG. 16 for which the prism 51 is replaced by a diffraction grating. Thus in this case the multiplexer and the optical assembly comprise the same diffraction grating. The first fixing axis 13 uses the first-order chromatic dispersion properties of the diffraction grating and the second fixing axis 14 uses the second-order chromatic dispersion properties of the diffraction grating. It is noted in FIG. 15 that the dispersion of a diffraction grating is linear.

It is possible that all of the sources taken as a whole are not distributed along the fixing direction 3 in order of increasing working wavelength. This is the case in particular, with reference to FIG. 29, when the optical assembly 6 has chromatic dispersion properties comprising chromatic folding in the plane of the support 2, as for an apochromatic objective. In the case of FIG. 29, in the light of the different parallel axes 13, 14, 15 and 40, it is noted that: for the fixing axis 40 considered individually, each source S₉ to S₃ of this axis 40 is fixed along the fixing direction 3 on the support 2 at its position respectively X₁ to X₃ determined according to the previously described first or second embodiment of the method according to the present disclosure (measurement or calculation) so that the sources S₉ to S₃ of this axis 40 are distributed along the fixing direction 3 by decreasing order of working wavelength λ₁ to λ₃ for the fixing axis 13 considered individually, each source S₁₀, S₁₂, and S₁₄ of this axis 13 is fixed along the fixing direction 3 on the support 2 at its position respectively X₁₀, X₁₂, and X₁₄, determined according to the previously described first or second embodiment of the method according to the present disclosure (measurement or calculation) so that the sources S₁₀, S₁₂, and S₁₄ of this axis 13 are distributed along the fixing direction 3 in order of increasing working wavelength λ₁₀, λ₁₂, λ₁₄, for the fixing axis 14 considered individually, each source S₄ to S₉ of this axis 14 is fixed along the fixing direction 3 on the support 2 at its position respectively X₄ to X₉ determined according to the previously described first or second embodiment of the method according to the present disclosure (measurement or calculation) so that the sources S₄ to S₉ of this axis 14 are distributed along the fixing direction 3 in order of increasing working wavelength λ₁ to X₉, and [0176] for the fixing axis 15 considered individually, each source S₁₁, S₁₃, and S₁₅ of this axis 15 is fixed along the fixing direction 3 on the support 2 at its position respectively X₁₁, X₁₃, and X₁₅, determined according to the previously described first or second embodiment of the method according to the present disclosure (measurement or calculation) so that the sources S₁₁, S₁₃, and S₁₅ of this axis 15 are distributed along the fixing direction 3 in order of increasing working wavelength λ₁₁, λ₁₃, and λ₁₅.

Unlike the case in FIGS. 23 and 24, it is noted that all the sources S₁ to S₁₅ considered as a whole are not distributed along the fixing direction 3 in increasing order of working wavelength λ₁ to λ₁₅.

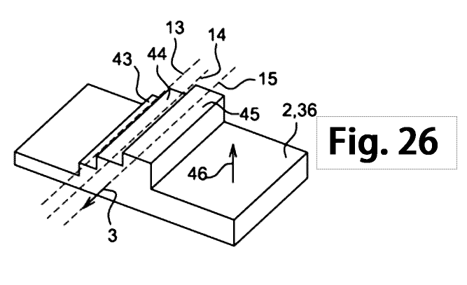

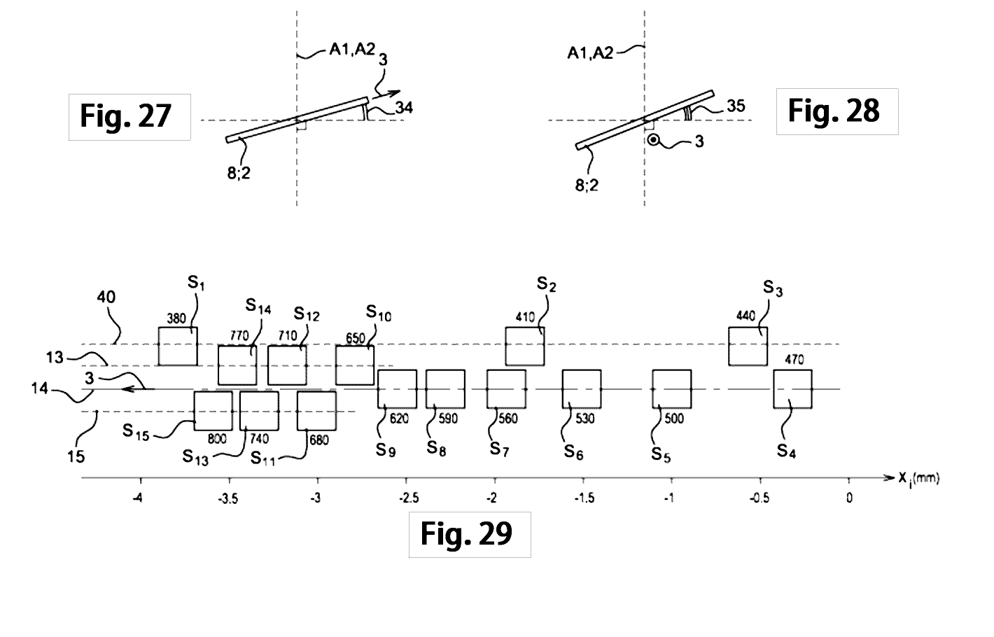

With reference to FIGS. 26 to 28, it will be noted that for all the embodiments described: the support 2 (just like the detector 8 in the case of a measurement) can, with reference to FIG. 27, be inclined at an angle 34 (about an axis perpendicular to the fixing direction 3) and/or the support 2 (just like the detector 8 in the case of a measurement) can, with reference to FIG. 28, be inclined at an angle 35 (about an axis parallel to the fixing direction 3) with respect to the optical axis A1 or A2, and/or with reference to FIG. 26, the planar support 2 can be equipped with relief patterns (cavities, bumps, grooves and/or steps) so that when the sources S1 to SN are fixed onto the support 2, some sources are fixed onto these patterns and are raised with respect to other sources along a normal 46 to the plane 36 of the support 2, so as to compensate for the longitudinal chromatic aberrations of the spectral multiplexer.

It is particularly appropriate to have as patterns a step 43, 44, 45 for each fixing axis 13, 14, 15, each step 43, 44, 45 having a different elevation from the other steps along a normal 46 to the plane 36 of the support 2. In the case of FIG. 25 (the optical assembly 6 preferably being a diffraction grating), it is particularly appropriate to have a step 43, 44 for each working wavelength range, i.e. for each fixing axis 13, 14, each step 43, 44 having a different elevation from the other steps along the normal 46 to the plane 36 of the support 2.

Of course, the present disclosure is not limited to the examples which have just been described and numerous adjustments can be made to these examples without exceeding the scope of the present disclosure.

Of course, the various characteristics, forms, variants and embodiments of the present disclosure can be combined together in various combinations insofar as they are not incompatible or mutually exclusive. In particular, all the previously described variants and embodiments can be combined together.

For example, it is possible to use the first embodiment of the method according to the present disclosure (measurement) for fabricating the second embodiment of a light emission device according to the present disclosure. Similarly, it is possible to use the second embodiment of the method according to the present disclosure (calculation) for fabricating the first embodiment of a light emission device according to the present disclosure. Moreover, the second embodiment of the method according to the present disclosure (calculation) can be based on a calculation in which the calculation steps, implemented by technical means, are based on a theoretical model or on a digital simulation model.

Finally, the first or the second embodiment of the method according to the present disclosure (measurement or calculation) can be used to fabricate numerous other example embodiments of a light emission device according to the present disclosure. It will be noted for example that the prism 51 can be replaced or combined with a diffraction grating, the chromatic dispersion properties of which can also be used.

For example, the first or the second embodiment of the method according to the present disclosure (measurement or calculation) can be used to fabricate a variant of the second embodiment of a light emission device according to the present disclosure (FIG. 16), in which: the prism 51 has a domed (preferably concave) entry face 30 of the light beams, and/or a domed (preferably concave) exit face 31 of the light beams, or the prism 51 is replaced by two lenses, including a first lens positioned on the entry face of the light beams of the prism 51, and a second lens (face 31 and 33) positioned on the exit face of the light beams of the prism 51, i.e. by two lenses (preferably biconcave) the optical axes of which intersect between these two lenses.

C. Sample Analysis Methods without Use of Chemical Reagents

The apparatuses described above can be used/provided to analyze various different types of samples. An exemplary method involves illuminating a heterogeneous sample including a target analyte with polychromatic light. Spectral data of the heterogeneous sample and the target analyte is then received to a detector without splitting the polychromatic light into individual wavelengths, thereby analyzing the heterogeneous sample. In certain embodiments, the heterogeneous samples can be analyzed without the use of chemical reagents.

A wide range of heterogeneous samples can be analyzed, such as biological samples, environmental samples (including, e.g., industrial samples and agricultural samples), and food/beverage product samples, etc.

Exemplary environmental samples include, but are not limited to, groundwater, surface water, saturated soil water, unsaturated soil water; industrialized processes such as waste water, cooling water; chemicals used in a process, chemical reactions in an industrial processes, and other systems that would involve leachate from waste sites; waste and water injection processes; liquids in or leak detection around storage tanks; discharge water from industrial facilities, water treatment plants or facilities; drainage and leachates from agricultural lands, drainage from urban land uses such as surface, subsurface, and sewer systems; waters from waste treatment technologies; and drainage from mineral extraction or other processes that extract natural resources such as oil production and in situ energy production.

Additionally exemplary environmental samples include, but certainly are not limited to, agricultural samples such as crop samples, such as grain and forage products, such as soybeans, wheat, and corn. Often, data on the constituents of the products, such as moisture, protein, oil, starch, amino acids, extractable starch, density, test weight, digestibility, cell wall content, and any other constituents or properties that are of commercial value is desired.

Exemplary biological samples include a human tissue or bodily fluid and may be collected in any clinically acceptable manner. A tissue is a mass of connected cells and/or extracellular matrix material, e.g. skin tissue, hair, nails, nasal passage tissue, CNS tissue, neural tissue, eye tissue, liver tissue, kidney tissue, placental tissue, mammary gland tissue, placental tissue, mammary gland tissue, gastrointestinal tissue, musculoskeletal tissue, genitourinary tissue, bone marrow, and the like, derived from, for example, a human or other mammal and includes the connecting material and the liquid material in association with the cells and/or tissues. A body fluid is a liquid material derived from, for example, a human or other mammal. Such body fluids include, but are not limited to, mucous, blood, plasma, serum, serum derivatives, bile, blood, maternal blood, phlegm, saliva, sputum, sweat, amniotic fluid, menstrual fluid, mammary fluid, peritoneal fluid, urine, semen, and cerebrospinal fluid (CSF), such as lumbar or ventricular CSF. A sample may also be a fine needle aspirate or biopsied tissue. A sample also may be media containing cells or biological material. A sample may also be a blood clot, for example, a blood clot that has been obtained from whole blood after the serum has been removed.

In one embodiment, the biological sample can be a blood sample, from which plasma or serum can be extracted. The blood can be obtained by standard phlebotomy procedures and then separated. Typical separation methods for preparing a plasma sample include centrifugation of the blood sample. For example, immediately following blood draw, protease inhibitors and/or anticoagulants can be added to the blood sample. The tube is then cooled and centrifuged, and can subsequently be placed on ice. The resultant sample is separated into the following components: a clear solution of blood plasma in the upper phase; the buffy coat, which is a thin layer of leukocytes mixed with platelets; and erythrocytes (red blood cells). Typically, 8.5 mL of whole blood will yield about 2.5-3.0 mL of plasma.

Blood serum is prepared in a very similar fashion. Venous blood is collected, followed by mixing of protease inhibitors and coagulant with the blood by inversion. The blood is allowed to clot by standing tubes vertically at room temperature. The blood is then centrifuged, wherein the resultant supernatant is the designated serum. The serum sample should subsequently be placed on ice.

Prior to analyzing a sample, the sample may be purified, for example, using filtration or centrifugation. These techniques can be used, for example, to remove particulates and chemical interference. Various filtration media for removal of particles includes filer paper, such as cellulose and membrane filters, such as regenerated cellulose, cellulose acetate, nylon, PTFE, polypropylene, polyester, polyethersulfone, polycarbonate, and polyvinylpyrolidone. Various filtration media for removal of particulates and matrix interferences includes functionalized membranes, such as ion exchange membranes and affinity membranes; SPE cartridges such as silica- and polymer-based cartridges; and SPE (solid phase extraction) disks, such as PTFE- and fiberglass-based. Some of these filters can be provided in a disk format for loosely placing in filter holdings/housings, others are provided within a disposable tip that can be placed on, for example, standard blood collection tubes, and still others are provided in the form of an array with wells for receiving pipetted samples. Another type of filter includes spin filters. Spin filters consist of polypropylene centrifuge tubes with cellulose acetate filter membranes and are used in conjunction with centrifugation to remove particulates from samples, such as serum and plasma samples, typically diluted in aqueous buffers.

Filtration is affected in part, by porosity values, such that larger porosities filter out only the larger particulates and smaller porosities filtering out both smaller and larger porosities. Typical porosity values for sample filtration are the 0.20 and 0.45 μm porosities. Samples containing colloidal material or a large amount of fine particulates, considerable pressure may be required to force the liquid sample through the filter. Accordingly, for samples such as soil extracts or wastewater, a prefilter or depth filter bed (e.g. “2-in-1” filter) can be used and which is placed on top of the membrane to prevent plugging with samples containing these types of particulates.

In some cases, centrifugation without filters can be used to remove particulates, as is often done with urine samples. For example, the samples are centrifuged. The resultant supernatant is then removed and frozen.

After a sample has been obtained and purified, the sample can be analyzed to determine the concentration of one or more target analytes, such as elements within a blood plasma sample. With respect to the analysis of a blood plasma sample, there are many elements present in the plasma, such as proteins (e.g., Albumin), ions and metals (e.g., iron), vitamins, hormones, and other elements (e.g., bilirubin and uric acid). Any of these elements may be detected using methods of the invention. More particularly, methods of the invention can be used to detect molecules in a biological sample that are indicative of a disease state. Specific examples are provided below.

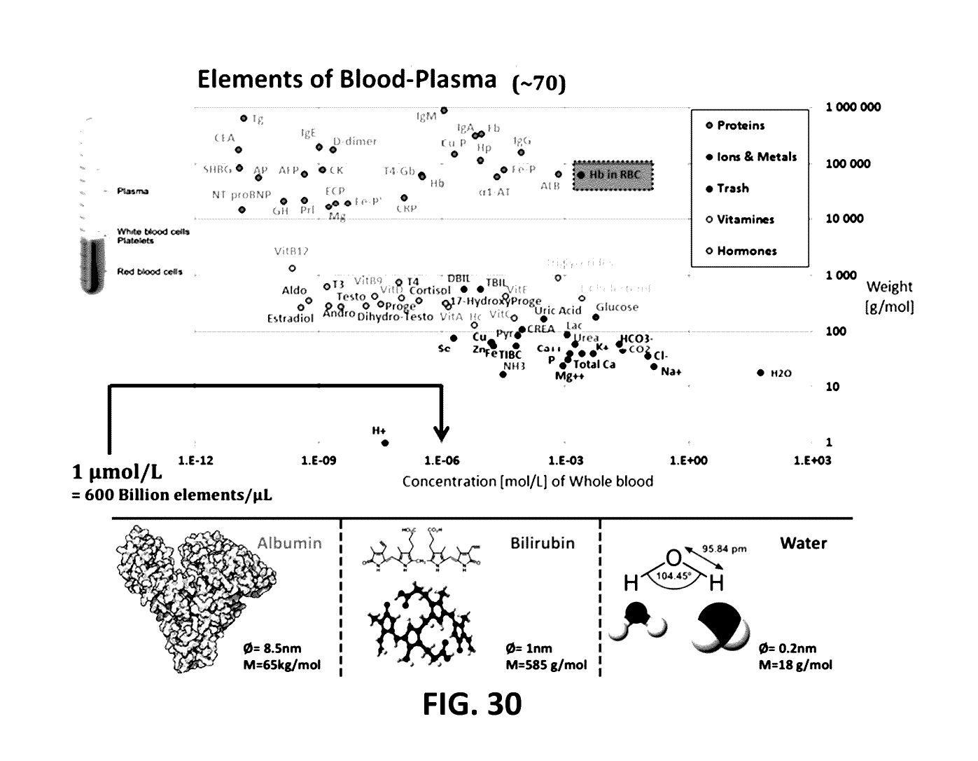

Exemplary molecules, many of which are shown in FIG. 30, that can be detected from blood include, but are not limited to, glucose, triglycerides, fibrinogen, hemoglobin (hg), dehydroepiandrosterone (DHEA), carcinoembryonic antigen (CEA), sex hormone binding globulin (SHBG), thyroglobulin (Tg), alpha-fetoprotein (AFP), Eosinophil Cationic Protein (ECP), prostate-specific antigen (PSA), Free erythrocyte protoporphyrin (FEP), Alpha-1 Antitrypsin (α1-AT), homocysteine, c-reactive protein (CRP), growth hormone (GH), thyroid stimulating hormone (TSH), Free serum T4 (thyroxine), testosterone (testo), Dihydro-testosterone (Dihydro-Testo), cortisol, follicle stimulating hormone (FSH), lutenizing hormone (LH), estradiol, progesterone (proge), aldosterone (aldo), thyroglobulin (Tg), Vitamin B9, Vitamin B12, Vitamin D, prolactin (prl), acid phosphatase, ferritin, creatine kinase (CK), Vitamin A, 17-hydroxyprogesterone, selenium, folic acid, copper (Cu), ammonia (NH3), total bilirubin (TBIL) and direct bilirubin, Vitamin C, pyruvate (Pyr), zinc (Zn), magnesium (Mg), thyroxine-binding globulin, Vitamin E, lactate (Lac), ionized calcium, inorganic phosphorus, total calcium (Total Ca), uric acid, urea, ceruloplasmin, potassium (K+), sodium (Na), carbon dioxide (CO2), HDL cholesterol, LDL cholesterol, total cholesterol, bicarbonate (HCO3−), transferrin, chloride (Cl−), globulins—Immunoglobulin E, A, G, and M (IgE, IgA, IgG, and IgM), albumin (ALB), total plasma protein.

Exemplary molecules that can be detected from urine include, but are not limited to, nitrite, sodium, potassium, urinary calcium, phosphate, proteins, human chorionic gonadotropin, red blood cells (RBCs), RBC casts, white blood cells (WBC), hemoglobin, glucose, ketone bodies, bilirubin, urobilinogen, creatinine, free catecholamines, dopamine, free cortisol, and phenylalanine.

Exemplary molecules that can be detected from saliva include, but are not limited to, 17α-hydroxyprogesterone, aldosterone, alpha-amylase, androstenedione, CRP, chromogranin A, cortisol, cotinine, DHEA, DHEA-S, estradiol, estriol, estrone, interleukin-1 Beta, interleukin-6, melatonin, neopterin, progesterone, secretory immunoglobulin A, testosterone, TNF-α, total protein, transferrin, and uric acid.

In other embodiments, methods of the invention can be used to detect a foreign substance within a biological sample, such as a drug concentration within the biological sample. The drug can be, for example, a prescription drug, performance enhancing drug or an illegal drug, such as a narcotic etc. Exemplary drugs (and/or their metabolites) that can be detected from various types of samples in accordance with the present invention include, but are not limited to, alcohol, amphetamines, methamphetamine, MDMA (ecstasy), barbituates, phenobarbital, benzodiazepines, cannabis, cocaine, codeine, cotinine, morphine, LSD, methadone, steroids, and PCP.

In other embodiments, methods of the invention can be used to detect the composition of various nutritional products, such as nutraceuticals. Nutraceuticals are products derived from food sources that are purported to provide health benefits in addition to the basic nutritional value found in foods. Depending on the jurisdiction, products may claim to prevent chronic diseases, improve health, delay the aging process, increase life expectancy, or support the structure or function of the body.

In the United States, nutraceuticals may be FDA regulated pharmaceutical-grade standardized nutrients sold to consumers, although not specifically defined. Depending on the jurisdiction, the term may be treated differently such that certain products may fall under this category in one country but not in another. There is little regulation of these products in both the United States and abroad. Accordingly, significant product quality issues often arise. Often times, nutraceuticals produced abroad make false claims as to the quality of the ingredients. But due to lack of regulation, companies continue to market and sell these products under false pretenses. The lack of transparency with respect to the ingredients contained within these products can compromise the safety of the individuals purchasing and consuming these products. Accordingly, methods for determining the composition/concentration of these products, such as the methods described herein, are needed.

Exemplary ingredients which may be contained in these products can include vitamins, minerals, herbs or other botanicals, amino acids, and substances such as enzymes, organ tissues, glandulars, and metabolites.

Methods of the invention can also be used to detect a nutrient deficiency, or other biological deficiency, such as a deficiency in any of the analytes disclosed herein, from a subject's sample, and optionally generate a report of the results. Additionally, methods and systems of the invention can be used to output a recommendation with respect to the analyzed sample as to whether an increase or decrease of a certain nutrient, etc is needed.

An important feature of the methods of the invention is the ability to analyze heterogeneous samples using a total absorption spectrum and without the use of chemical reagents. These methods also include the ability to modulate each spectral component (e.g., LED light source) at different frequencies ranging from about 1 kHz to about 100 MHz, as well as to modulate the temperature at which the samples are analyzed.

Unlike prior art methods that separate the light into its component wavelengths prior to detection, the methods of the invention receive the polychromatic light to a single detector, thereby obtaining the total absorption spectrum, which is then analyzed. The methods for analyzing the total absorption spectrum are based upon the principles that each element in a mixture has its own spectrum and that each element has a specific absorption coefficient. The methods of the invention then correlate concentration with absorption. Particularly, the concentration of a compound can be determined with the knowledge of the compound's absorption coefficient. This relationship, in the most basic sense, can be illustrated by Beer's Law:

A=εbc,

wherein A is absorbance, c is concentration (mol/L;M), b is pathlength, and ε is the molar absorptivity (or extinction coefficient). Molar absorptivity is the characteristic of a substance that tells how much light is absorbed at a particular wavelength. Furthermore, temperature has an effect on the absorbance, as does external light excitation (e.g. optical pumping, transient spectroscopy, and time resolved spectroscopy) from, for example, a laser diode. Thus, these effects must be taken into consideration when collecting and interpreting data.

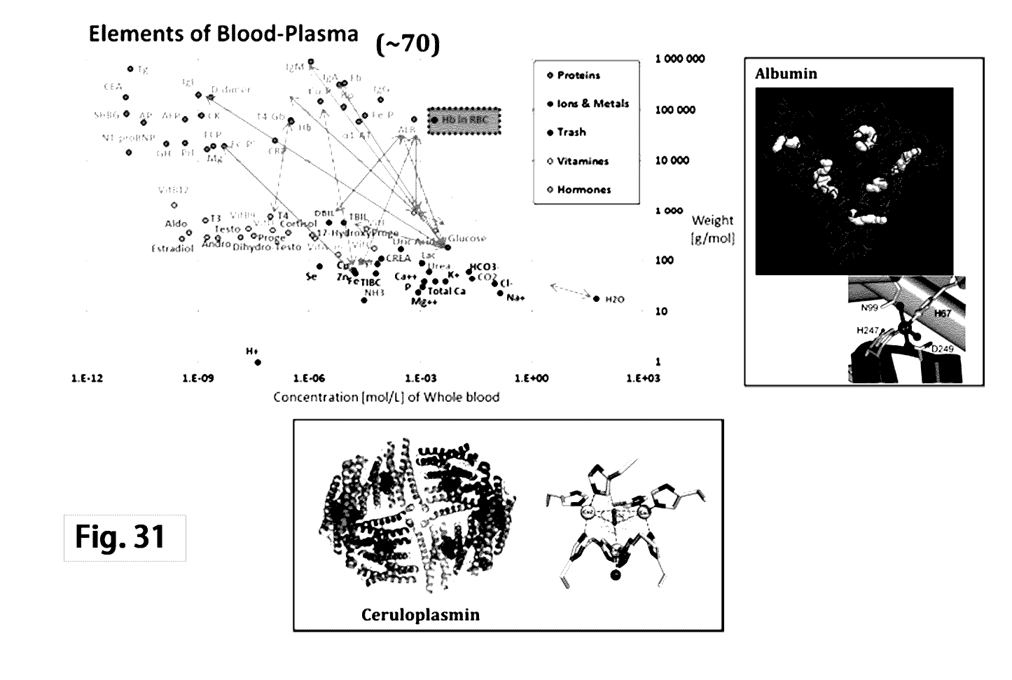

When measuring the absorption of a heterogeneous mixture, the sum of the absorption coefficient values for each element is measured at the same time. Thus, in order to determine the concentration, the linear combination of all spectra of the elements needs to be determined. The analysis then takes into account the interaction of elements with one another, as shown in FIG. 31. In one embodiment, deconvolution can be used to enable determination of concentrations. Deconvolution is an algorithm-based process used to reverse the effects of convolution on recorded data. See, e.g., O'Haver T. “Intro to Signal Processing-Deconvolution”. University of Maryland at College Park. Retrieved 2016-09-13, the content of which is incorporated by reference herein in its entirety. In general, the object of deconvolution is to find the solution of a convolution equation of the form: f*g=h, wherein h is some recorded value, and f is the desired value, but has been convolved with some other value g before it was recorded. The function g might represent the interaction between two elements. If g is known, then deterministic deconvolution can be performed. However, if g is not known in advance, then it will need to be estimated using, for example, statistical estimation. In actual practice, the situation is usually closer to: (f*g)+ε=h, wherein ε is noise that has entered the recorded value. The lower the signal-to-noise ratio, the worse the estimate of the deconvolved value will be.

Methods for deconvoluting the data in accordance with the present disclosure include the use of, for example, principal component analysis (PCA). PCA is a statistical procedure that reduces the dimensionality of a data set by transforming the data to a new set of variable (principal components) that summarize the features of the data. See, for example, Jolliffe, 1986, Principal Component Analysis, Springer, New York. PCA uses an orthogonal transformation to convert a set of observations of possibly correlated variables into a set of values of linearly uncorrelated variables called principal components. The number of principal components is less than or equal to the number of original variables. This transformation is defined in such a way that the first principal component has the largest possible variance (that is, accounts for as much of the variability in the data as possible), and each succeeding component in turn has the highest variance possible under the constraint that it is orthogonal to the preceding components. The resulting vectors are an uncorrelated orthogonal basis set. PCA is sensitive to the relative scaling of the original variables. The first few principal components (“PCs”) capture most of the variation in the data set. In contrast, the last few PCs are often assumed to capture only the residual ‘noise’ in the data.

PCA is very effective for linear relationships. However, the absorption of a complex mixture/heterogeneous sample is linear only in a first order approximation. Thus, in one embodiment, PCA is used with one or more nonlinear models to deconvolute nonlinear spectral behavior. The non-linear models can be models with many degree of liberty (such as polynomial fitting, or exponential decay in the case of an pump excitation). In another embodiment, PCA is used with nonlinear dimensionality reduction (NLDR) techniques.

PCA is discussed in more detail below with respect to use of databases in the analysis of data. It is also to be understood that other statistical analysis methods known in the art, such as those discussed in more detail below, can be used. Exemplary analyses are also described below.

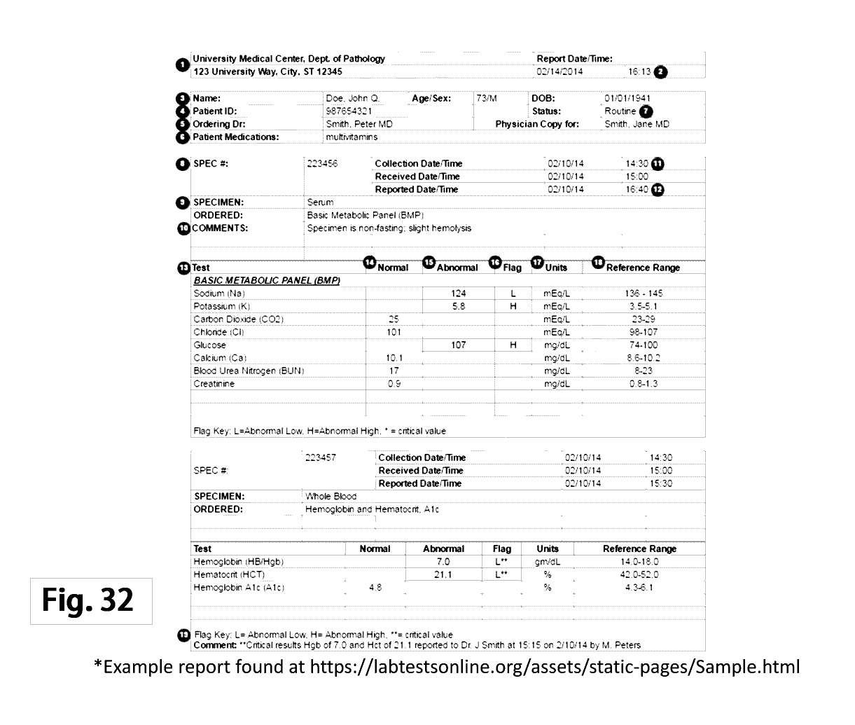

In the case of biological samples, the obtained information, e.g., presence of a target analyte and, optionally, its concentration, can be used to facilitate disease diagnosis. In certain embodiments, the methods of the invention can involve the use of a computer system (described in more detail below in Section E) to generate a report that includes the concentration of the target analyte. The computer system may perform one or more of the following steps: analyzing the sample to provide spectral data on the one or more target analytes received by the single detector by receiving and measuring an optical signal and then processing that signal in order to output the spectral data, retrieving known spectral and concentration data, applying the known data to the spectral data received by the detector, and generating a written report comprising the concentration of the one or more target analytes, such as the sample report shown in FIG. 32. Typically, the concentration is indicative of a disease state of a subject. The report can be transmitted to a physician, which can optionally aide the physician in diagnosing a disease state of a patient. The written report may be an electronic document and may be transmitted electronically (e.g., through email) to a recipient (e.g., a physician). The written report may also be sent to an output device such as a display monitor or a printer.

### D. Converting an Adsorption Spectrum to a Concentration Reading

Sample analysis results are generally reported in concentrations of different analytes in a sample. For example, results of a blood test are reported as the concentration of different components of the blood sample. The present disclosure provides for a method in which spectral data can be converted into concentration for a target analyte through the comparison of the spectral data to a database comprising known spectra already associated with concentration levels of the target analyte, e.g. reference data. Because methods of the present invention involve the use of a single detector that receives a polychromatic light beam after it has passed through the sample, the spectral data includes total absorption data. Typically, when converting spectral data to concentration, careful measurement of a “training set” of samples, e.g., blood samples, is performed. A mathematical multivariate model is then constructed for individual components to be eventually used to evaluate unknown concentrations.

In certain embodiments, the database will contain chemical composition and spectral data from a training set. The training set can comprise a number of samples from which the chemical composition and spectral behavior are known. Chemical composition data can be determined through any means known in the art, such as, for example, a chemical component analyzer (CCA). Spectral behavior can be determined through any means known in the art, including the apparatuses and methods described herein.

Using the spectral data obtained, the concentration of the components (e.g. elements of blood plasma) can be determined. This information is compiled in a database and absorption/concentration curves for the various components/elements can be determined and also contained in the database.

Once the database is compiled, the concentration of one or more target analytes in a heterogeneous sample can be determined. This is done by comparing the spectral data obtained according to the present disclosure to the database comprising the known spectra already associated with concentration levels of the target analyte, e.g. reference data. This aspect of the present disclosure is especially amenable for implementation using a computer. The computer or CPU is able to compare the spectral data of the target analyte(s) to the reference spectral data to thereby provide the concentration of the target analyte(s). Such systems generally include a central processing unit (CPU) and storage coupled to the CPU. The storage stores instructions that when executed by the CPU, cause the CPU to accept as input, spectral data obtained by the detector. The executed instructions also cause the computer to provide the concentration of the target analyte as a result of inputting the sample data into an algorithm, or pattern recognition platform, trained on the reference set of known spectral data.

In certain embodiments, the reference set is stored at a remote location separate from the computer and the computer communicates across a network to access the reference set in order to determine the concentration. In other embodiments, the reference set is stored locally within the computer and the computer accesses the reference set within the computer in order to make the determination.

The pattern recognition platform can be based on any appropriate pattern recognition method that is capable of receiving input data representative of a spectral data from the sample being analyzed and providing the concentration of the target analyte in the sample as an output. The pattern recognition program is trained with training data from a reference set of known spectral data and concentrations from various analytes. In some embodiments, a test sample having known concentration and spectral data can be used to test the accuracy of the platform recognition platform obtained using the training data.

Various known statistical pattern recognition methods can be used in conjunction with the present disclosed methods. Suitable statistical methods include, without limitation, principal component analysis (PCA), logic regression, ordinal logistic regression, linear or quadratic discriminant analysis, clustering, nearest neighbor classifier analysis, and Cox Proportional Handling. Non-limiting examples of implementing particular pattern recognition platforms using the various statistical are provided herein.

In some embodiments, the pattern recognition platform is based on a regression model, preferably a logistic regression model. Some embodiments of the present invention provide generalizations of the logistic regression model that handle multicategory (polychotomous) responses. Such embodiments can be used to discriminate between three or more elements. Such regression models use multicategory logit models that simultaneously refer to all pairs of categories, and describe the odds of response in one category instead of another. Once the model specifies logits for a certain (J-1) pairs of categories, the rest are redundant. See, for example, Agresti, An Introduction to Categorical Data Analysis, John Wiley & Sons, Inc., 1996, New York, Chapter 8, which is hereby incorporated by reference.

Linear discriminant analysis (LDA) attempts to classify sample according to its elemental composition based on certain spectral properties. In other words, LDA tests whether measured spectral data predicts categorization. LDA typically requires continuous independent variables and a dichotomous categorical dependent variable. In the present disclosure, the spectral data for select wavelengths across a number of elements in the training population serve as the requisite continuous independent variables. The concentration of each of the elements of the training population serves as the dichotomous categorical dependent variable.

LDA seeks the linear combination of variables that maximizes the ratio of between-group variance and within-group variance by using the grouping information. Implicitly, the linear weights used by LDA depend on how the spectral data for a wavelength separates between, for example, two different elements and how the spectral data correlates with spectral data for other wavelengths. For example, LDA can be applied to the data matrix of the N members (e.g. elements) in the training sample by K wavelengths in a number of wavelengths described in the present invention. Then, the linear discriminant of each member of the training population is plotted. Ideally, those members of the training population representing a first subgroup (e.g. a first element) will cluster into one range of linear discriminant values and those members of the training population representing a second subgroup (e.g. a second element) will cluster into a second range of linear discriminant values. The LDA is considered more successful when the separation between the clusters of discriminant values is larger. For more information on linear discriminant analysis, see Duda, Pattern Classification, Second Edition, 2001, John Wiley & Sons, Inc; and Hastie, 2001, The Elements of Statistical Learning, Springer, New York; Venables & Ripley, 1997, Modern Applied Statistics with s-plus, Springer, New York.

Quadratic discriminant analysis (QDA) takes the same input parameters and returns the same results as LDA. QDA uses quadratic equations, rather than linear equations, to produce results. LDA and QDA are interchangeable, and which to use is a matter of preference and/or availability of software to support the analysis. Logistic regression takes the same input parameters and returns the same results as LDA and QDA.

In some embodiments of the present disclosure, decision trees are used to classify elements using spectral data for a selected set of wavelengths. Decision tree algorithms belong to the class of supervised learning algorithms. The aim of a decision tree is to induce a classifier (a tree) from real-world example data. This tree can be used to classify unseen examples (determine elements in a sample of unknown composition) which have not been used to derive the decision tree. A decision tree is derived from training data. An example contains values for the different attributes and what class the example belongs. In one embodiment, the training data is spectral data from a number of wavelengths across the training population (e.g. various elements)

In general there are a number of different decision tree algorithms, many of which are described in Duda, Pattern Classification, Second Edition, 2001, John Wiley & Sons, Inc. Decision tree algorithms often require consideration of feature processing, impurity measure, stopping criterion, and pruning. Specific decision tree algorithms include, cut are not limited to classification and regression trees (CART), multivariate decision trees, ID3, and C4.5.

In one approach, when an exemplary embodiment of a decision tree is used, the spectral data for a representative number of wavelengths across a training population is standardized to have mean zero and unit variance. The members (e.g. elements) of the training population are randomly divided into a training set and a test set. For example, in one embodiment, two thirds of the members of the training population are placed in the training set and one third of the members of the training population are placed in the test set. The spectral data for a representative number of wavelengths are used to construct the decision tree. Then, the ability for the decision tree to correctly classify members in the test set is determined. In some embodiments, this computation is performed several times for a given number of wavelengths. In each iteration of the computation, the members of the training population are randomly assigned to the training set and the test set. Then, the quality of the combination of traits is taken as the average of each such iteration of the decision tree computation.

In some embodiments, the spectral data across a representative number of wavelengths is used to cluster a training set. For example, consider the case in which ten wavelengths are used. Each member m (e.g. element) of the training population will have absorption/concentration values for each of the ten wavelengths. Such values from a member m in the training population define the vector:

X₁ₘ X₂ₘ X₃ₘ X₄ₘ X₅ₘ X₆ₘ X₇ₘ X₈ₘ X₉ₘ X₁₀ₘ

where Xᵢₘ is the absorbance/concentration of the i^{th} wavelength in element m. If there are m elements in the training set, selection of i wavelengths will define m vectors. Those members of the training population that exhibit similar absorption/concentration curves across the training group will tend to cluster together. A particular combination of wavelengths of the present invention is considered to be a good classifier in this aspect of the present disclosure when the vectors cluster into the trait groups (elements) found in the training population. For instance, if the training population includes two different elements, a clustering classifier will cluster the population into two groups, with each group uniquely representing either element.

Clustering is described on pages 211-256 of Duda and Hart, Pattern Classification and Scene Analysis, 1973, John Wiley & Sons, Inc., New York. As described in Section 6.7 of Duda, the clustering problem is described as one of finding natural groupings in a dataset. To identify natural groupings, two issues are addressed. First, a way to measure similarity (or dissimilarity) between two samples is determined. This metric (similarity measure) is used to ensure that the samples in one cluster are more like one another than they are to samples in other clusters. Second, a mechanism for partitioning the data into clusters using the similarity measure is determined.

Similarity measures are discussed in Section 6.7 of Duda, where it is stated that one way to begin a clustering investigation is to define a distance function and to compute the matrix of distances between all pairs of samples in a dataset. If distance is a good measure of similarity, then the distance between samples in the same cluster will be significantly less than the distance between samples in different clusters. However, as stated on page 215 of Duda, clustering does not require the use of a distance metric. For example, a nonmetric similarity function s(x, x′) can be used to compare two vectors x and x′. Conventionally, s(x, x′) is a symmetric function whose value is large when x and x′ are somehow “similar”. An example of a nonmetric similarity function s(x, x′) is provided on page 216 of Duda.

Once a method for measuring “similarity” or “dissimilarity” between points in a dataset has been selected, clustering requires a criterion function that measures the clustering quality of any partition of the data. Partitions of the data set that extremize the criterion function are used to cluster the data. See page 217 of Duda. Criterion functions are discussed in Section 6.8 of Duda.

More recently, Duda et al., Pattern Classification, 2nd edition, John Wiley & Sons, Inc. New York, has been published. Pages 537-563 describe clustering in detail. More information on clustering techniques can be found in Kaufman and Rousseeuw, 1990, Finding Groups in Data: An Introduction to Cluster Analysis, Wiley, New York, N.Y.; Everitt, 1993, Cluster analysis (3d ed.), Wiley, New York, N.Y.; and Backer, 1995, Computer-Assisted Reasoning in Cluster Analysis, Prentice Hall, Upper Saddle River, N.J. Particular exemplary clustering techniques that can be used in the present invention include, but are not limited to, hierarchical clustering (agglomerative clustering using nearest-neighbor algorithm, farthest-neighbor algorithm, the average linkage algorithm, the centroid algorithm, or the sum-of-squares algorithm), k-means clustering, fuzzy k-means clustering algorithm, and Jarvis-Patrick clustering.

In some embodiments, the pattern recognition platform is based on PCA, as briefly described above. In such an approach, vectors for a selected set of wavelengths can be selected in the same manner described for clustering above. In fact, the set of vectors, where each vector represents spectral data for the select wavelengths from a particular member (e.g. element) of the training populations, can be considered a matrix. In some embodiments, this matrix is represented in a Free-Wilson method of qualitative binary description of monomers (Kubinyi, 1990, 3D QSAR in drug design theory methods and applications, Pergamon Press, Oxford, pp 589-638), and distributed in a maximally compressed space using PCA so that the first principal component (PC) captures the largest amount of variance information possible, the second principal component (PC) captures the second largest amount of all variance information, and so forth until all variance information in the matrix has been accounted for.

Then, each of the vectors (where each vector represents a member of the training population) is plotted. Many different types of plots are possible. In some embodiments, a one-dimensional plot is made. In this one-dimensional plot, the value for the first principal component from each of the wavelengths is plotted. In this form of plot, the expectation is that members of a first group (e.g. a first element within the blood plasma) will cluster in one range of first principal component values and members of a second group (e.g., a second element within the blood plasma) will cluster in a second range of first principal component values.

In one example, the training population comprises two groups: a first element and a second element. The first principal component is computed using the spectral data for the select wavelengths of the present disclosure across the entire training population data set. Then, each member of the training set is plotted as a function of the value for the first principal component. In this example, those members of the training population in which the first principal component is positive are the first element and those members of the training population in which the first principal component is negative are the second element.

In some embodiments, the members of the training population are plotted against more than one principal component. For example, in some embodiments, the members of the training population are plotted on a two-dimensional plot in which the first dimension is the first principal component and the second dimension is the second principal component. In such a two-dimensional plot, the expectation is that members of each subgroup represented in the training population will cluster into discrete groups. For example, a first cluster of members in the two-dimensional plot will represent a first element, a second cluster of members in the two-dimensional plot will represent a second element, and so forth.

In some embodiments, the members of the training population are plotted against more than two principal components and a determination is made as to whether the members of the training population are clustering into groups that each uniquely represents a subgroup found in the training population. In some embodiments, principal component analysis is performed by using the R mva package (Anderson, 1973, Cluster Analysis for applications, Academic Press, New York 1973; Gordon, Classification, Second Edition, Chapman and Hall, C R C, 1999.). Principal component analysis is further described in Duda, Pattern Classification, Second Edition, 2001, John Wiley & Sons, Inc.

Nearest neighbor classifiers are another statistical method on which the pattern recognition platform can be based. Nearest neighbor classifiers are memory-based and require no model to be fit. Given a query point x₀, the k training points x₍ᵣ₎, r, . . . , k closest in distance to x₀ are identified and then the point x₀ is classified using the k nearest neighbors. Ties can be broken at random. In some embodiments, Euclidean distance in feature space is used to determine distance as:

d₍ᵢ₎=∥x₍ᵢ₎−xₒ∥.

Typically, when the nearest neighbor algorithm is used, the expression data used to compute the linear discriminant is standardized to have mean zero and variance 1. In the present disclosure, the members of the training population are randomly divided into a training set and a test set. For example, in one embodiment, two thirds of the members of the training population are placed in the training set and one third of the members of the training population are placed in the test set. Profiles represent the feature space into which members of the test set are plotted. Next, the ability of the training set to correctly characterize the members of the test set is computed. In some embodiments, nearest neighbor computation is performed several times for a set number of wavelengths. In each iteration of the computation, the members of the training population are randomly assigned to the training set and the test set. Then, the quality of the spectral data for the set number of wavelengths is taken as the average of each such iteration of the nearest neighbor computation.

The nearest neighbor rule can be refined to deal with issues of unequal class priors, differential misclassification costs, and feature selection. Many of these refinements involve some form of weighted voting for the neighbors. For more information on nearest neighbor analysis, see Duda, Pattern Classification, Second Edition, 2001, John Wiley & Sons, Inc; and Hastie, 2001, The Elements of Statistical Learning, Springer, New York.

The pattern classification and statistical techniques described above are merely examples of the types of models that can be used to construct a model for classification. It is to be understood that any statistical method can be used in accordance with the present disclosure. Moreover, combinations of these described above also can be used. Further detail on other statistical methods and their implementation are described in U.S. patent application Ser. No. 11/134,688, incorporated by reference herein in its entirety.

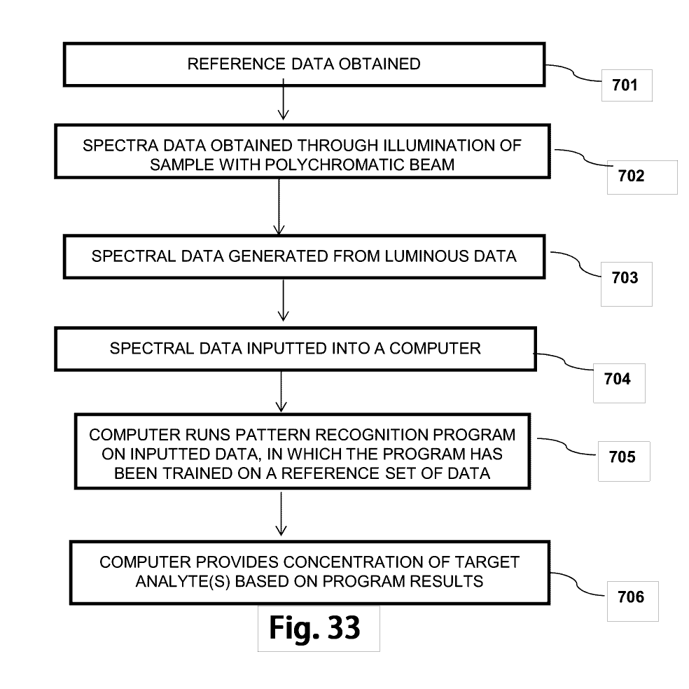

In accordance with one embodiment, as shown in FIG. 33, methods of the present disclosure include obtaining a reference data set 701, obtaining luminous data through illumination of the sample with a polychromatic multiplexed beam 702, generating spectral data from the luminous data 703, inputting spectral data to a computer 704, running the pattern recognition platform on the inputted data, wherein the platform has been trained on the reference set of data 705, and providing a concentration of the target analytes based on the pattern recognition platform results 706.

### Example 1

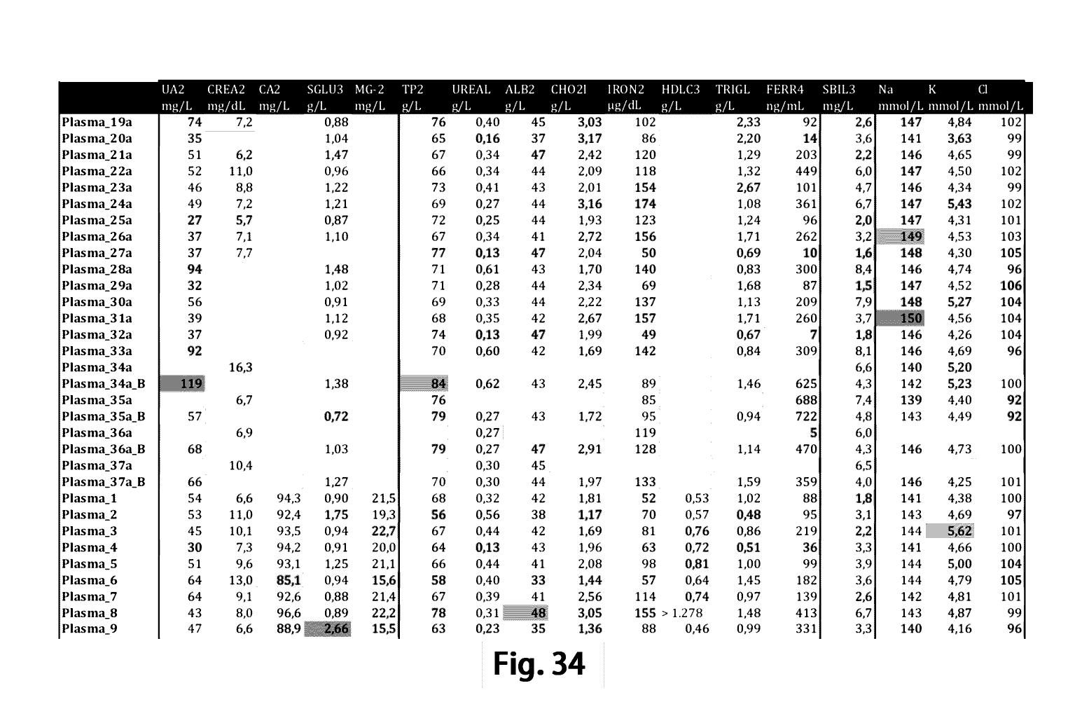

In order to determine the concentrations of various target analytes without the use of chemical reagents, as described in Section C, and making use of the method described in this section, the following study was conducted. Chemical composition data was determined over a period of 7 days using 140 samples and over 1,000 measurements on a Roche Cobas c501 chemical component analyzer (CCA). FIG. 34 shows a report containing the concentration levels of various analytes for a number of plasma samples, as determined using the CCA. This data was input into a database using Python programming language and corresponding Python-based database management tools such as the Scientyific PYthon Development EnviRonment (Spyder), NumPy (a scientific computing package), and matplotlib (a 2D plotting library).

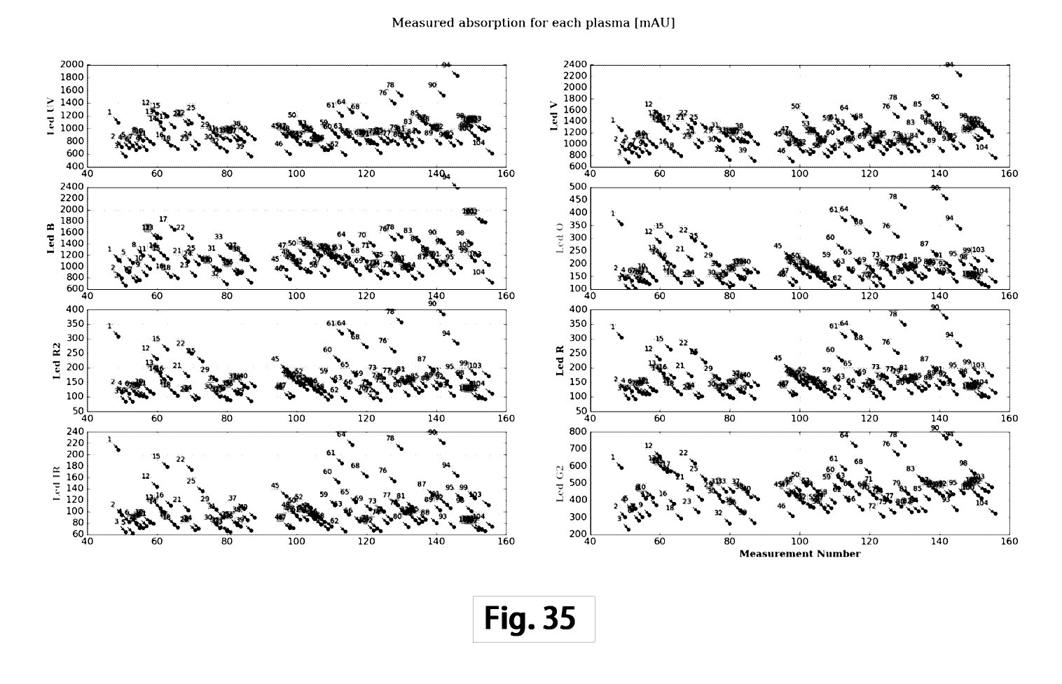

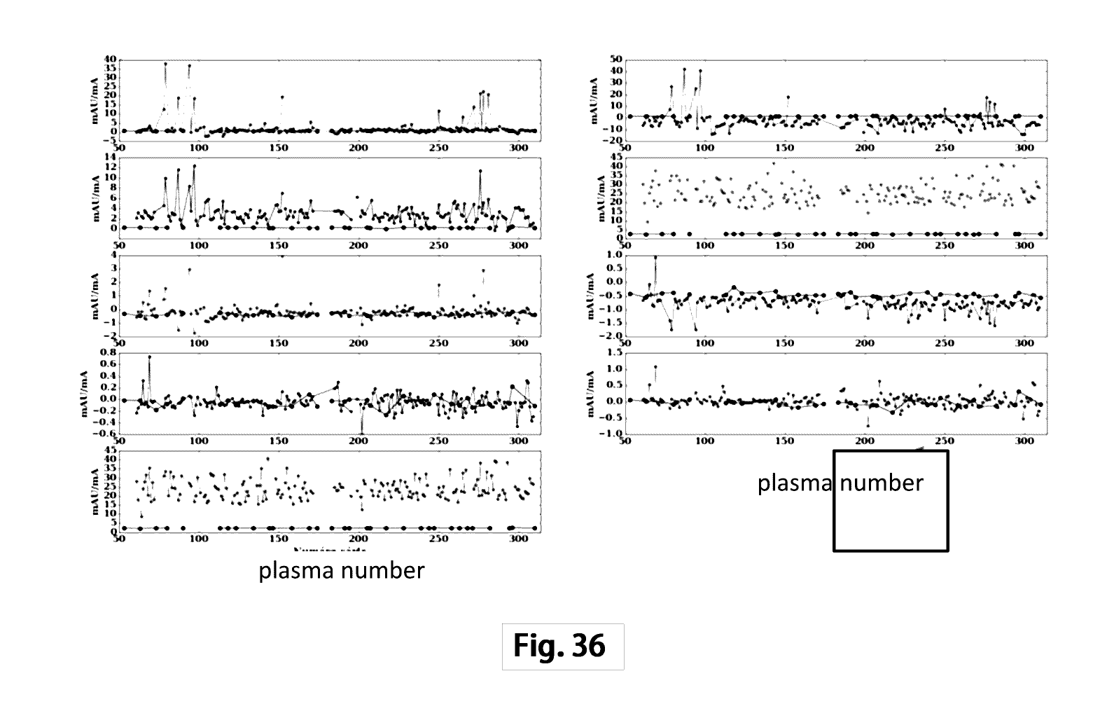

Measurements were then obtained from apparatuses (two) and methods described in Sections A and B above. From there, the spectral behavior, including but not limited to one or more of the absorption of each plasma sample for each wavelength, the derivative of this absorption, and the changes of this absorption according to external light excitation, was generated. FIG. 35 shows exemplary data obtained using these methods, separated by LED source. This data is then used to generate spectral data for the plasma samples, the results of which are provided in FIG. 36.

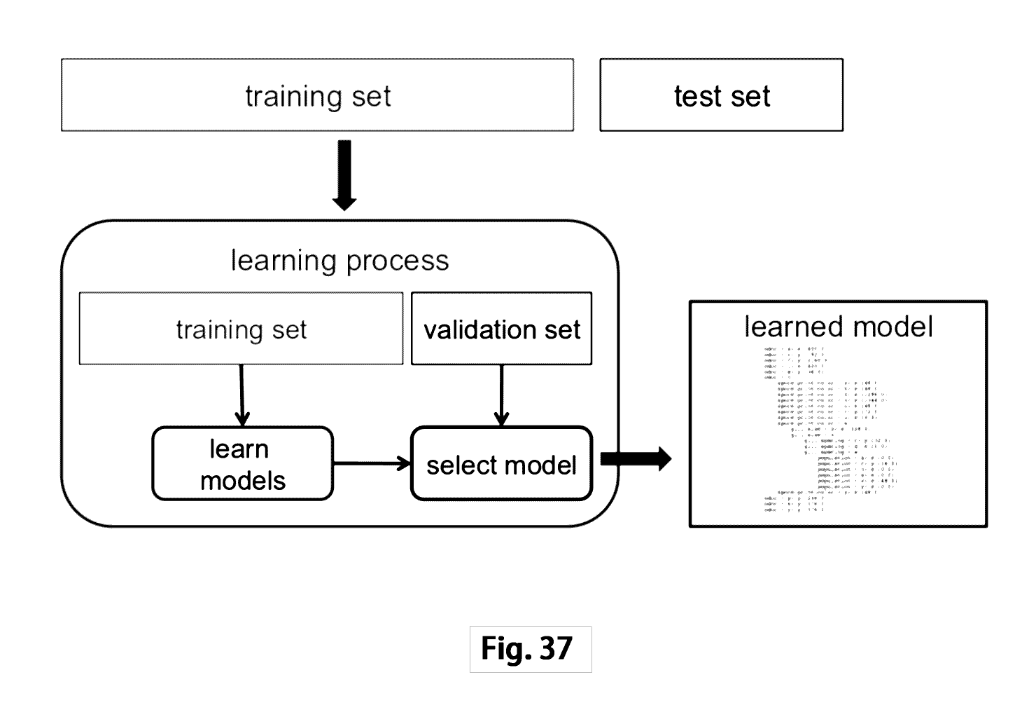

Subsequently, for each target analyte, a machine learning algorithm was used to find a mathematical model that fits the measured data with the reference data. A flow chart depicting the steps of applying a machine learning algorithm can be found in FIG. 37. For example, to find the concentration of bilirubin in a sample multiple linear regression can be used to find the following formula:

C_{bili}=a₁A_{λ1}+a₂A_{λ2}+ . . . +aₙA_{λn}+b

wherein C_{bili} is the reference concentration of bilirubin obtained from the chemical component analyzer (CCA), A_{λn} represent the absorbance measurement obtained from the plasma samples, and a₁, a₂, . . . , aₙ b are the coefficients found using the machine learning algorithm. When the coefficients (e.g. a₁, a₂, . . . , aₙ b) are known, the concentration of bilirubin can be predicted from the measurement obtained from the plasma samples.

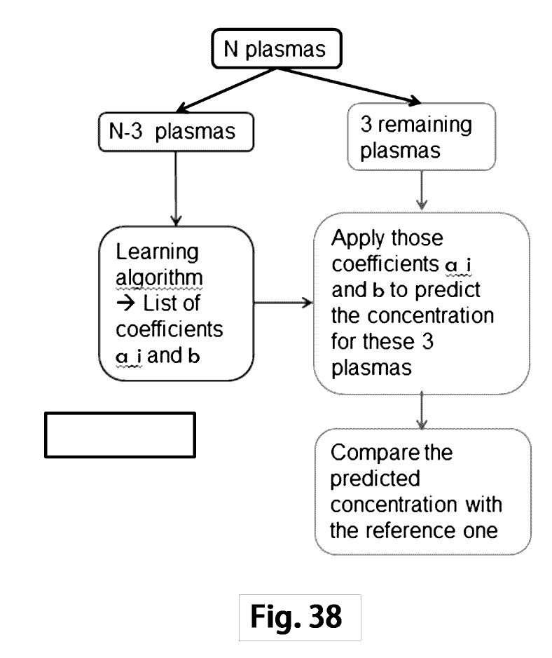

In order to evaluate the algorithm and the measurements, 3 plasma samples (e.g. the “test” set) were removed from the reference, or “learning” set, comprised of N samples. Next, the parameters aᵢ and b were learned for the reference set including data for N-3 samples. Then these learned parameters are applied to the test set to predict the bilirubin concentration for those samples in the test set. A flow chart depicting the steps of this process is provided in FIG. 38. This process was repeated several times, each time removing three different plasma samples until a predicted value is obtained for each plasma sample.

The resultant correlation data for each of the following 4 elements: total bilirubin, uric acid, triglyceride, and iron are provided below in their respective subsections under Section E. The mean error of prediction of these for chemical elements is provided in the chart below:

| | | |
|---|---|---|
| Total bilirubin | 0.5 | g/L |
| Uric acid | 7.7 | mg/L |
| Triglyceride | 0.26 | g/L |
| Iron | 23 | μg/dL |

The mean errors were then compared with the measurement uncertainty of the CCA used to obtain the reference concentrations given by the medical laboratory, as provided in the chart below:

| | | |
|---|---|---|
| Total bilirubin | 0.6 | g/L |
| Uric acid | 3 | mg/L |
| Triglyceride | 0.08 | g/L |
| Iron | 10 | μg/dL |

### E. Disease-Specific Evaluations

The methods of the invention and their implementation using the above described apparatuses are now exemplified for the detection of certain biological molecules from a biological sample. The skilled artisan will appreciate that the examples herein can be applied to other biological molecules or targets in other types of samples and the methodology used does not change and the apparatuses employed are the same. Similarly, the skilled artisan will appreciate the analysis herein is not limited to biological samples and the principles described for analysis of biological samples are the sample principles implements for the analysis of non-biological samples.

When analyzing a biological sample, one can perform diagnostic/assessment and prognostic testing on individuals for various diseases and disorders. Analysis can be completed on a biological sample from the individual, such as a tissue or a body fluid. Typical tests are performed on body fluids, such as blood, urine saliva, etc. However, the skilled artisan will appreciate that the body fluid will depend on the target molecule to be detected and where it is typically found in the body. In that manner, the methods of the invention are not limited to the exemplified body fluids, and the methods of the invention work the same regardless of the body fluid used. Analysis may involve the determination of concentration of one or more target analytes in a biological sample, the concentration of the target analyte being indicative of the presence/absence and/or severity of a disease or disorder. Once the concentration of the target analyte(s) has been determined as described herein, it can be compared with known values for normal and diseased states to allow for diagnosis of or prognosis with respect to a disease or disorder.

Using methods of the invention, many different tests can be performed to aid in neonatal diagnosis and assess organ function. For example, a hyperbilirubinemia panel for use in pediatrics and neonate clinics will include will include two tests—direct bilirubin and indirect bilirubin. Alternatively, or in addition, the panel will include total serum bilirubin. With respect to assessment of organ function, tests to assess liver function include bilirubin, alanine aminotransferase (ALT), aspartate aminotransferase (AST), alkaline phosphatase (ALP), albumin, total protein, and gamma-glutamyl transferase (GGT). Tests to assess heart function include total cholesterol, triglycerides, HDL, LDL, and creatine kinase (CK). Tests to assess kidney function include blood urea nitrogen (BUN), creatinine, and uric acid. Other tests include potassium (K+), Sodium (Na+), Chloride (Cl−), Calcium (Ca+), phosphate (P or PO₄), glucose, hemoglobin A1c (HBA1C), and amylase. These tests can be provided separately or two or more can be provided together as a panel, as shown in the table below.

Panels

| | Heart | Kidney | Other |
|---|---|---|---|
| Liver Function | Function | Function | (individual tests) |
| 7 tests | 5 tests | 3 tests | 8 tests |
| Bilirubin, ALT, AST, | Total | BUN, | K+, Na+, |
| ALP, Albumin, Total | Cholesterol, | Creatinine, | Cl−, Ca+, P, |
| protein, and GGT | Triglycerides, | Uric Acid | Glucose, HBA1C, |
| | HDL, | | Amylase |
| | LDL, and CK | | |

Additional panels for assessing specific conditions are also contemplated in the present disclosure. For example, fibrosis and cirrhosis can be assessed using one or both of the panels listed in the table below.

Panels
Fibrosis & Cirrhosis

| 6 tests | 4 tests |
|---|---|
| Bilirubin, ALT, | AST, Total Cholesterol, |
| GGT, Haptaglobin, | Triglycerides, |
| Apolipoprotein-A1, | Glucose |
| Alpha-2-macroglobulin | |

Exemplary methods are now illustrated for testing on uric acid, triglycerides, bilirubin, iron and total proteins.

### Uric Acid

Uric acid is a product of the metabolic breakdown of purine nucleotides. A high blood concentration of uric acid can lead to gout and is associated with other medical conditions including diabetes and the formation of kidney stones.

Uric acid can be tested from blood or urine samples, and methods of the invention can test for uric acid from either body fluid type. A uric acid blood test is performed on a sample of the patient's blood, typically withdrawn from a vein into a vacuum tube, wherein the plasma is separated therefrom. In plasma, the reference range of uric acid is typically 3.4-7.2 mg/dL (200-430 μmol/L) for men, and 2.4-6.1 mg/dL for women (140-360 μmol/L)[22]−one milligram per deciliter (mg/dL) equals 59.48 micromoles/liter (μmol/L). However, blood test results will vary depending on the laboratory that performed the test and the equipment used to perform the test. Uric acid concentrations in blood plasma above and below the normal range are known as, respectively, hyperuricemia and hypouricemia.

A uric acid urine test typically requires the patient to collect all urine voided over a 24-hour period, with the exception of the very first specimen. The patient keeps the specimen container on ice or in the refrigerator during the collection period.

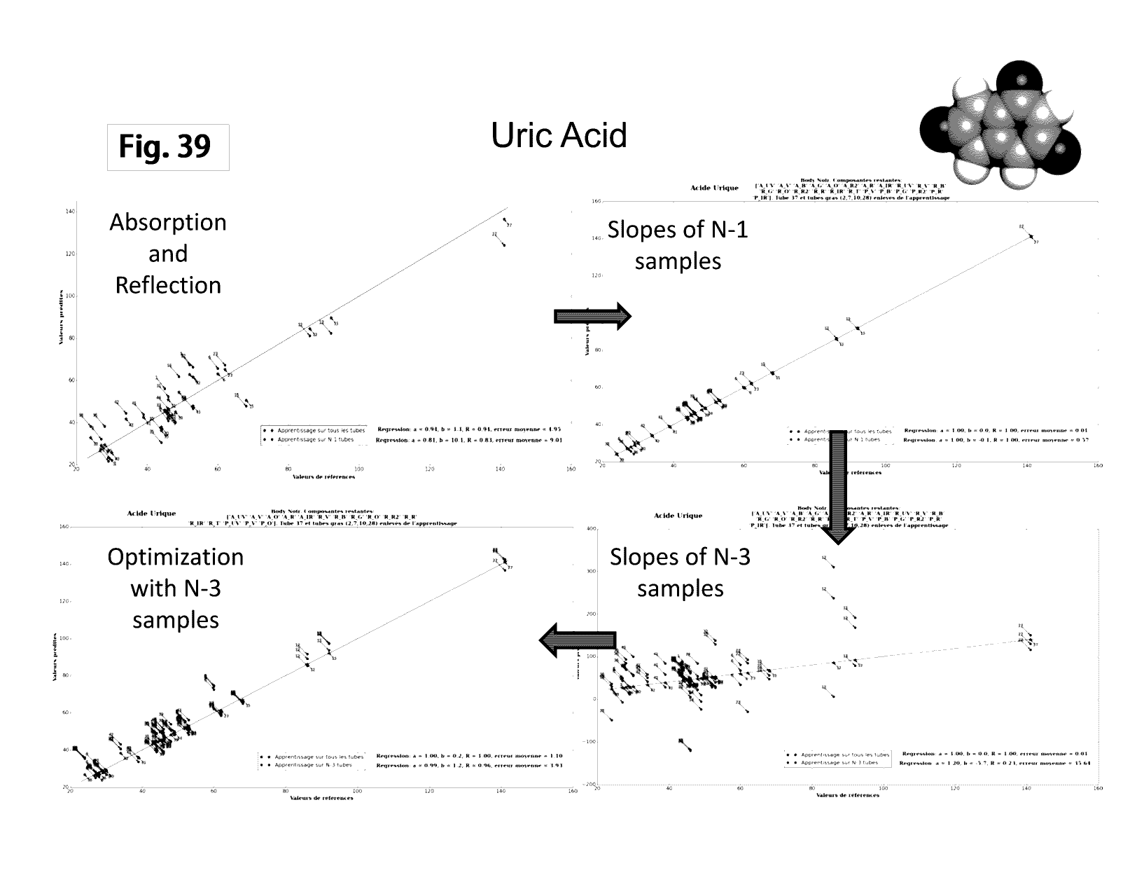

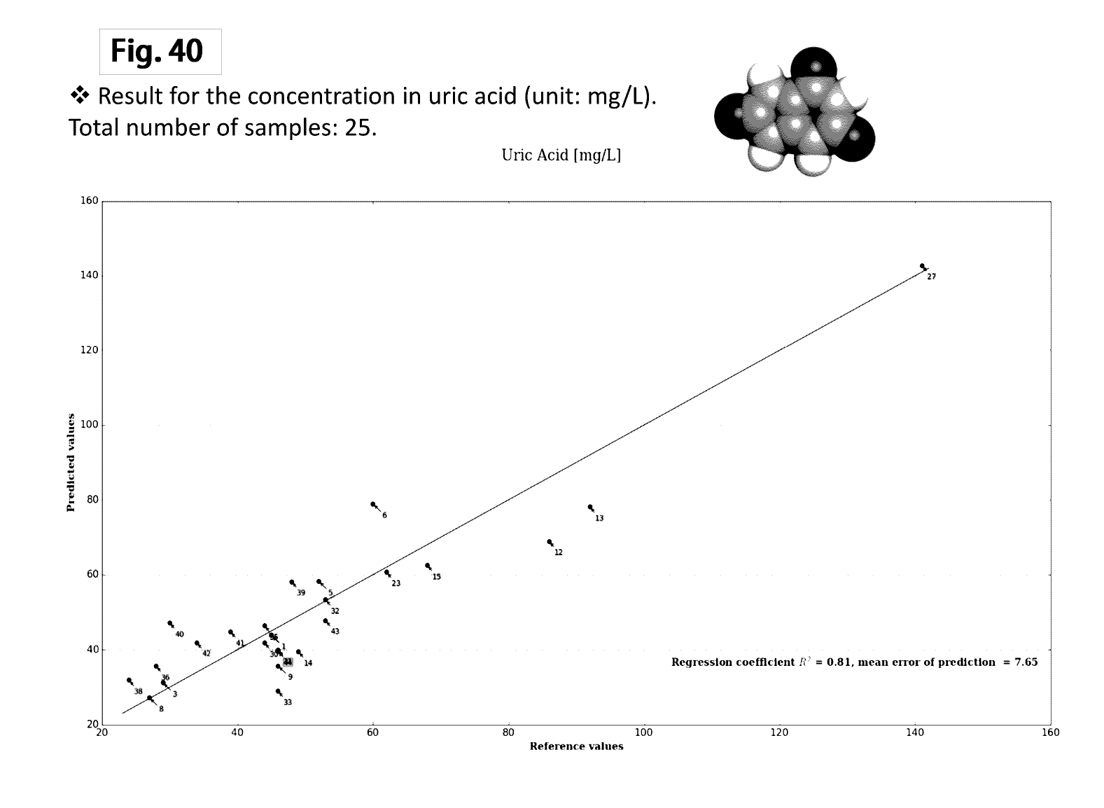

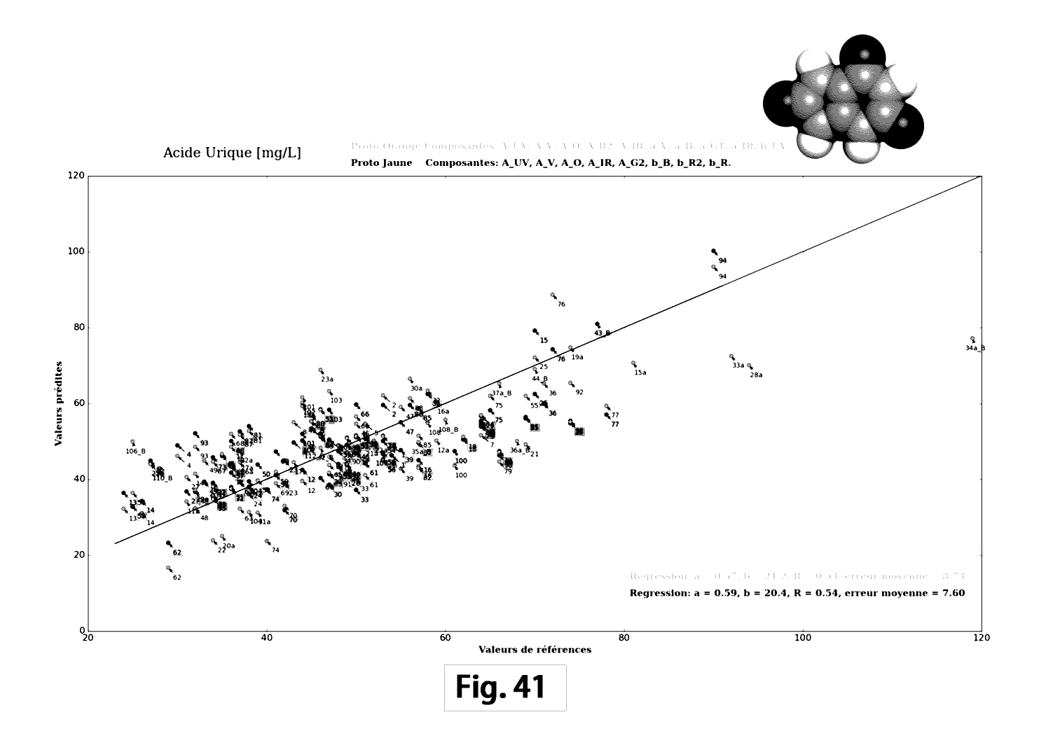

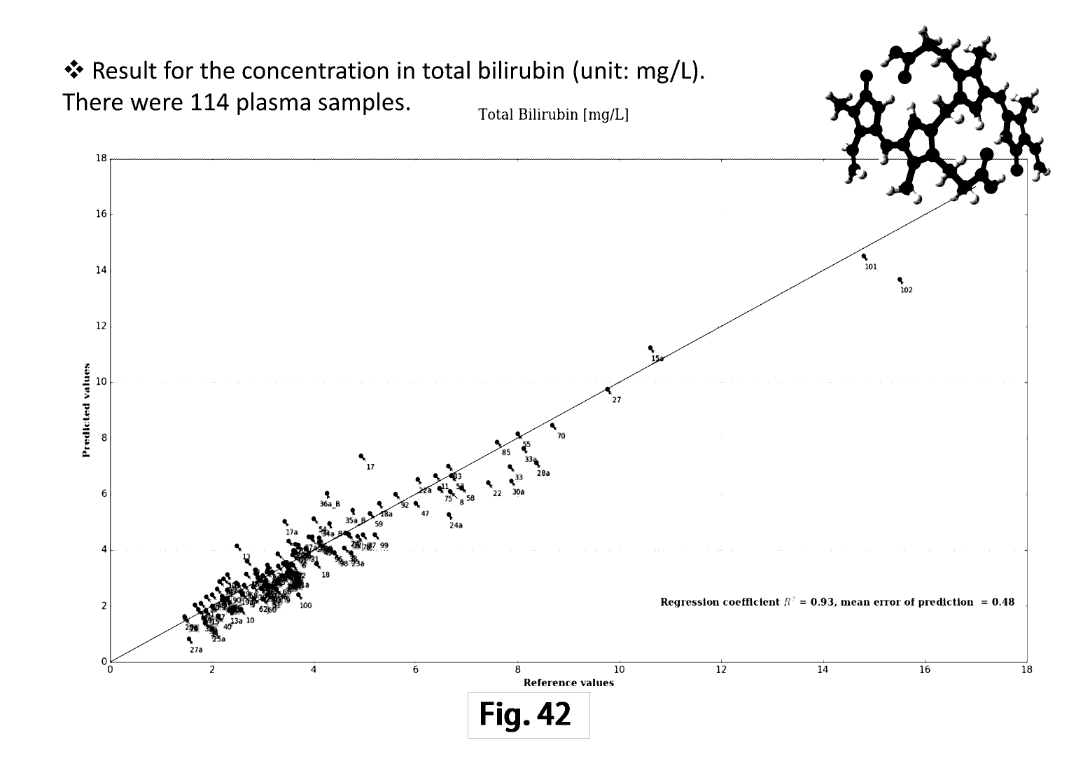

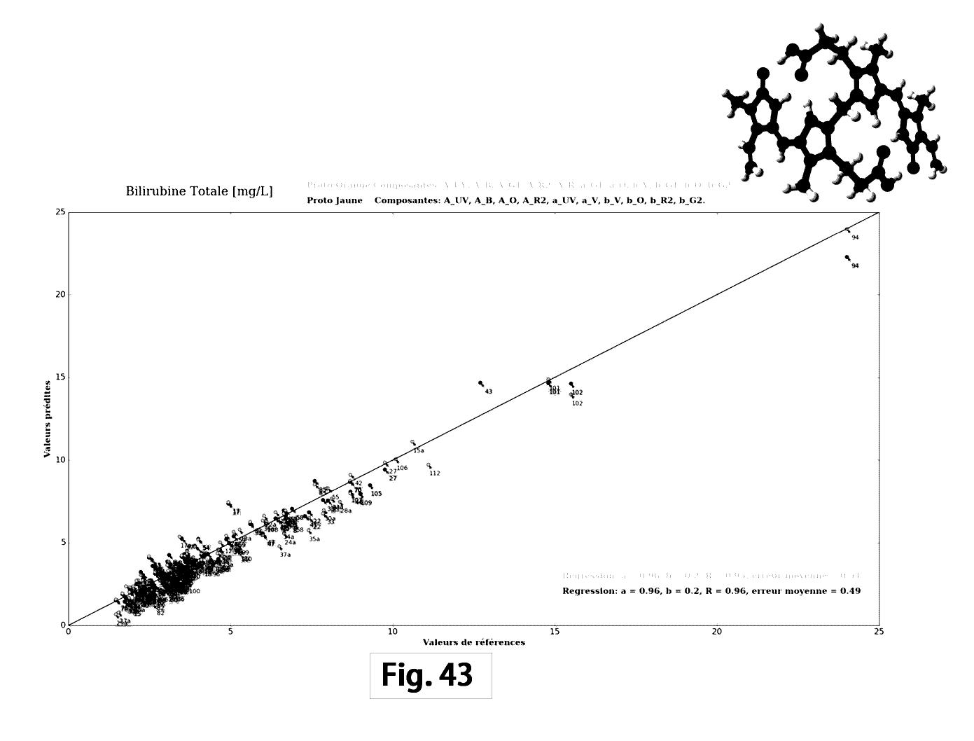

To assess a uric acid concentration in a blood or urine sample, the sample is illuminated using the devices described herein with a polychromatic light beam. Spectral data associated with the urine or blood sample and the uric acid is received to a detector of the system without splitting the polychromatic light into individual wavelengths. The spectral data is then analyzed. That is, the total absorption spectrum is processed as described above in order to deconvolute the data to obtain the specific spectrum for uric acid in the sample. The obtained spectrum for uric acid from the sample (e.g., blood or urine) is compared to a database including reference spectral data in which relative absorption of uric acid in blood or urine is known and is correlated with a particular concentration. In certain embodiments, these methods are conducted without reacting the uric acid with another chemical reagent. FIGS. 39-41 depict the data analysis and results as applied to uric acid, using the methods provided in Example 1 above.

The methods may further involve generating a report that includes the concentration of uric acid in the sample, in which the concentration may be indicative of a disease state of a subject. As described above, the report may be transmitted to a physician. The report will aid the physician in the diagnosis of a disease state of a subject. For example, the report can provide a range for concentration of uric acid that is considered “normal,” such that a concentration falling close to, above or below the ends of the range may indicate a disease state or that further monitoring/testing may be necessary. For example, high concentration of uric acid can be an indication of disease states involving the kidneys, such as gout, diabetes, and the formation of kidney stones. Additionally, high concentrations of uric acid can also indicate other disease states such as metastatic cancer, multiple myeloma, leukemias, in addition to the buildup of uric acid due to cancer chemotherapy. Low concentrations of uric acid are less common, but can be associated with certain kinds of liver or kidney disease such as Fanconi syndrome, exposure to toxic compounds, or metabolic defects such as Wilson disease. Chronic alcohol use and lead poisoning can also produce low uric acid levels. The concentration will also indicate to the physician the severity of the disease, with concentrations being further from normal range in either direction (e.g., hyper or hypo) being indicative of greater severity of a disease state.

### Bilirubin

Bilirubin is often tested for as total bilirubin, which includes unconjugated (indirect) plus conjugated (direct bilirubin). “Conjugated” bilirubin is bilirubin formed in the liver by the conjugation with a molecule of glucuronic acid (sugar), which makes it soluble in water. Unconjugated bilirubin is carried by proteins to the liver. Bilirubin is produced during the normal breakdown of red blood cells. Higher than normal levels of bilirubin may indicate different types of liver problems and can also indicate an increased rate of destruction of red blood cells (hemolysis). For example but not limitation, bilirubin testing can be done to determine whether an individual is suffering from jaundice, to determine whether there is a blockage in the liver's bile ducts, to help detect or monitor the progression of liver diseases such as hepatitis, to help detect increased destruction of red blood cells, to follow how a treatment is working, and to help evaluate a suspected drug toxicity.

Hyperbilirubinemia is one example of a disease involving abnormal levels of bilirubin. For adults, this is any level above 170 μmol/l and for newborns 340 μmol/l and critical hyperbilirubinemia 425 μmol/l. Unconjugated hyperbilirubinemia in a newborn can lead to accumulation of bilirubin in certain brain regions (particularly the basal nuclei) with consequent irreversible damage to these areas manifesting as various neurological deficits, seizures, abnormal reflexes and eye movements. This type of neurological injury is known as kernicterus. The spectrum of clinical effect is called bilirubin encephalopathy.

Testing for bilirubin typically involves blood testing. For adults, blood is typically collected by needle from a vein in the arm. In newborns, blood is often collected from a heel stick, a technique that uses a small, sharp blade to cut the skin on the infant's heel and collect a few drops of blood into a small tube.

To assess the bilirubin concentration in a blood sample, the sample is illuminated using the devices described herein with a polychromatic light beam. Spectral data associated with the blood sample and the bilirubin is received to a detector of the system without splitting the polychromatic light into individual wavelengths. The spectral data is then analyzed. That is, the total absorption spectrum is processed as described above in order to deconvolute the data to obtain the specific spectrum for bilirubin in the sample. The obtained spectrum for bilirubin from the sample (e.g., blood) is compared to a database including reference spectral data in which relative absorption of bilirubin in blood is known and is correlated with a particular concentration. In certain embodiments, these methods are conducted without reacting the bilirubin with another chemical reagent. FIGS. 30 and 31 depict the results of the analysis methods described in Example 1 above.

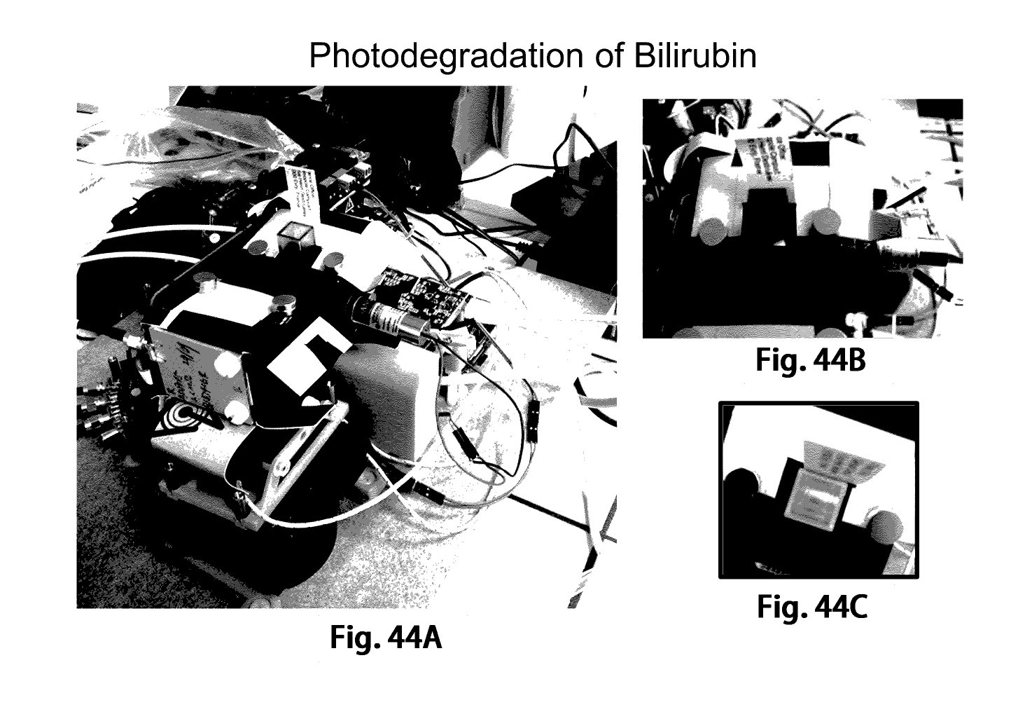

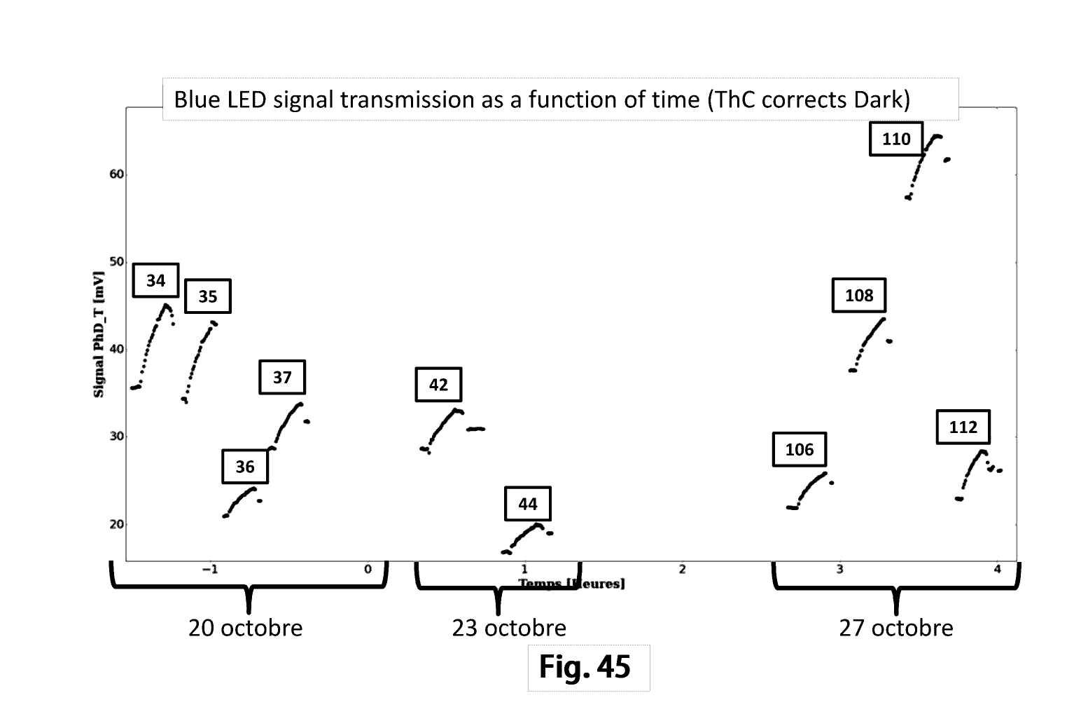

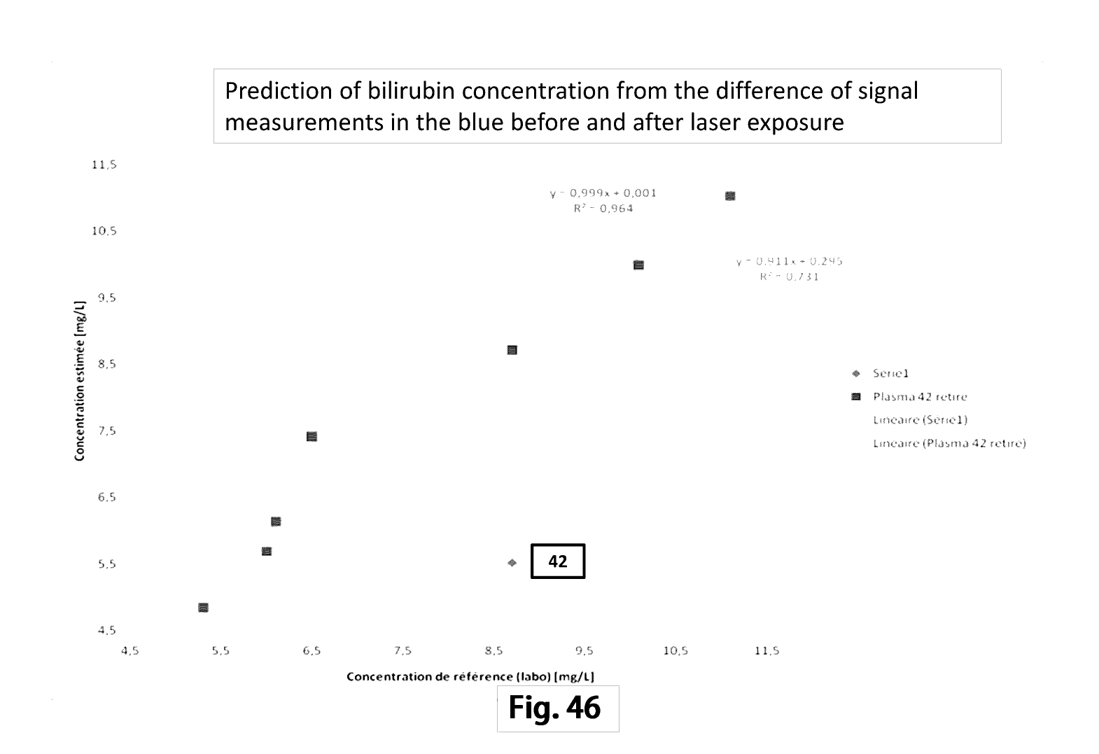

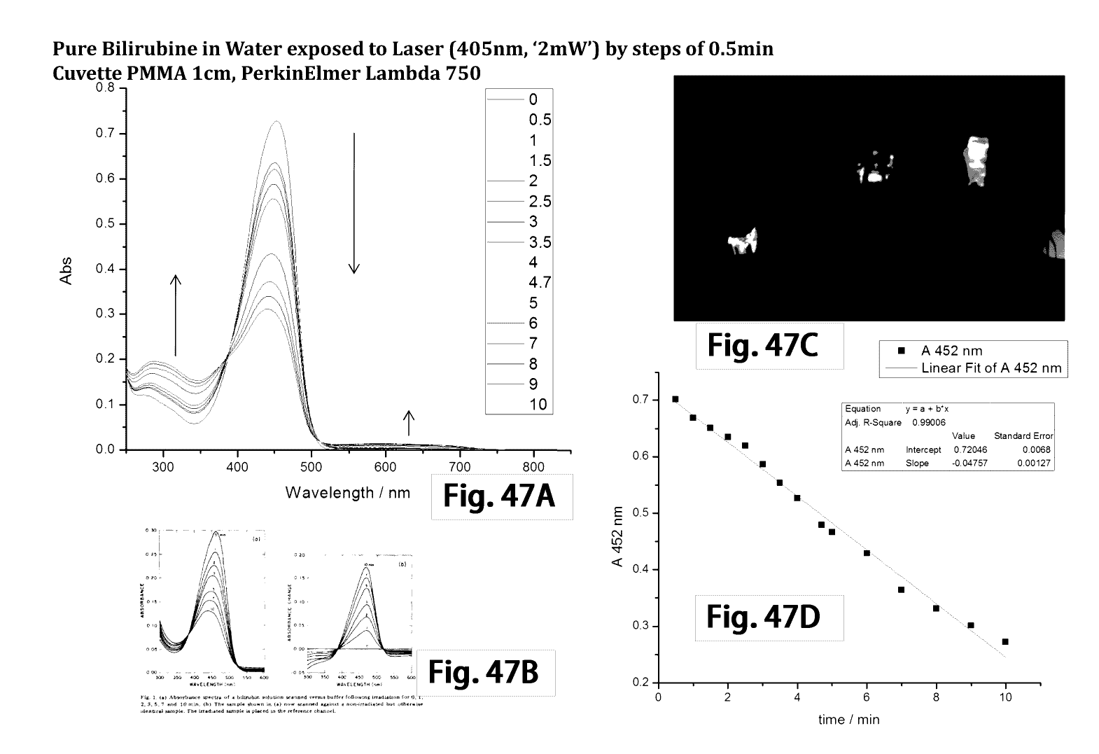

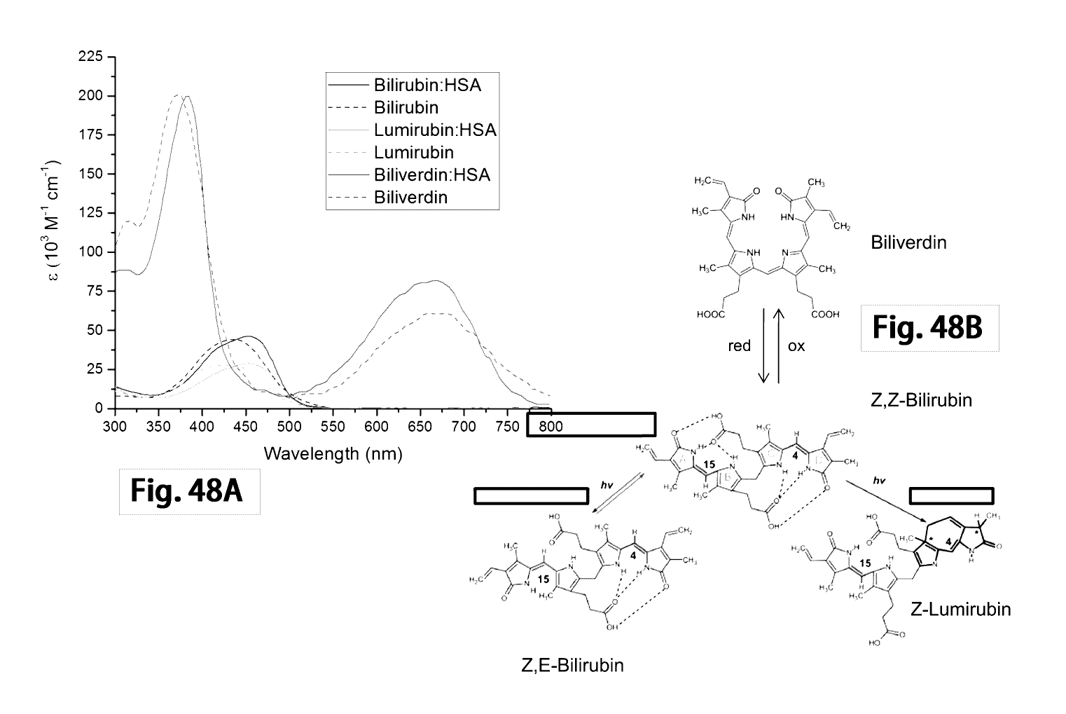

Bilirubin is a very active element that often accounts for significant errors in the spectrum. Accordingly, an improved method for determining the exact concentration of bilirubin to better inform correction for this analyte is desirable. The present invention has discovered that the use of photodegradation methods to determine bilirubin concentration can provide a more accurate concentration. FIGS. 44A-C show a prototype apparatus including a laser at 405 nm (e.g. blue laser) used to produce photodegradation data for bilirubin. In the order to generate the data, a laser was on for 10 minutes (20 cycles), then the plasma was stirred (except 34 and 35). FIG. 45 depicts the LED (blue) signal transmission as a function of time. FIG. 46 shows the prediction of bilirubin concentration from the difference of signal measurements in the blue before and after laser exposure. The change in absorbance of bilirubin over time as the sample is exposed to a blue laser can be seen in FIG. 47A. Further evidence of this change can be seen in FIG. 47B, which depicts the absorbance spectra of a bilirubin sample scanned following irradiation for 0, 1, 2, 3, 5, 7, and 10 minutes as well as the same sample scanned against a non-irradiated but otherwise identical sample. As can be seen, there is a marked change in absorbance of the sample as it is irradiated. FIG. 47D further illustrates the degradation of bilirubin. As can be seen, the absorbance at the wavelength of the laser (452) drops dramatically over time as the bilirubin is degraded. This is due to the chemical change that occurs as the bilirubin is degraded and the different absorption spectrum of the degradation products versus bilirubin, as shown in FIGS. 48A and 48B.

Similar to the disclosure above with respect to uric acid, the methods may further involve generating a report that includes the concentration of bilirubin in the sample, in which the concentration may be indicative of a disease state of a subject. As described above, the report may be transmitted to a physician. The report will aid the physician in the diagnosis of a disease state of a subject. For example, the report can provide a range for concentration of bilirubin (total and/or direct) that is considered “normal,” such that a concentration falling close to, above or below the ends of the range may indicate a disease state or that further monitoring/testing may be necessary. High concentrations of bilirubin usually cause jaundice and can be an indication of disease states involving the liver and bile duct, such as cirrhosis, hepatitis, or gallstones. Additionally, high concentrations of uric acid can also indicate other disease states such as Gilbert syndrome, viral hepatitis, alcohol liver disease, gallstones, tumors, sickle cell disease, and/or hemolytic anemia. Elevated levels of bilirubin in newborns can be especially problematic given that excessive levels can damage developing brain cells, which can lead to mental retardation, learning and development disabilities, hearing loss, eye movement problems, and even death. Additionally, the relative elevation between conjugated and unconjugated bilirubin can serve as an indication of a disease state. For example, when conjugated bilirubin is elevated more than unconjugated bilirubin, it may be an indication of gall stones or tumors. Low concentrations of uric acid are usually not a concern. The concentration will also indicate to the physician the severity of the disease/condition, with concentrations being further from normal range being indicative of greater severity of a disease state/condition.

### Iron and Iron Proteins

Iron is an essential trace element that is required for the formation of red blood cells. It plays a role in many important functions in the human body such as the production of DNA and the production of hemoglobin, which delivers oxygen to the body. Iron also carries carbon dioxide out of the body and is used to make myoglobin in the muscles. Too high or too low of levels in the body can lead to a number of diseases and disorders.

A number of tests for evaluating the body's iron stores or the iron level in the blood serum can be done. These include, but at not limited to, tests for serum iron, ferritin, and transferrin. Ferritin is an iron storage protein and is measured to help determine the amount of iron being stored in the body. Transferrin is a protein and major carrier of iron in the blood stream. Typically, the quantity of iron bound to transferring is measured. The foregoing tests, in addition to other tests, such as total iron-binding capacity (TIBC) and unsaturated iron-binding capacity (UIBC) are often done together to help detect and diagnose iron deficiency or iron overload. Too low or too high levels of one or more of these can lead to various diseases or disorders, such as, but not limited to, iron deficiency anemia, iron overload (hemochromatosis), anemia of chronic disease, porphyria cutanea tarda (PCT), thalassemia, sideroblastic anemia, megaloblastic anemia, hemolytic anemia. Some of these disorders can also indicate that another disease is the cause for the iron imbalance.

Hemochromatosis is the most common form of iron overload disease. Primary hemochromatosis, also called hereditary hemochromatosis, is an inherited disease. Secondary hemochromatosis is caused by anemia, alcoholism, and other disorders. Juvenile hemochromatosis and neonatal hemochromatosis are two additional forms of the disease. Juvenile hemochromatosis leads to severe iron overload and liver and heart disease in adolescents and young adults between the ages of 15 and 30. The neonatal form causes rapid iron buildup in a baby's liver that can lead to death.

Hemochromatosis is associated with the increased absorption of iron from the diet followed by a buildup of iron in the body's organs leading to tissue damage. Without treatment, the disease can cause the liver, heart, and pancreas to fail.

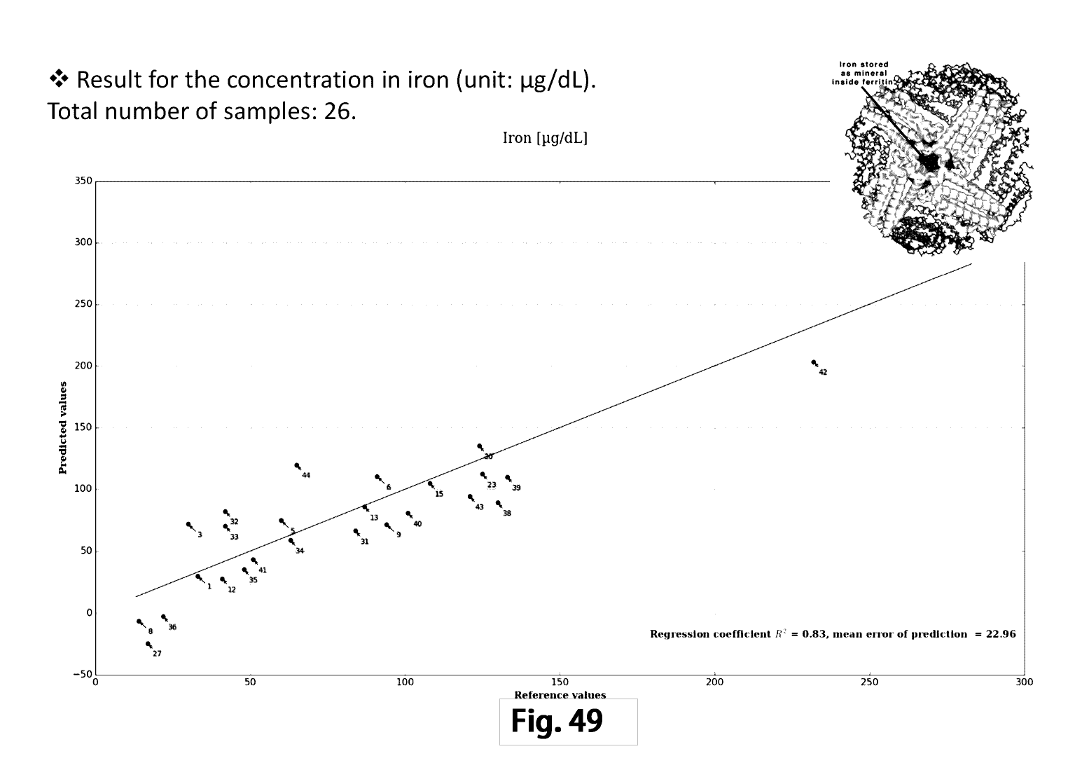

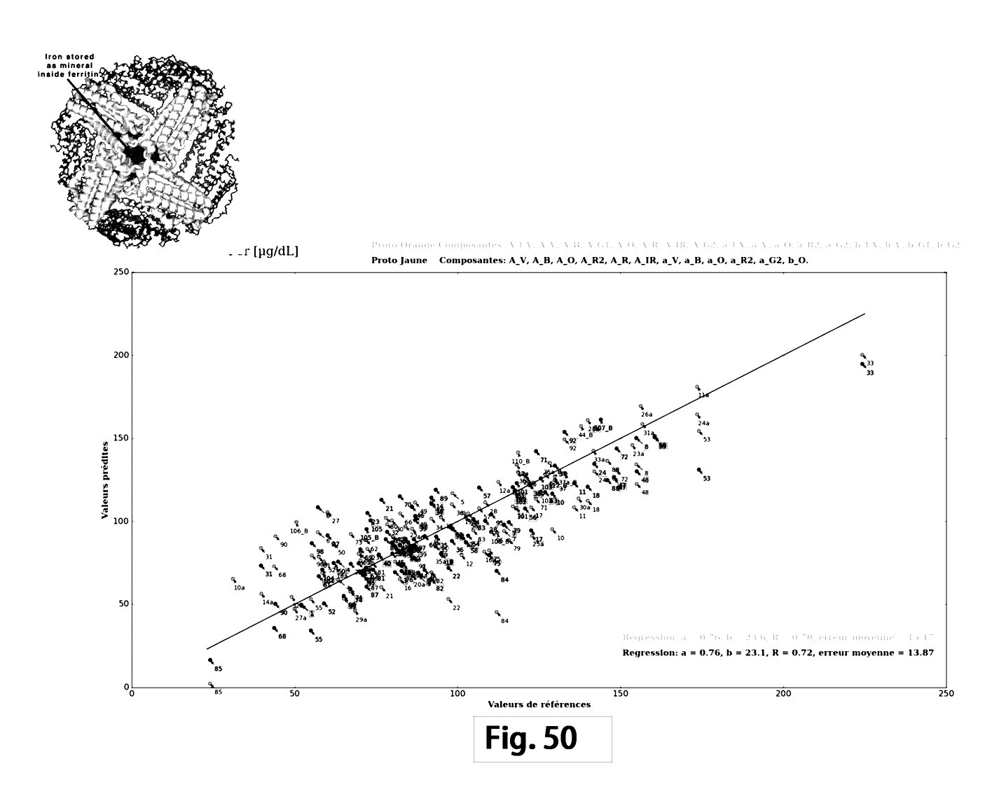

To assess iron (or iron protein) concentration in a blood sample, the sample is illuminated using the devices described herein with a polychromatic light beam. Spectral data associated with the blood sample and the iron is received to a detector of the system without splitting the polychromatic light into individual wavelengths. The spectral data is then analyzed. That is, the total absorption spectrum is processed as described above in order to deconvolute the data to obtain the specific spectrum for iron in the sample. The obtained spectrum for iron from the sample (e.g., blood) is compared to a database including reference spectral data in which relative absorption of iron in blood is known and is correlated with a particular concentration. In certain embodiments, three methods are conducted without reacting the iron with another chemical reagent. FIGS. 49 and 50 depict the results of the analysis methods described in Example 1 above.

As disclosed above, the methods may further involve generating a report that includes the concentration of iron and/or iron protein in the sample, in which the concentration(s) may be indicative of a disease state of a subject. As described above, the report may be transmitted to a physician. The report will aid the physician in the diagnosis of a disease state of a subject. For example, the report can provide a range for concentration of iron and/or iron protein that is considered “normal,” such that a concentration(s) falling close to, above or below the ends of the range may indicate a disease state or that further monitoring/testing may be necessary. For example, the following chart illustrates the disease states indicated by high or low levels of iron, iron protein and related factors.

| | | | | % | |
|---|---|---|---|---|---|
| | | TIBC/ | | Transferrin | |
| Disease | Iron | Transferrin | UIBC | Saturation | Ferritin |
| Iron Deficiency | Low | High | High | Low | Low |
| Hemochro- | High | Low | Low | High | High |
| matosis | | | | | |
| Chronic Illness | Low | Low | Low/ | Low | Normal/ |
| | | | Normal | | High |
| Hemolytic | High | Normal/ | Low/ | High | High |
| Anemia | | Low | Normal | | |
| Sideroblastic | Normal/ | Normal/ | Low/ | High | High |
| Anemia | High | Low | Normal | | |
| Iron Poisoning | High | Normal | Low | High | Normal |

Additional diseases or disorders implicated by iron levels include porphyria cutanea tarda (PCT), thalassemia, and megaloblastic anemia. Some of these diseases/disorders can also indicate that another disease is the cause for the iron imbalance. Furthermore, the concentration will also indicate to the physician the severity of the disease/condition, with concentrations being further from normal range in either direction (e.g., hyper or hypo) being indicative of greater severity of a disease state/condition.

### Triglycerides

Triglycerides are a type of fat (lipid) found in your blood. They allow the bidirectional transference of adipose fat and blood glucose from the liver, and are a major component of human skin oils. The body converts any calories not immediately used into triglycerides, which are then stored in the body's fat cells. Hormones release triglycerides for energy between meals. If an individual eats more calories than are burned, the individual may have a high level of triglycerides, otherwise known as hypertriglyceridemia.

It is known that disorders in lipid metabolism and carbohydrate metabolism are associative indicators of diseases such as atherosclerosis and coronary heart disease, in addition to increased risk for heart attack or stroke.

Testing for triglyceride levels are usually done as part of a lipid profile in conjunction with cholesterol testing. A triglyceride or lipid profile test is usually conducted on a blood sample from an individual. Unhealthy lipid levels and/or the presence of other risk factors such as age, family history, cigarette smoking, diabetes and high blood pressure, may mean that the person tested requires treatment. Typically, for adults, triglyceride levels are categorized as follows:

Desirable: Less than 150 mg/dL (1.7 mmol/L)
Borderline high: 150 to 199 mg/dL (1.7-2.2 mmol/L)
High: 200 to 499 mg/dL (2.3-5.6 mmol/L)
Very high: Greater than 500 mg/dL (5.6 mmol/L)
These ranges may differ for children, teens and young adults.

To assess triglyceride concentration in a blood sample, the sample is illuminated using the devices described herein with a polychromatic light beam. Spectral data associated with the blood sample and triglyceride concentration is received to a detector of the system without splitting the polychromatic light into individual wavelengths. The spectral data is then analyzed. That is, the total absorption spectrum is processed as described above in order to deconvolute the data to obtain the specific spectrum for triglycerides in the sample. The obtained spectrum for triglycerides from the sample (e.g., blood) is compared to a database including reference spectral data in which relative absorption of triglycerides in blood or urine is known and is correlated with a particular concentration. In certain embodiments, three methods are conducted without reacting the uric acid with another chemical reagent.

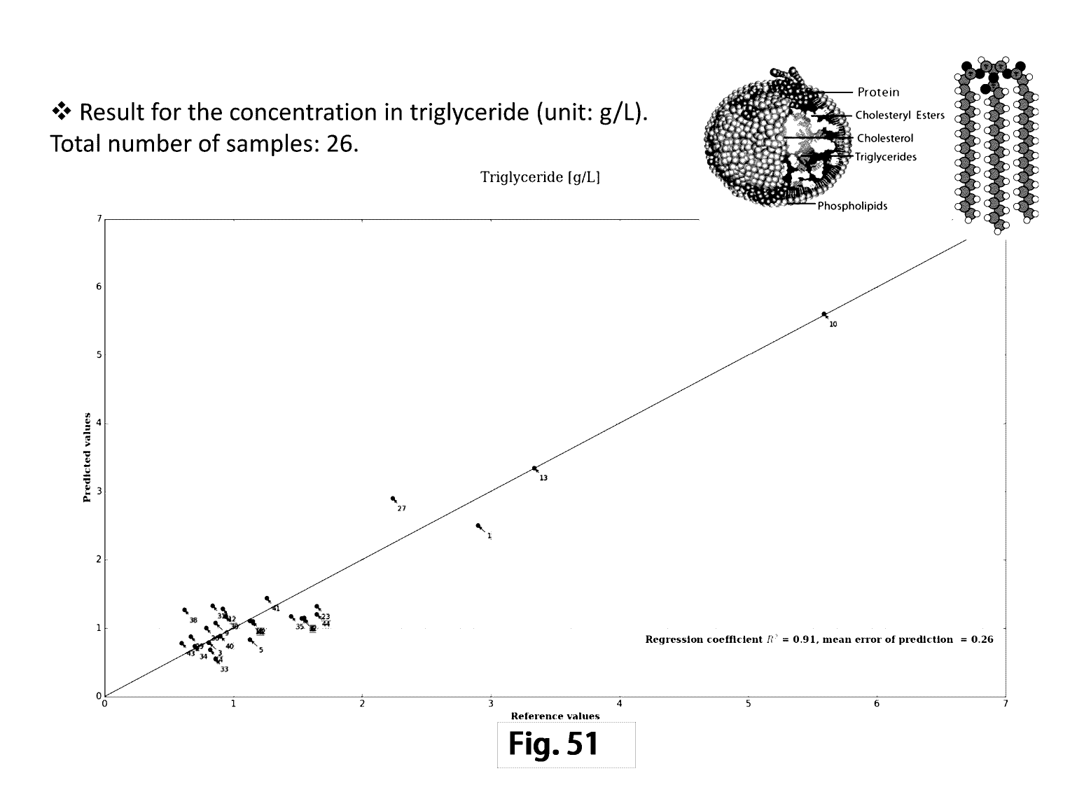

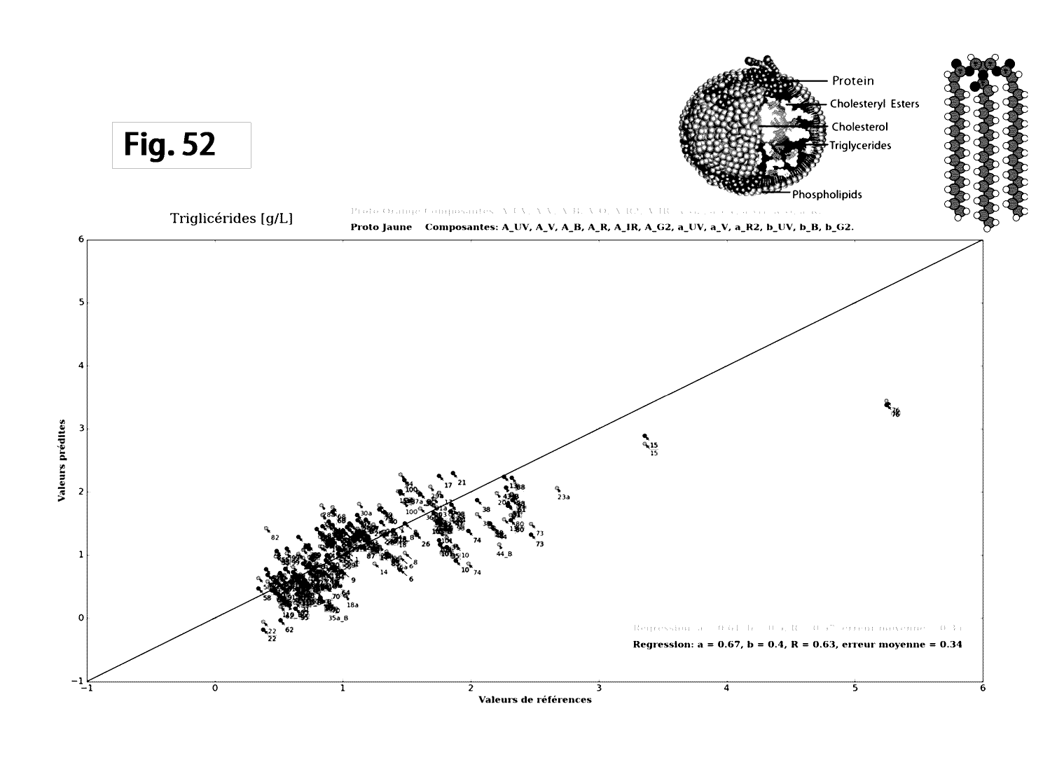

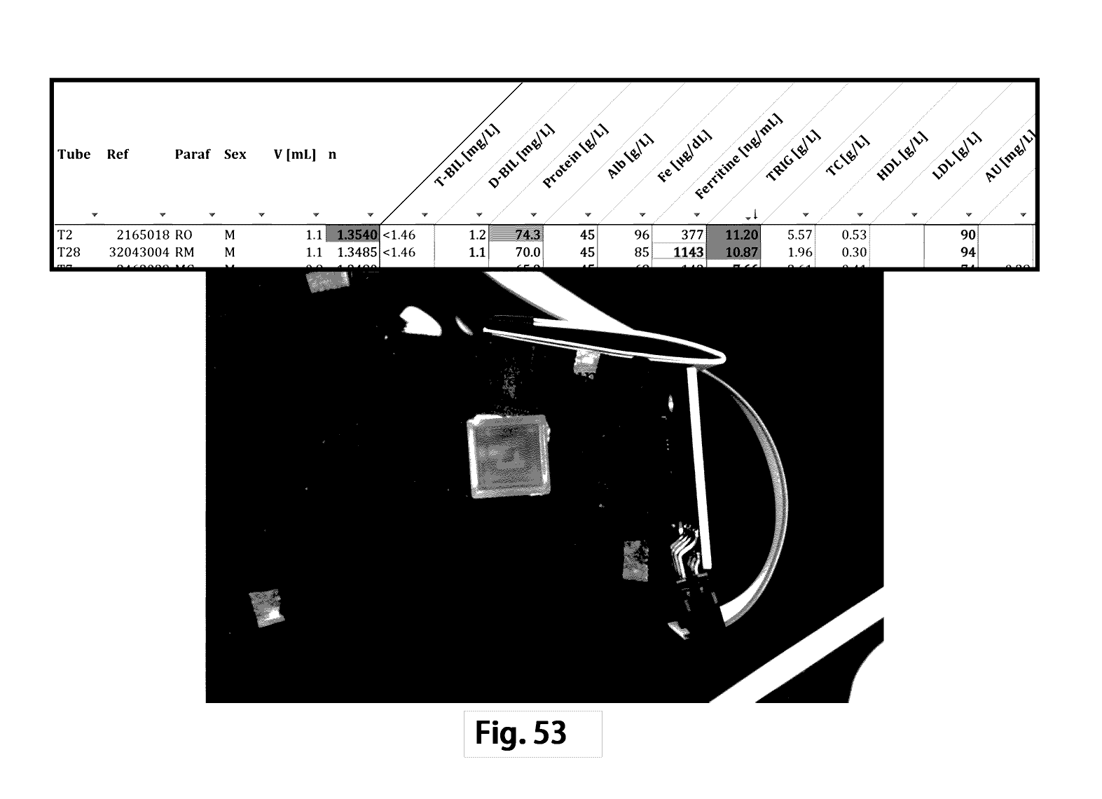

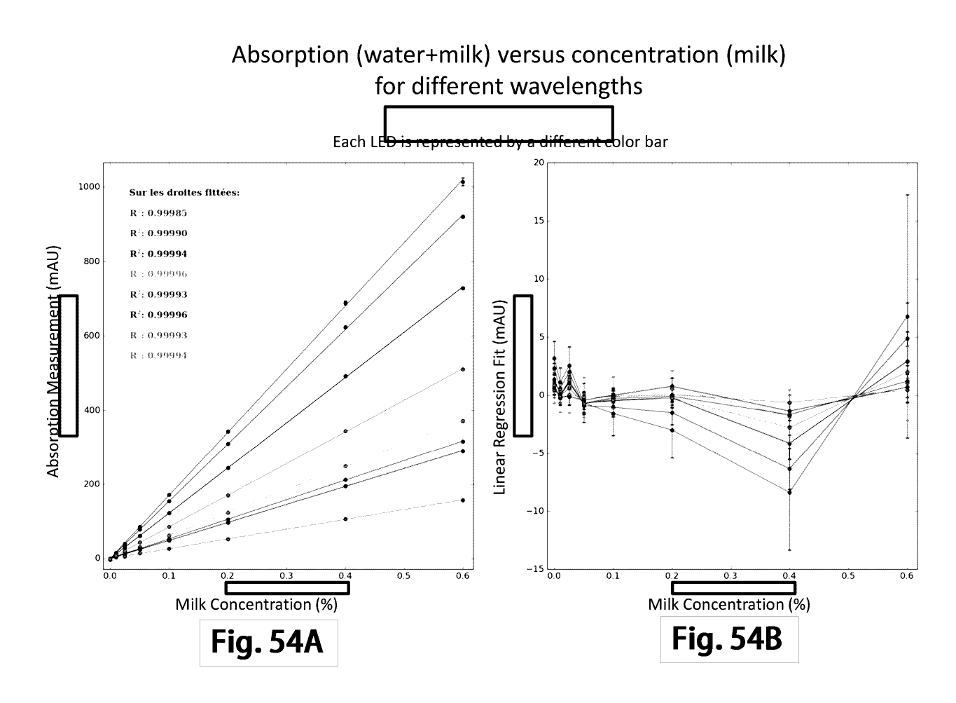

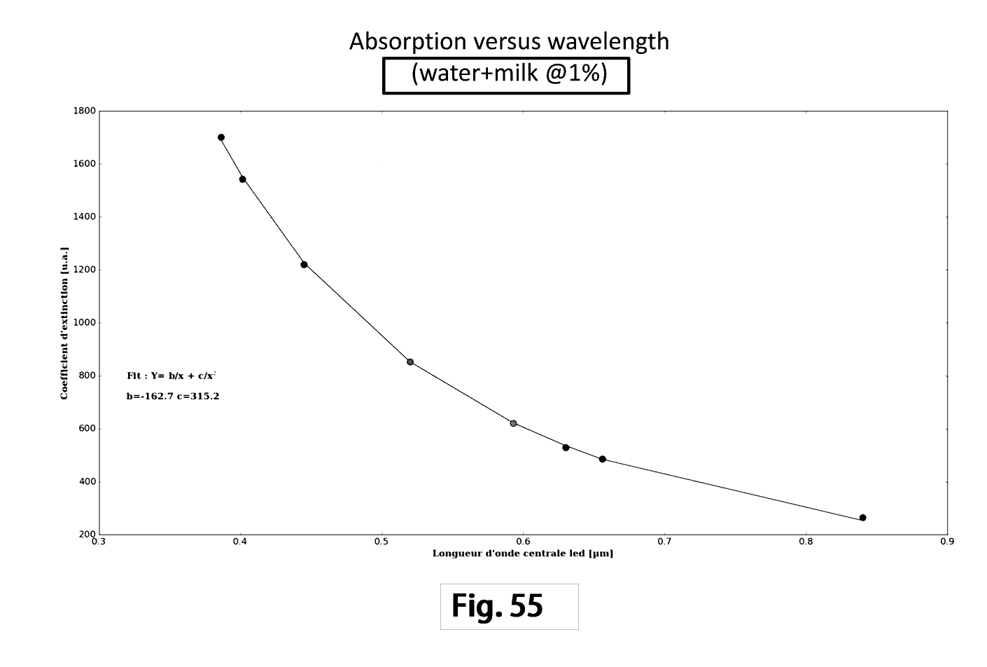

FIGS. 51 and 52. depict the results of the analysis methods described in Example 1 above. However, due to the scattering, or diffusion, caused by triglycerides (and total proteins, discussed directly below), a slightly different method for calculating concentration of triglycerides versus the previous three target analytes was completed. The effect of scattering is demonstrated in FIGs. 54A, which shows the absorption of water and milk versus the milk concentration, with a linear regression fit shown in FIG. 54B. The absorption (water+milk @1%) versus wavelength is shown in FIG. 55. The shape of the curve in FIG. 55 is characteristic of scattering behavior (due to micro-particles in milk). The fit coefficients (b and c) are linked to the concentration and the size of the particles.

The methods may further involve generating a report that includes the concentration of triglycerides in the sample, in which the concentration may be indicative of a disease state of a subject. As described above, the report may be transmitted to a physician. The report will aid the physician in the diagnosis of a disease state of a subject. For example, the report can provide a range for concentration of triglycerides that is considered “normal,” such that a concentration falling close to, above or below the ends of the range may indicate a disease state or that further monitoring/testing may be necessary. For example, a high concentration of triglycerides can be an indication of cardiovascular diseases such as atherosclerosis and coronary heart disease, in addition to an increased risk for pancreatitis, heart attack and/or stroke. The concentration will also indicate to the physician the severity of the disease/condition, with concentrations being further from normal range in either direction (e.g., hyper or hypo) being indicative of greater severity of a disease state/condition.

### Total Protein

Proteins play a role in a number of functions within an individual, such as catalyzing metabolic reactions, DNA replication, responding to stimuli, and transporting molecules from one location to another. A typical test to determine the protein levels in an individual is known as the total protein test.

The total protein test measures the total amount of two classes of proteins found in the fluid portion of your blood: albumin and globulin; the globulin in turn is made up of α1, α2, β, and γ globulins. Albumin is made mainly in the liver and helps prevent fluid from leaking out of blood vessels. Albumin is also responsible, in part, for carrying medicines and other substances through the blood and plays a role in tissue growth and healing. Globulins are mainly made by the liver and the immune system. Certain globulins bind with hemoglobin while others help transport metals, such as iron, in the blood to help fight infection.

Tests are available that can provide the breakdown of albumin and globulin, with normal ranges for the test provided below:

| | |
|---|---|
| Total protein: | 6.4-8.3 grams per deciliter (g/dL) or |
| | 64-83 grams per liter (g/L) |
| Albumin: | 3.5-5.0 g/dL or 35-50 g/L |
| Alpha-1 globulin: | 0.1-0.3 g/dL or 1-3 g/L |
| Alpha-2 globulin: | 0.6-1.0 g/dL or 6-10 g/L |
| Beta globulin: | 0.7-1.1 g/dL or 7-11 g/L |

However, testing for total protein alone can be faster and cheaper. This test is often done to diagnose nutritional problems; blood disease, such as multiple myeloma or macroglobulinemia; kidney disease; or liver disease. If total protein is abnormal, the individual will likely need to have more tests done to determine the exact cause of the problem.

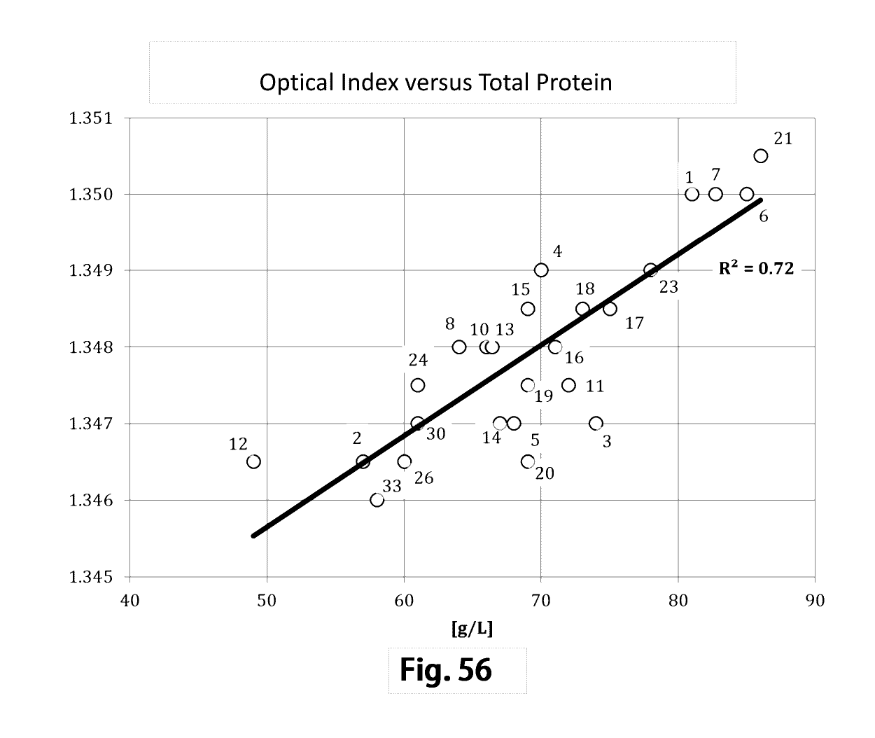

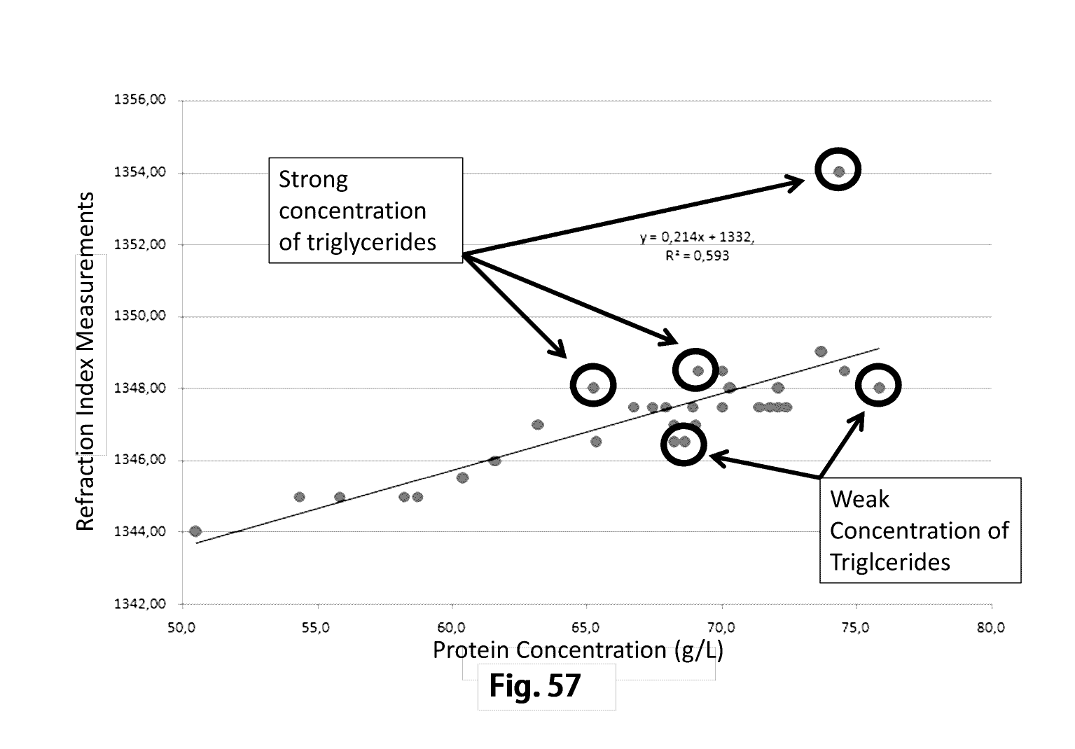

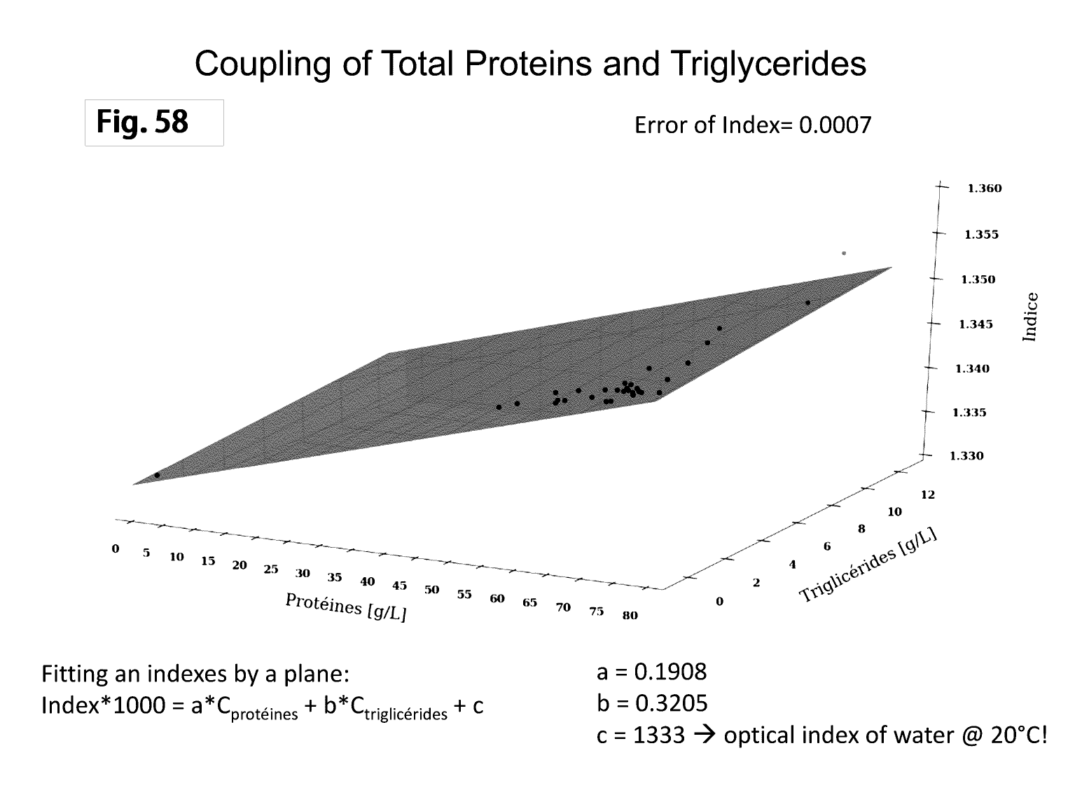

To assess a total protein concentration in a blood or urine sample, the sample is illuminated using the devices described herein with a polychromatic light beam. Spectral data associated with the urine or blood sample and the total proteins is received to a detector of the system without splitting the polychromatic light into individual wavelengths. The spectral data is then analyzed. That is, the total absorption spectrum is processed as described above in order to deconvolute the data to obtain the specific spectrum for total proteins in the sample. The obtained spectrum for total proteins from the sample (e.g., blood or urine) is compared to a database including reference spectral data in which relative absorption of total proteins in blood or urine is known and is correlated with a particular concentration. In certain embodiments, three methods are conducted without reacting the proteins with another chemical reagent. As demonstrated above with respect to triglycerides, analysis methods for determining total protein concentration must account for scattering. FIG. 56 provides a chart depicting the optical index versus total protein concentration. FIG. 57 shows refraction index measurements plotted against protein concentration with those samples having a strong concentration of triglycerides associated with a higher refraction index. FIG. 58 shows the coupling of total proteins and triglycerides. As can be seen, higher concentrations of triglycerides have the greatest effect on the index.

As with the above disclosed examples, the methods may further involve generating a report that includes the concentration of total proteins in the sample, in which the concentration may be indicative of a disease state of a subject. As described above, the report may be transmitted to a physician. The report will aid the physician in the diagnosis of a disease state of a subject. For example, the report can provide a range for concentration of total proteins that is considered “normal,” such that a concentration falling close to, above or below the ends of the range may indicate a disease state or that further monitoring/testing may be necessary. High total protein levels can be an indication of disease states involving the liver or kidneys. High levels can also be an indication of chronic inflammation, infections such as viral hepatitis or HIV, and/or bone marrow disorders such as multiple myeloma. Low total protein levels can be indicative of, for example, severe malnutrition and conditions that cause malabsorption such as celiac disease or inflammatory bowel disease (IBD). If total protein is abnormal, more testing will likely need to be done to determine the exact cause of the problem. The concentration will also indicate to the physician the severity of the disease/condition, with concentrations being further from normal range in either direction (e.g., hyper or hypo) being indicative of greater severity of a disease state/condition.

### F. Analysis of Samples by Correcting for Diffusion

There are several analytes for which the use of spectroscopy due to the issue of light diffusion, or light scattering, as described above with respect to triglycerides and total proteins. The diffusion affects the signal read by analytical instruments and, as such, interferes with the accuracy of the measurements reported. An example of this effect was shown in FIGS. 54A-55 with respect to milk samples, as disclosed in more detail in Section E above. The present disclosure corrects for the diffusion that occurs when analyzing certain samples, such as those containing lipids, as disclosed above with respect to triglycerides and total proteins in Section E above. In general, diffusion determines the average path of light through a sample, and thus affects the extent the various wavelengths are absorbed. With respect to lipids, correction must be applied across all wavelengths due to the fact that lipids act on all of the wavelengths (e.g., 100 nm-1000 nm). Thus, in order to correct for this diffusion, the contribution of the analyte of interest is removed. This is an iterative process, such that the model is optimized with each iteration. Various analytical methods for correcting the diffused wavelengths include, but are not limited to, baseline correction, multiplicative scatter correction (MSC), and orthogonal scatter correction (OSC).

In certain aspects, the invention provides methods for analyzing a sample including a lipid that involves obtaining spectral data of a sample including one or more lipids, correcting for diffusion of light in the spectral data to generated corrected spectral data, and analyzing the corrected spectral data.

### G. Sample Analysis Methods Using Chemical Reagents

In certain embodiments, chemical reagents can be used to facilitate detection of target analytes, especially those target analytes which are present in low concentrations. Generally, a chemical reagent is added to the sample, a chemical reaction occurs in which the target analyte is converted, using the chemical reagent, into a new species for which the absorbance will be determined. Then, using stoichiometric calculations, the absorbance of the target analyte can be determined.

When choosing a reagent, one or more of the following properties should be considered: stability of the chemical reagent in solution, stoichiometric reactivity with the target analyte, transparency in the wavelength region, selectivity or specificity to the target analyte; freedom from interference by other solution components; freedom from cross-reactivity with other reagents; ability to function in a common solvent; and temperature of the sample. Sample temperature is especially important when enzymes are involved with respect to both the reagents and the target analyte.

A few exemplary reagents and their corresponding target analytes include, but are not limited to total bilirubin: Diazonium Salt; uric acid: probenecid; iron (III): morin (2′,3,4′,5,7-pentahydroxyflavone); glucose: glucose hexokinase; sodium: β-galactosidase; potassium: pyruvate kinase; total proteins: p-benzoquinone (PBQ); creatinine: p-methylamino phenol sulfate (metol)/copper sulfate; hemoglobin: cyanmethemoglobin; cholesterol: glacial acetic acid, acetic anhydride and sulfuric acid; zinc: bis-[2,6-(2′-hydroxy-4′-sulpho-1′-napthylazo)]pyridine disodium salt (HSNP); potassium: sodium tetraphenylboron; phosphate: trichloroacetic acid; and Vitamin C: phosphotungstate reagent. It is noted that when the target analyte is an enzyme, the concentration of the enzyme is not measured, but rather the “enzymatic activity” (an arbitrary unit that measures the speed at which the enzyme catalyzes the chemical reaction) is measured.

In one aspect, a sample is analyzed using a single chemical reagent specific for one target analyte. A sample is mixed with one or more chemical reagents, such as a mix of different reagents (e.g., “working mix”), in a single chamber. The reagent is specific for a single target analyte, such that one reaction product will be formed. The sample will be illuminated in the chamber with a polychromatic light beam, as described herein. A detector will receive the transmitted beam and spectral data of the sample and reaction product. The data will be processed and output the spectral signature for the target analyte.

In another aspect, multiplexing within a single chamber can be accomplished using the presently disclosed methods and apparatuses. This can be done due to the fact that the methods of the invention do not require splitting a polychromatic light bean into its different wavelength components, each of which must be sent to a different detector. Rather, a single detector receives the polychromatic light beam after it has passed through the sample. The received polychromatic light beam is then analyzed and target analytes in a sample are detected based on the analysis of the received polychromatic light. When multiplexing in accordance with the present invention, a heterogeneous sample will be mixed with a plurality of chemical reagents in a single chamber. Each reagent or reagent mix will be specific for a different target analyte, such that a plurality of reaction products is formed.

In operation, the heterogeneous sample will be illuminated in a single chamber with a polychromatic light beam, as described herein. A detector will receive the spectral data of the heterogeneous sample and the reaction products. It is to be understood that each reaction product will have a unique spectral signature. The data can be subsequently processed, using for example, a computer having a processor, such that the unique spectral signature for each of the plurality of target analytes is output. It is also to be understood that any number of target analytes and chemical reagents can be used. The data can be deconvoluted as described herein.

### H. Computer Implementation

Aspects of the present disclosure described herein, such as analysis of spectral data using a database, can be performed using any type of computing device, such as a computer, that includes a processor, e.g., a central processing unit, or any combination of computing devices where each device performs at least part of the process or method. In some embodiments, systems and methods described herein may be performed with a handheld device, e.g., a smart tablet, or a smart phone, or a specialty device produced for the system.

Methods of the present disclosure can be performed using software, hardware, firmware, hardwiring, or combinations of any of these. Features implementing functions can also be physically located at various positions, including being distributed such that portions of functions are implemented at different physical locations (e.g., imaging apparatus in one room and host workstation in another, or in separate buildings, for example, with wireless or wired connections).

Processors suitable for the execution of computer program include, by way of example, both general and special purpose microprocessors, and any one or more processor of any kind of digital computer. Generally, a processor will receive instructions and data from a read-only memory or a random access memory or both. The essential elements of computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, solid state drive (SSD), and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having an I/O device, e.g., a CRT, LCD, LED, or projection device for displaying information to the user and an input or output device such as a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected through network by any form or medium of digital data communication, e.g., a communication network. For example, the reference data may be stored at a remote location and the computer communicates across a network to access the reference data to compare spectral data obtained from the light emission device to the reference set. In other embodiments, however, the reference set is stored locally within the computer and the computer accesses the reference set within the CPU to compare subject data to the reference set. Examples of communication networks include cell network (e.g., 3G or 4G), a local area network (LAN), and a wide area network (WAN), e.g., the Internet.

The subject matter described herein can be implemented as one or more computer program products, such as one or more computer programs tangibly embodied in an information carrier (e.g., in a non-transitory computer-readable medium) for execution by, or to control the operation of, data processing apparatus (e.g., a programmable processor, a computer, or multiple computers). A computer program (also known as a program, software, software application, app, macro, or code) can be written in any form of programming language, including compiled or interpreted languages (e.g., C, C++, Perl), and it can be deployed in any form, including as a stand-alone program or as a module, component, subroutine, or other unit suitable for use in a computing environment. Systems and methods of the invention can include instructions written in any suitable programming language known in the art, including, without limitation, C, C++, Perl, Java, ActiveX, HTML5, Visual Basic, or JavaScript.

A computer program does not necessarily correspond to a file. A program can be stored in a file or a portion of file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

A file can be a digital file, for example, stored on a hard drive, SSD, CD, or other tangible, non-transitory medium. A file can be sent from one device to another over a network (e.g., as packets being sent from a server to a client, for example, through a Network Interface Card, modem, wireless card, or similar).

Writing a file according to the invention involves transforming a tangible, non-transitory computer-readable medium, for example, by adding, removing, or rearranging particles (e.g., with a net charge or dipole moment into patterns of magnetization by read/write heads), the patterns then representing new collocations of information about objective physical phenomena desired by, and useful to, the user. In some embodiments, writing involves a physical transformation of material in tangible, non-transitory computer readable media (e.g., with certain optical properties so that optical read/write devices can then read the new and useful collocation of information, e.g., burning a CD-ROM). In some embodiments, writing a file includes transforming a physical flash memory apparatus such as NAND flash memory device and storing information by transforming physical elements in an array of memory cells made from floating-gate transistors. Methods of writing a file are well-known in the art and, for example, can be invoked manually or automatically by a program or by a save command from software or a write command from a programming language.

Suitable computing devices typically include mass memory, at least one graphical user interface, at least one display device, and typically include communication between devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory, or other memory technology, CD-ROM, digital versatile disks (DVD) or other optical storage, magnetic cassettes, magnetic tape, magnetic disk storage or other magnetic storage devices, Radiofrequency Identification tags or chips, or any other medium which can be used to store the desired information and which can be accessed by a computing device.

As one skilled in the art would recognize as necessary or best-suited for performance of the methods of the invention, a computer system or machines of the invention include one or more processors (e.g., a central processing unit (CPU) a graphics processing unit (GPU) or both), a main memory and a static memory, which communicate with each other via a bus.

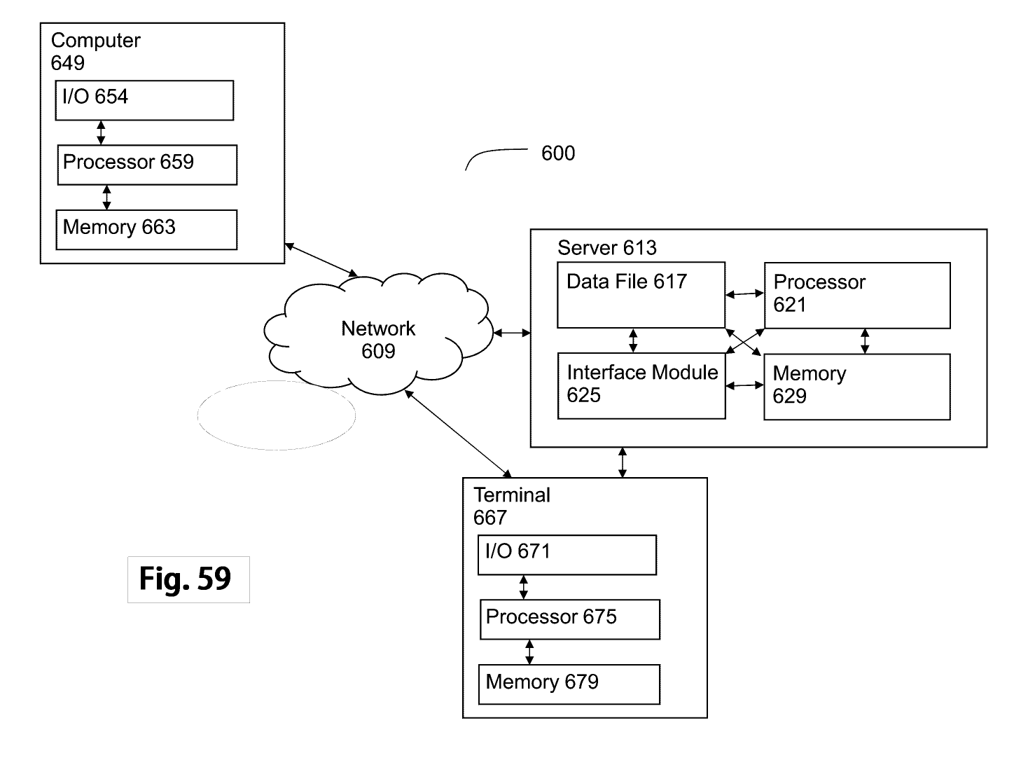

In an exemplary embodiment shown in FIG. 59, system 600 can include a computer 649 (e.g., laptop, desktop, or tablet). The computer 649 may be configured to communicate across a network 609. Computer 649 includes one or more processor 659 and memory 663 as well as an input/output mechanism 654. Where methods of the invention employ a client/server architecture, an steps of methods of the invention may be performed using server 613, which includes one or more of processor 621 and memory 629, capable of obtaining data, instructions, etc., or providing results via interface module 625 or providing results as a file 617. Server 613 may be engaged over network 609 through computer 649 or terminal 667, or server 613 may be directly connected to terminal 667, including one or more processor 675 and memory 679, as well as input/output mechanism 671.

System 600 or machines according to the invention may further include, for any of I/O 649, 637, or 671 a video display unit (e.g., a liquid crystal display (LCD) or a cathode ray tube (CRT)). Computer systems or machines according to the invention can also include an alphanumeric input device (e.g., a keyboard), a cursor control device (e.g., a mouse), a disk drive unit, a signal generation device (e.g., a speaker), a touchscreen, an accelerometer, a microphone, a cellular radio frequency antenna, and a network interface device, which can be, for example, a network interface card (NIC), Wi-Fi card, or cellular modem.

Memory 663, 679, or 629 according to the invention can include a machine-readable medium on which is stored one or more sets of instructions (e.g., software) embodying any one or more of the methodologies or functions described herein. The software may also reside, completely or at least partially, within the main memory and/or within the processor during execution thereof by the computer system, the main memory and the processor also constituting machine-readable media. The software may further be transmitted or received over a network via the network interface device.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are therefore intended to be embraced therein.

What is claimed is:

1. A method for determining a concentration of at least one target analyte in a heterogeneous sample, the method comprising:
illuminating a heterogeneous sample comprising at least one target analyte with polychromatic light;
receiving a luminous signal of the heterogeneous sample and the at least one target analyte with a detector without splitting the polychromatic light into individual wavelengths;
generating spectral data from the received luminous signal; and
converting the spectral data into a concentration of the at least one target analyte in the heterogeneous sample by comparing the spectral data to a database comprising known spectra already associated with concentration levels of the target analyte.

2. The method of claim 1, wherein the heterogeneous sample is at least one selected from the group consisting of a biological sample, an environmental sample, a food product sample, and a beverage product sample.

3. The method of claim 2, wherein the biological sample is a human tissue or body fluid sample

4. The method of claim 3, wherein the body fluid sample is a blood sample.

5. The method of claim 2, wherein the body fluid sample is a urine sample.

6. The method of claim 1, wherein the method is conducted without the use of chemical reagents.

7. The method of claim 1, wherein the heterogeneous sample further comprises one or more chemical reagents.

8. The method of claim 1, wherein the polychromatic light comprises a plurality of different monochromatic light beams.

9. The method of claim 8, wherein generating spectral data further comprises accounting for current data from each of the plurality of monochromatic light beams as well as temperature.

10. The method of claim 1, further comprising generating a report that comprises the concentration of the at least one target analyte, wherein the concentration is indicative of a disease state of a subject.

11. The method of claim 10, further comprising transmitting the report to a physician.

12. A method for detecting a condition, the method comprising:
illuminating a biological sample comprising at least one target analyte with polychromatic light;
receiving a luminous signal of the biological sample and the at least one target analyte with a detector without splitting the polychromatic light into individual wavelengths;
generating spectral data from the received luminous signal; and
converting the spectral data into a concentration of the at least one target analyte in the biological sample by comparing the spectral data to a database comprising known spectra already associated with concentration levels, wherein the concentration of the at least one target analyte is indicative of a condition.

13. The method of claim 12, wherein the biological sample is a human tissue or body fluid.

14. The method of claim 13, wherein the body fluid sample is a blood sample.

15. The method of claim 13, wherein the body fluid sample is a urine sample.

16. The method of claim 12, wherein the polychromatic light comprises a plurality of different monochromatic light beams.

17. The method of claim 16, wherein generating spectral data further comprises accounting for current data from each of the plurality of monochromatic light beams as well as temperature.

18. The method of claim 12, further comprising generating a report that comprises the concentration of the at least one target analyte, wherein the concentration is indicative of a disease state of a subject

19. The method of claim 18, further comprising transmitting the report to a physician.

20. The method of claim 12, wherein the method is conducted without the use of chemical reagents.

21. The method of claim 12, wherein the illuminating the biological sample step further comprises adding one or more chemical reagents to the biological sample prior to illuminating the biological sample.
